(19) United States
(12) Patent Application Publication
(10) Pub. No.: US 2013/0253185 A1
(43) Pub. Date: Sep. 26, 2013

(54) NOVEL CATALYSTS

(71) Applicants: Rylan J. Lundgren, Winnipeg (CA); Mark Stradiotto, Halifax (CA)

(72) Inventors: Rylan J. Lundgren, Winnipeg (CA); Mark Stradiotto, Halifax (CA)

(73) Assignee: Dalhousie University, Halifax (CA)

(21) Appl. No.: 13/885,415

(22) PCT Filed: Nov. 17, 2011
(86) PCT No.: PCT/US2011/061130

§ 371 Date: Jun. 11, 2013

Related U.S. Application Data
(60) Provisional application No. 61/415,032, filed on Nov. 18, 2010.

(51) Int. Cl. B01J 31/24

(52) U.S. Cl. CPC B01J 31/2452; B01J 31/2433; B01J 31/2404; B01J 31/2409; B01J 31/2414
USPC 540/542; 544/57; 544/155; 544/337; 546/22; 546/23; 548/413; 548/950; 564/15

(57) ABSTRACT

The present invention provides novel compounds and ligands that are useful in transition metal catalyzed cross-coupling reactions. For example, the compounds and ligands of the present invention are useful in palladium or gold catalyzed cross-coupling reactions.

### CROSS REFERENCE TO RELATED APPLICATION

This PCT application claims the benefit of U.S. provisional application Ser. No. 61/415,032, filed on Nov. 18, 2010, hereby incorporated by reference in its entirety.

### FIELD OF THE INVENTION

The present invention provides novel compounds, ligands, and reactions that are useful for preparing organic compounds.

### BACKGROUND

Arylamines are important pharmaceutical intermediates, natural products, and chemical probes for biochemical or biological assays. Traditionally, Pd-catalyzed cross-coupling of aryl halides and amines (e.g., Buchwald-Hartwig coupling) is considered to be the method of choice for the synthesis of arylamines. This type of cross-coupling reaction offers high levels of selectivity, broad substrate scope, and excellent functional group tolerance.

However, the utility of Pd-mediated C—N cross-coupling reaction protocols for selective monoarylation of small primary alkylamines, arylation of poorly nucleophilic or heteroatom-functionalized anilines, coupling of base-sensitive substrates, arylation of lithium amide, and synthesis of anilines from ammonia remains severely limited. And, although certain Pd-ligand systems work well for selected substrates, these ligands often fail when used with alternative amine classes, or require substantially higher Pd/ligand loadings to achieve reasonable yields. For instance, in the case of sterically demanding N-heterocyclic carbenes, secondary amines are readily cross-coupled to aryl chlorides under mild conditions with low Pd loadings, but smaller, nucleophilic primary amines remain problematic. Biarylphosphane ligands, perhaps the most versatile class of ligands for Pd-mediated C—N cross-coupling, lack require complex development of task-specific variants within the rather large biarylphosphane ligand family.

Flexible catalysts are also being sought for certain potentially useful hydroamination reactions. In particular, the intermolecular hydroamination of internal alkynes with basic dialkylamines represents an appealing pathway for synthesis of functionalized enamines, which are receptive to further synthetic manipulations. Although significant contributions involving Group 4-based catalysts have been made for the addition of primary alkylamines to alkynes, these catalysts exhibit characteristically poor performance for dialkylamine and internal alkyne pairings. The most effective catalyst for the addition of dialkylamines to internal alkynes is a cationic gold complex featuring a CAAC ancillary ligand (where CAAC is a cyclic(alkyl)(amino)carbene). This catalyst has proven effective for only a limited number of dialkylamine and alkyne partners, however, and only where those partners had no other functional groups. Also, only a single example of an asymmetrically substituted alkyne has been reported, and in that case negligible regioselectivity was observed.

In light of the foregoing limitations in the art, there is need for a single catalyst system capable of cross-coupling a broad range of amine classes with a broad range of aryl halide partners. There is also need for a single catalyst system to facilitate stereoselective addition of dialkylamines to a range of internal alkynes with a diverse substrate scope and with controlled regioselectivity.

### SUMMARY OF THE INVENTION

The present invention provides novel chemical compounds and ligands useful for broad spectrum catalysis of cross-coupling and hydroamination reactions. In addition, the present invention provides methods of preparing such compounds and ligands.

One aspect of the present invention comprises a compound of Formula I:

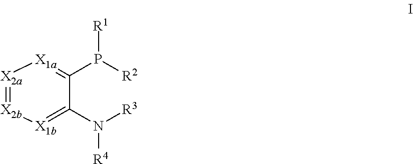

wherein each of R¹ and R² is independently selected from tert-butyl, cyclohexyl, 2-tolyl, or 1-adamantyl, and each of R³ and R⁴ is independently selected from a C₁₋₅ alkyl. Alternatively, R³, R⁴, and the nitrogen atom to which they are attached form an optionally substituted 4-10 membered heterocyclic ring. Each of X₁ₐ and X_{1b}, is independently selected from N or C—R⁵, and each of X₂, and X_{2b}, is independently selected from N or C—R⁶. Each R⁵ is independently selected from —H, —CH₃, —OCH₃, halogen, or —CF₃. Each R⁶ is independently selected from —H, —CH₃, —OCH₃, —N(CH₃)₂, halogen, or —CF₃. Alternatively, a vicinal R⁵ group and R⁶ group together with the carbon atoms to which they are attached form an optionally substituted 5-7 membered heterocyclic or carbocyclic ring, or two R⁶ groups together with the carbon atoms to which they are attached form an optionally substituted 5-7 membered heterocyclic or carbocyclic ring. No more than one of X₁ₐ, X_{1b}, X₂ₐ, or X_{2b} is N.

Another aspect of the present invention provides a method for preparing a compound of Formula I:

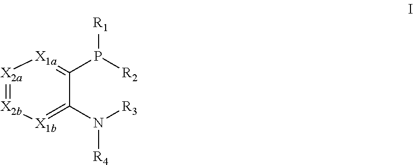

wherein each of R¹ and R² is independently selected from tert-butyl, cyclohexyl, 2-tolyl, or 1-adamantyl. Each of R³ and R⁴ is independently selected from a C₁₋₅ alkyl, or R³, R⁴, and the nitrogen atom to which they are attached form an optionally substituted 4-10 membered heterocyclic ring. Each of X₁ₐ and X_{1b}, is independently selected from N or C—R⁵, and each of X₂ₐ, and X_{2b}, is independently selected from N or C—R⁶. Each R⁵ is independently selected from —H, —CH₃, —OCH₃, halogen, or —CF₃, and each R⁶ is independently selected from —H, —CH₃, —OCH₃, —N(CH₃)₂, halogen, or —CF₃. Alternatively, an R⁵ and an R⁶ located on adjacent carbon atoms together with the carbon atoms to which they are attached form an optionally substituted 5-7 membered heterocyclic or carbocyclic ring, or two R⁶ groups together with the carbon atoms to which they are attached form an optionally substituted 5-7 membered heterocyclic or carbocyclic ring. No more than one of X₁ₐ, X_{1b}, X₂ₐ, or X_{2b} is N.

In this embodiment, the method of preparing a compound of Formula I comprises the step of reacting a compound of Formula 2:

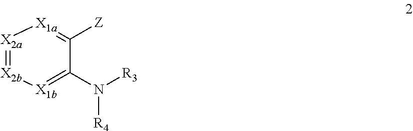

wherein Z is —Cl, —Br, or —I, with a compound of Formula 3:

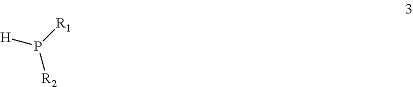

in the presence of the following: a) a metal catalyst; b) a complexing agent; c) a base; and d) a solvent.

A different aspect of the present invention comprises a method for preparing a compound of Formula IV:

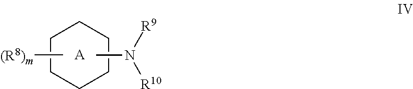

wherein ring A is a phenyl or a six membered heteroaryl having 1 to 2 nitrogen atoms located at any chemically feasible position on Ring A. Also, each of R⁸ is -Z^{A}R¹¹, wherein each Z^{A} is independently a bond or an optionally substituted branched or straight C₁₋₈ aliphatic chain wherein up to two carbon units of Z^{A} are optionally and independently replaced by —CO—, —CS—, —CONR^{A}—, —CONR^{A}NR^{A}—, —CO₂—, —Si(R^{A1})₂—, —OCO—, —NR^{A}CO₂—, —O—, —NR^{A}CONR^{A}—, —OCONR^{A}—, —S—, —S(O)—, —S(O)₂—, —NR^{A}—, —S(O)₂NR^{A}, —NR^{A}S(O)₂—, or —NR^{A}S(O)₂NR^{A}—. Each R¹¹ is independently R^{A}, —OH, —NH₂, —NO₂, —CN, —CF₃, or —OCH₃. Each R^{A} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl. Each R^{A1} is independently an optionally substituted C₁₋₆ alkyl group, or two vicinal R⁸ groups taken together with the atoms to which they are attached form an optionally substituted 5-7 membered saturated or partially unsaturated ring having up to 1 nitrogen atom. Each of R⁹ and R¹⁰ is -Z^{B}R¹², wherein each Z⁸ is independently a bond or an optionally substituted branched or straight C₁₋₈ aliphatic chain wherein up to two carbon units of Z^{B} are optionally and independently replaced by —CO—, —CS—, —CONR^{B}—, —CONR^{B}NR^{B}—, —CO₂—, —OCO—, —NR^{B}CO₂—, —O—, —NR^{B}CONR^{B}—, —OCONR^{B}—, —S—, —S(O)—, —S(O)₂—, —NR^{B}—, —S(O)₂NR^{B}—, —NR^{B}S(O)₂—, or —NR^{B}S(O)₂NR^{B}—. Each R¹² is independently R^{B}, —OH, —NH₂, —NO₂, —CN, —CF₃, or —OCH₃. Each R^{B} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl, or alternatively, R⁹ and R¹⁰ taken together with the nitrogen atom to which they are attached form an optionally substituted 5-8 membered heterocycloaliphatic having up to 1 additional heteroatom independently selected from N, O, or S. Finally, m is 0-3.

In this embodiment, the method comprises the step of reacting a compound of Formula 5:

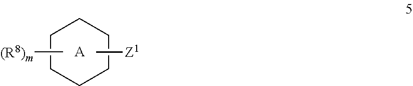

wherein Z¹ is —Cl, —Br, —I, or -Ots, with a compound of Formula 6:

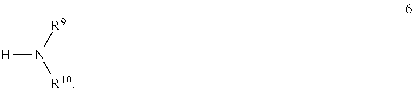

These reagents are reacted in the presence of a base, a solvent, and a catalyst comprising a palladium complex and a ligand of Formula I.

In yet another aspect, the present invention provides a method for preparing a compound of Formula VII:

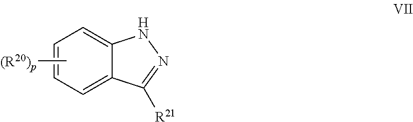

wherein each of R²⁰ is -Z^{C}R³⁰, wherein each Z^{C} is independently a bond or an optionally substituted branched or straight C₁₋₈ aliphatic chain wherein up to two carbon units of Z^{C} are optionally and independently replaced by —CO—, —CS—, —CONR^{C}—, —CONR^{C}NR^{c}—, —CO₂—, —OCO—, —NR^{C}CO₂—, —O—, —NR^{C}CONR^{C}—, —OCONR^{C}—, —S—, —S(O)—, —S(O)₂—, —NR^{C}—, —S(O)₂, —NR^{C}—, —NR^{C}S(O)₂—, or —NR^{A}S(O)₂NR^{C}—. Each R³⁰ is independently R^{D}, —OH, —NH₂, —NO₂, —CN, —CF₃, or —OCH₃. Each R^{D} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl. Alternatively, two vicinal R²⁰ groups together with the carbon atoms to which they are attached form an optionally substituted 5-7 membered fully saturated or partially unsaturated ring having 0-2 heteroatoms independently selected from N, O, and S. R²¹ is —H, methyl, ethyl, propyl, t-butyl, cyclopentyl, cyclohexyl, cycloheptyl, or phenyl, and p is 0-3.

The method of preparing a compound of Formula VII comprises the step of reacting a compound of Formula 8:

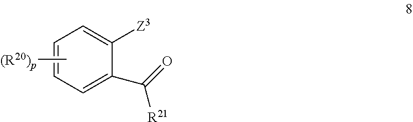

wherein Z³ is —Cl, —Br, I, or —OTs, and H₂NNH₂ in the presence of a base, a palladium complex, a solvent, and a ligand of Formula I.

Another aspect of the present invention provides a method for preparing a compound of Formula IX:

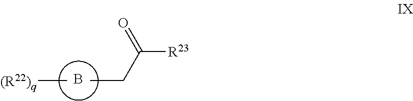

wherein ring B is a phenyl or a 5-6 membered heteroaryl having 1-2 heteroatoms independently selected from N, O, or S located at any chemically feasible position on Ring B. Each R²² is -Z^{D}R³¹, wherein each Z^{D} is independently a bond or an optionally substituted branched or straight C₁₋₈ aliphatic chain wherein up to two carbon units of Z^{D} are optionally and independently replaced by —CO—, —CS—, —CONR^{D}—, —CONR^{D}NR^{D}—, —CO₂—, —OCO—, —NR^{D}CO₂—, —O—, —N(R^{D})—, —NR^{D}CONR^{D}—, —OCONR^{D}—, —S—, —S(O)—, —S(O)₂—, —S(O)₂NR^{D}—, —NR^{D}S(O)₂—, or —NR^{D}S(O)₂NR^{C}. Each R³¹ is independently R^{D}, —OH, —NH₂, —NO₂, —CN, —CF₃, or —OCH₃. Each R^{D} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl. Alternatively, two vicinal R²² groups together with the carbon atoms to which they are attached form an optionally substituted 5-7 membered fully saturated or partially unsaturated ring having 0-2 heteroatoms independently selected from N, O, and S. R²³ is —H, methyl, ethyl, propyl, t-butyl, cyclopentyl, cyclohexyl, cycloheptyl, or phenyl, and q is 0-3.

The method of preparing a compound of Formula IX comprises the step of reacting a compound of Formula 10:

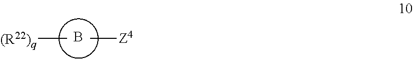

wherein Z⁴ is —Cl, —Br, —I, or —Ots, with a compound of Formula 11:

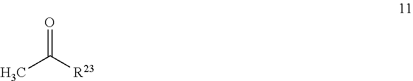

in the presence of a base, a solvent, and a catalyst comprising a palladium complex and a ligand of Formula I.

A further aspect of the present invention provides a method for preparing a compound of Formula XII:

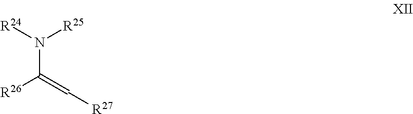

wherein R²⁴ and R²⁵ are independently selected from a C₁₋₈ alkyl or C₅₋₈ cycloalkyl, either of which is optionally substituted with phenyl; or R²⁴, R²⁵ and the nitrogen atom to which they are attached form an optionally substituted 5-8 membered heterocycloaliphatic having up to 1 additional ring heteroatom selected from N, O, or S. R²⁶ and R²⁷ are independently -Z^{E}R³², wherein each Z^{E} is independently a bond or an optionally substituted branched or straight C₁₋₆ aliphatic chain wherein up to two carbon units of Z^{E} are optionally and independently replaced by —CO—, —CS—, —CONR^{E}—, —CONR^{E}NR^{E}—, —CO₂—, —OCO—, —NR^{E}CO₂—, —O—, —N(R^{E})—, —NR^{E}CONR^{E}—, —OCONR^{E}—, —S—, —S(O)—, —S(O)₂—, —S(O)₂NR^{E}—, —NR^{E}S(O)₂—, or —NR^{E}S(O)₂NR^{E}—. Each R³² is independently R^{E}, —OH, —NH₂, —NO₂, —CN, —CF₃, or —OCH₃. Each R^{E} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl.

The method of preparing a compound of Formula XII comprises the step of reacting a compound of Formula 13:

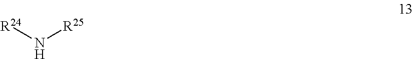

with a compound of Formula 14:

R²⁵—≡—R²⁶ 14

in the presence of a base, a solvent, and a catalyst comprising a gold complex and a ligand of Formula I.

### BRIEF DESCRIPTION OF THE DRAWINGS

The following figures are provided by way of example and are not intended to limit the scope of the claimed invention.

FIG. 1 is a graphical representation of the conversion of starting materials to enamine products via hydroamination of diphenylacetylene with morpholine according to the reaction protocols of Example 1.

FIG. 2 is a graphical representation of the ligand screen for palladium-catalyzed cross-coupling of aryl chlorides and toslyates with hydrazine according to the reaction protocols of Example 4.

FIG. 3 is an illustration of a structure solved novel palladium complex that was prepared according to the method described in Example 12A.

### DETAILED DESCRIPTION

The present invention provides novel compounds and ligands that are useful in transition metal catalyzed cross-coupling reactions. For example, the compounds and ligands of the present invention are useful in palladium or gold catalyzed cross-coupling reactions.

### I. DEFINITIONS

As described herein, compounds of the invention may optionally be substituted with one or more substituents, such as are illustrated generally above, or as exemplified by particular classes, subclasses, and species of the invention.

For purposes of this invention, the chemical elements are identified in accordance with the Periodic Table of the Elements, CAS version, Handbook of Chemistry and Physics, 75th Ed. Additionally, general principles of organic chemistry are described in “Organic Chemistry”, Thomas Sorrell, University Science Books, Sausalito: 1999, and “March's Advanced Organic Chemistry”, 5th Ed., Ed.: Smith, M. B. and March, J., John Wiley & Sons, New York: 2001, the entire contents of which are hereby incorporated by reference.

As described herein, compounds of the invention may optionally, be substituted with one or more substituents, such as are illustrated generally above, or as exemplified by particular classes, subclasses, and species of the invention.

As used herein, the terms “heterocyclic” and “heterocycle” refer to an optionally substituted heterocycloaliphatic or an optionally substituted heteroaryl. A heterocycle can be fused to a phenyl ring to provide a bicyclic heteroaryl (e.g., indoline or indoline-yl), or a heterocycle can be fused to a heteroaryl ring to provide a bicyclic heteroaryl (e.g., 2,3-dihydro-1H-pyrrolo[2,3-b]pyridine or 2,3-dihydro-1H-pyrrolo[2,3-b]pyridine-yl).

As used herein, the terms “carbocyclic” and “carbocycle” refer to an optionally substituted cycloaliphatic or an optionally substituted aryl. A carbocycle can be fused to a phenyl ring to provide a bicyclic aryl (e.g., 2,3-dihydro-1H-indene or 2,3-dihydro-1H-indene-yl), or a carbocycle can be fused to a heteroaryl to provide a bicyclic heteroaryl (e.g., 6,7-dihydro-5H-cyclopenta[b]pyridine or 6,7-dihydro-5H-cyclopenta[b]pyridine-yl).

As used herein the term “aliphatic” encompasses the terms alkyl, alkenyl, alkynyl, each of which being optionally substituted as set forth below.

As used herein, an “alkyl” group refers to a saturated aliphatic hydrocarbon group containing 1-12 (e.g., 1-8, 1-6 or 1-4) carbon atoms. An alkyl group can be straight or branched. Examples of alkyl groups include, but are not limited to, methyl, ethyl, propyl, isopropyl, butyl, isobutyl, sec-butyl, tert-butyl, n-pentyl, n-heptyl, or 2-ethylhexyl. An alkyl group can be substituted (i.e., optionally substituted) with one or more substituents such as halo; cycloaliphatic [e.g., cycloalkyl or cycloalkenyl]; heterocycloaliphatic [e.g., heterocycloalkyl or heterocycloalkenyl]; aryl; heteroaryl; alkoxy; aroyl; heteroaroyl; acyl [e.g., (aliphatic)carbonyl, (cycloaliphatic)carbonyl, or (heterocycloaliphatic)carbonyl]; nitro; cyano; amido [e.g., (cycloalkylalkyl)carbonylamino, arylcarbonylamino, aralkylcarbonylamino, (heterocycloalkyl)carbonylamino, (heterocycloalkylalkyl)carbonylamino, heteroarylcarbonylamino, heteroaralkylcarbonylamino alkylaminocarbonyl, cycloalkylaminocarbonyl, heterocycloalkylaminocarbonyl, arylaminocarbonyl, or heteroarylaminocarbonyl]; amino [e.g., aliphaticamino, cycloaliphaticamino, or heterocycloaliphaticamino]; sulfonyl [e.g., aliphatic-S(O)₂-]; sulfinyl; sulfanyl; sulfoxy; urea; thiourea; sulfamoyl; sulfamide; oxo; carboxy; carbamoyl; cycloaliphaticoxy; heterocycloaliphaticoxy; aryloxy; heteroaryloxy; aralkyloxy; heteroarylalkoxy; alkoxycarbonyl; alkylcarbonyloxy; or hydroxy. Without limitation, some examples of substituted alkyls include carboxyalkyl (such as HOOC-alkyl, alkoxycarbonylalkyl, and alkylcarbonyloxyalkyl); cyanoalkyl; hydroxyalkyl; alkoxyalkyl; acylalkyl; aralkyl; (alkoxyaryl)alkyl; (sulfonylamino)alkyl (such as alkyl-S(O)₂-aminoalkyl); aminoalkyl; amidoalkyl; (cycloaliphatic)alkyl; or haloalkyl.

As used herein, an “alkenyl” group refers to an aliphatic carbon group that contains 2-8 (e.g., 2-6 or 2-4) carbon atoms and at least one double bond. Like an alkyl group, an alkenyl group can be straight or branched. Examples of an alkenyl group include, but are not limited to, allyl, isoprenyl, 2-butenyl, and 2-hexenyl. An alkenyl group can be optionally substituted with one or more substituents such as halo; cycloaliphatic [e.g., cycloalkyl or cycloalkenyl]; heterocycloaliphatic [e.g., heterocycloalkyl or heterocycloalkenyl]; aryl; heteroaryl; alkoxy; aroyl; heteroaroyl; acyl [e.g., (aliphatic)carbonyl, (cycloaliphatic)carbonyl, or (heterocycloaliphatic)carbonyl]; nitro; cyano; amido [e.g., (cycloalkylalkyl)carbonylamino, arylcarbonylamino, aralkylcarbonylamino, (heterocycloalkyl)carbonylamino, (heterocycloalkylalkyl)carbonylamino, heteroarylcarbonylamino, heteroaralkylcarbonylamino, alkylaminocarbonyl, cycloalkylaminocarbonyl, heterocycloalkylaminocarbonyl, arylaminocarbonyl, or heteroarylaminocarbonyl]; amino [e.g., aliphaticamino, cycloaliphaticamino, heterocycloaliphaticamino, or aliphaticsulfonylamino]; sulfonyl [e.g., alkyl-S(O)₂—, cycloaliphatic-S(O)₂—, or aryl-S(O)₂—]; sulfinyl; sulfanyl; sulfoxy; urea; thiourea; sulfamoyl; sulfamide; oxo; carboxy; carbamoyl; cycloaliphaticoxy; heterocycloaliphaticoxy; aryloxy; heteroaryloxy; aralkyloxy; heteroaralkoxy; alkoxycarbonyl; alkylcarbonyloxy; or hydroxy. Without limitation, some examples of substituted alkenyls include cyanoalkenyl, alkoxyalkenyl, acylalkenyl, hydroxyalkenyl, aralkenyl, (alkoxyaryl)alkenyl, (sulfonylamino)alkenyl (such as (alkyl-S(O)₂-aminoalkenyl), aminoalkenyl, amidoalkenyl, (cycloaliphatic)alkenyl, or haloalkenyl.

As used herein, an “alkynyl” group refers to an aliphatic carbon group that contains 2-8 (e.g., 2-6 or 2-4) carbon atoms and has at least one triple bond. An alkynyl group can be straight or branched. Examples of an alkynyl group include, but are not limited to, propargyl and butynyl. An alkynyl group can be optionally substituted with one or more substituents such as aroyl; heteroaroyl; alkoxy; cycloalkyloxy; heterocycloalkyloxy; aryloxy; heteroaryloxy; aralkyloxy; nitro; carboxy; cyano; halo; hydroxy; sulfo; mercapto; sulfanyl [e.g., aliphatic-S— or cycloaliphatic-S-]; sulfinyl [e.g., aliphatic-S(O)— or cycloaliphatic-S(O)-]; sulfonyl [e.g., aliphatic-S(O)₂—, aliphaticamino-S(O)₂—, or cycloaliphatic-S(O)₂—]; amido [e.g., aminocarbonyl, alkylaminocarbonyl, alkylcarbonylamino, cycloalkylaminocarbonyl, heterocycloalkylaminocarbonyl, cycloalkylcarbonylamino, arylaminocarbonyl, arylcarbonylamino, aralkylcarbonylamino, (heterocycloalkyl)carbonylamino, (cycloalkylalkyl)carbonylamino, heteroaralkylcarbonylamino, heteroarylcarbonylamino or heteroarylaminocarbonyl]; urea; thiourea; sulfamoyl; sulfamide; alkoxycarbonyl; alkylcarbonyloxy; cycloaliphatic; heterocycloaliphatic; aryl; heteroaryl; acyl [e.g., (cycloaliphatic)carbonyl or (heterocycloaliphatic)carbonyl]; amino [e.g., aliphaticamino]; sulfoxy; oxo; carbamoyl; (cycloaliphatic)oxy; (heterocycloaliphatic)oxy; or (heteroaryl)alkoxy.

As used herein, an “amido” encompasses both “aminocarbonyl” and “carbonylamino”. These terms when used alone or in connection with another group refers to an amido group such as —N(R^{X})—C(O)—R^{Y} or —C(O)—N(R^{X})₂, when used terminally, and —C(O)—N(R^{X})— or —N(R^{X})—C(O)— when used internally, wherein R^{X} and R^{Y} are defined below. Examples of amido groups include alkylamido (such as alkylcarbonylamino or alkylaminocarbonyl), (heterocycloaliphatic)amido, (heteroaralkyl)amido, (heteroaryl)amido, (heterocycloalkyl)alkylamido, arylamido, aralkylamido, (cycloalkyl)alkylamido, or cycloalkylamido.

As used herein, an “amino” group refers to —NR^{X}R^{Y} wherein each of R^{X} and R^{Y} is independently hydrogen, alkyl, cycloaliphatic, (cycloaliphatic)aliphatic, aryl, araliphatic, heterocycloaliphatic, (heterocycloaliphatic)aliphatic, heteroaryl, carboxy, sulfanyl, sulfinyl, sulfonyl, (aliphatic)carbonyl, (cycloaliphatic)carbonyl, ((cycloaliphatic)aliphatic)carbonyl, arylcarbonyl, (araliphatic)carbonyl, (heterocycloaliphatic)carbonyl, ((heterocycloaliphatic)aliphatic)carbonyl, (heteroaryl)carbonyl, or (heteroaraliphatic)carbonyl, each of which being defined herein and being optionally substituted. Examples of amino groups include alkylamino, dialkylamino, or arylamino. When the term “amino” is not the terminal group (e.g., alkylcarbonylamino), it is represented by —NR^{X}—. R^{X} has the same meaning as defined above.

As used herein, an “aryl” group used alone or as part of a larger moiety as in “aralkyl”, “aralkoxy”, or “aryloxyalkyl” refers to monocyclic (e.g., phenyl); bicyclic (e.g., indenyl, naphthalenyl, tetrahydronaphthyl, tetrahydroindenyl); and tricyclic (e.g., fluorenyl, tetrahydrofluorenyl, tetrahydroanthracenyl, or anthracenyl) ring systems in which the monocyclic ring system is aromatic or at least one of the rings in a bicyclic or tricyclic ring system is aromatic. The bicyclic and tricyclic groups include benzofused 2-3 membered carbocyclic rings. For example, a benzofused group includes phenyl fused with two or more C₄₋₈ carbocyclic moieties. An aryl is optionally substituted with one or more substituents including aliphatic [e.g., alkyl, alkenyl, or alkynyl]; cycloaliphatic; (cycloaliphatic)aliphatic; heterocycloaliphatic; (heterocycloaliphatic)aliphatic; aryl; heteroaryl; alkoxy; (cycloaliphatic)oxy; (heterocycloaliphatic)oxy; aryloxy; heteroaryloxy; (araliphatic)oxy; (heteroaraliphatic)oxy; aroyl; heteroaroyl; amino; oxo (on a non-aromatic carbocyclic ring of a benzofused bicyclic or tricyclic aryl); nitro; carboxy; amido; acyl [e.g., aliphaticcarbonyl, (cycloaliphatic)carbonyl, ((cycloaliphatic)aliphatic)carbonyl, (araliphatic)carbonyl, (heterocycloaliphatic)carbonyl, ((heterocycloaliphatic)aliphatic)carbonyl, or (heteroaraliphatic)carbonyl]; sulfonyl [e.g., aliphatic-S(O)₂— or amino-S(O)₂—]; sulfinyl [e.g., aliphatic-S(O)— or cycloaliphatic-S(O)—]; sulfanyl [e.g., aliphatic-S—]; cyano; halo; hydroxy; mercapto; sulfoxy; urea; thiourea; sulfamoyl; sulfamide; or carbamoyl. Alternatively, an aryl can be unsubstituted.

Non-limiting examples of substituted aryls include haloaryl [e.g., mono-, di (such as p,m-dihaloaryl), and (trihalo)aryl]; (carboxy)aryl [e.g., (alkoxycarbonyl)aryl, ((aralkyl)carbonyloxy)aryl, and (alkoxycarbonyl)aryl]; (amido)aryl [e.g., (aminocarbonyl)aryl, (((alkylamino)alkyl)aminocarbonyl)aryl, (alkylcarbonyl)aminoaryl, (arylaminocarbonyl)aryl, and (((heteroaryl)amino)carbonyl)aryl]; aminoaryl [e.g., ((alkylsulfonyl)amino)aryl or ((dialkyl)amino)aryl]; (cyanoalkyl)aryl; (alkoxy)aryl; (sulfamoyl)aryl [e.g., (aminosulfonyl)aryl]; (alkylsulfonyl)aryl; (cyano)aryl; (hydroxyalkyl)aryl; ((alkoxy)alkyl)aryl; (hydroxy)aryl, ((carboxy)alkyl)aryl; (((dialkyl)amino)alkyl)aryl; (nitroalkyl)aryl; (((alkylsulfonyl)amino)alkyl)aryl; ((heterocycloaliphatic)carbonyl)aryl; ((alkylsulfonyl)alkyl)aryl; (cyanoalkyl)aryl; (hydroxyalkyl)aryl; (alkylcarbonyl)aryl; alkylaryl; (trihaloalkyl)aryl; p-amino-m-alkoxycarbonylaryl; p-amino-m-cyanoaryl; p-halo-m-aminoaryl; or (m-(heterocycloaliphatic)-o-(alkyl))aryl.

As used herein, an “araliphatic” such as an “aralkyl” group refers to an aliphatic group (e.g., a C₁₋₄ alkyl group) that is substituted with an aryl group. “Aliphatic,” “alkyl,” and “aryl” are defined herein. An example of an araliphatic such as an aralkyl group is benzyl.

As used herein, an “aralkyl” group refers to an alkyl group (e.g., a C₁₋₄ alkyl group) that is substituted with an aryl group. Both “alkyl” and “aryl” have been defined above. An example of an aralkyl group is benzyl. An aralkyl is optionally substituted with one or more substituents such as aliphatic [e.g., alkyl, alkenyl, or alkynyl, including carboxyalkyl, hydroxyalkyl, or haloalkyl such as trifluoromethyl]; cycloaliphatic [e.g., cycloalkyl or cycloalkenyl]; (cycloalkyl)alkyl; heterocycloalkyl; (heterocycloalkyl)alkyl; aryl; heteroaryl; alkoxy; cycloalkyloxy; heterocycloalkyloxy; aryloxy; heteroaryloxy; aralkyloxy; heteroaralkyloxy; aroyl; heteroaroyl; nitro; carboxy; alkoxycarbonyl; alkylcarbonyloxy; amido [e.g., aminocarbonyl, alkylcarbonylamino, cycloalkylcarbonylamino, (cycloalkylalkyl)carbonylamino, arylcarbonylamino, aralkylcarbonylamino, (heterocycloalkyl)carbonylamino, (heterocycloalkylalkyl)carbonylamino, heteroarylcarbonylamino, or heteroaralkylcarbonylamino]; cyano; halo; hydroxy; acyl; mercapto; alkylsulfanyl; sulfoxy; urea; thiourea; sulfamoyl; sulfamide; oxo; or carbamoyl.

As used herein, a “bicyclic ring system” includes 8-12 (e.g., 9, 10, or 11) membered structures that form two rings, wherein the two rings have at least one atom in common (e.g., 2 atoms in common). Bicyclic ring systems include bicycloaliphatics (e.g., bicycloalkyl or bicycloalkenyl), bicycloheteroaliphatics, bicyclic aryls, and bicyclic heteroaryls.

As used herein, a “cycloaliphatic” group encompasses a “cycloalkyl” group and a “cycloalkenyl” group, each of which being optionally substituted as set forth below.

As used herein, a “cycloalkyl” group refers to a saturated carbocyclic mono- or bicyclic (fused or bridged) ring of 3-10 (e.g., 5-10) carbon atoms. Examples of cycloalkyl groups include cyclopropyl, cyclobutyl, cyclopentyl, cyclohexyl, cycloheptyl, adamantyl, norbornyl, cubyl, octahydro-indenyl, decahydro-naphthyl, bicyclo[3.2.1]octyl, bicyclo[2.2.2]octyl, bicyclo[3.3.1]nonyl, bicyclo[3.3.2.]decyl, bicyclo[2.2.2]octyl, adamantyl, azacycloalkyl, or ((aminocarbonyl)cycloalkyl)cycloalkyl.

A “cycloalkenyl” group, as used herein, refers to a non-aromatic carbocyclic ring of 3-10 (e.g., 4-8) carbon atoms having one or more double bonds. Examples of cycloalkenyl groups include cyclopentenyl, 1,4-cyclohexa-di-enyl, cycloheptenyl, cyclooctenyl, hexahydro-indenyl, octahydro-naphthyl, cyclohexenyl, cyclopentenyl, bicyclo[2.2.2]octenyl, or bicyclo[3.3.1]nonenyl.

A cycloalkyl or cycloalkenyl group can be optionally substituted with one or more substituents such as aliphatic [e.g., alkyl, alkenyl, or alkynyl]; cycloaliphatic; (cycloaliphatic)aliphatic; heterocycloaliphatic; (heterocycloaliphatic) aliphatic; aryl; heteroaryl; alkoxy; (cycloaliphatic)oxy; (heterocycloaliphatic)oxy; aryloxy; heteroaryloxy; (araliphatic)oxy; (heteroaraliphatic)oxy; aroyl; heteroaroyl; amino; amido [e.g., (aliphatic)carbonylamino, (cycloaliphatic)carbonylamino, ((cycloaliphatic)aliphatic)carbonylamino, (aryl)carbonylamino, (araliphatic)carbonylamino, (heterocycloaliphatic)carbonylamino, ((heterocycloaliphatic)aliphatic)carbonylamino, (heteroaryl)carbonylamino, or (heteroaraliphatic)carbonylamino]; nitro; carboxy [e.g., HOOC—, alkoxycarbonyl, or alkylcarbonyloxy]; acyl [e.g., (cycloaliphatic)carbonyl, ((cycloaliphatic) aliphatic)carbonyl, (araliphatic)carbonyl, (heterocycloaliphatic)carbonyl, ((heterocycloaliphatic)aliphatic)carbonyl, or (heteroaraliphatic)carbonyl]; cyano; halo; hydroxy; mercapto; sulfonyl [e.g., alkyl-S(O)₂— and aryl-S(O)₂—]; sulfinyl [e.g., alkyl-S(O)—]; sulfanyl [e.g., alkyl-S-]; sulfoxy; urea; thiourea; sulfamoyl; sulfamide; oxo; or carbamoyl.

As used herein, the term “heterocycloaliphatic” encompasses a heterocycloalkyl group and a heterocycloalkenyl group, each of which being optionally substituted as set forth below.

As used herein, a “heterocycloalkyl” group refers to a 3-10 membered mono- or bicylic (fused or bridged) (e.g., 5- to 10-membered mono- or bicyclic) saturated ring structure, in which one or more of the ring atoms is a heteroatom (e.g., N, O, S, or combinations thereof). Examples of a heterocycloalkyl group include piperidyl, piperazyl, tetrahydropyranyl, tetrahydrofuryl, 1,4-dioxolanyl, 1,4-dithianyl, 1,3-dioxolanyl, oxazolidyl, isoxazolidyl, morpholinyl, thiomorpholyl, octahydrobenzofuryl, octahydrochromenyl, octahydrothiochromenyl, octahydroindolyl, octahydropyrindinyl, decahydroquinolinyl, octahydrobenzo[b]thiopheneyl, 2-oxa-bicyclo[2.2.2]octyl, 1-aza-bicyclo[2.2.2]octyl, 3-aza-bicyclo[3.2.1]octyl, and 2,6-dioxa-tricyclo[3.3.1.0^{3,7}]nonyl. A monocyclic heterocycloalkyl group can be fused with a phenyl moiety such as tetrahydroisoquinoline to produce a heteroaryl group.

A “heterocycloalkenyl” group, as used herein, refers to a mono- or bicylic (e.g., 5- to 10-membered mono- or bicyclic) non-aromatic ring structure having one or more double bonds, and wherein one or more of the ring atoms is a heteroatom (e.g., N, O, or S).

Monocyclic and bicycloheteroaliphatics are numbered according to standard chemical nomenclature.

A heterocycloalkyl or heterocycloalkenyl group can be optionally substituted with one or more substituents such as aliphatic [e.g., alkyl, alkenyl, or alkynyl]; cycloaliphatic; (cycloaliphatic)aliphatic; heterocycloaliphatic; (heterocycloaliphatic)aliphatic; aryl; heteroaryl; alkoxy; (cycloaliphatic)oxy; (heterocycloaliphatic)oxy; aryloxy; heteroaryloxy; (araliphatic)oxy; (heteroaraliphatic)oxy; aroyl; heteroaroyl; amino; amido [e.g., (aliphatic)carbonylamino, (cycloaliphatic)carbonylamino, ((cycloaliphatic) aliphatic)carbonylamino, (aryl)carbonylamino, (araliphatic)carbonylamino, (heterocycloaliphatic)carbonylamino, ((heterocycloaliphatic) aliphatic)carbonylamino, (heteroaryl)carbonylamino, or (heteroaraliphatic)carbonylamino]; nitro; carboxy [e.g., HOOC—, alkoxycarbonyl, or alkylcarbonyloxy]; acyl [e.g., (cycloaliphatic)carbonyl, ((cycloaliphatic) aliphatic)carbonyl, (araliphatic)carbonyl, (heterocycloaliphatic)carbonyl, ((heterocycloaliphatic)aliphatic)carbonyl, or (heteroaraliphatic)carbonyl]; nitro; cyano; halo; hydroxy; mercapto; sulfonyl [e.g., alkylsulfonyl or arylsulfonyl]; sulfinyl [e.g., alkylsulfinyl]; sulfanyl [e.g., alkylsulfanyl]; sulfoxy; urea; thiourea; sulfamoyl; sulfamide; oxo; or carbamoyl.

A “heteroaryl” group, as used herein, refers to a monocyclic, bicyclic, or tricyclic ring system having 4 to 15 ring atoms wherein one or more of the ring atoms is a heteroatom (e.g., N, O, S, or combinations thereof) and in which the monocyclic ring system is aromatic or at least one of the rings in the bicyclic or tricyclic ring systems is aromatic. A heteroaryl group includes a benzofused ring system having 2 to 3 rings. For example, a benzofused group includes benzo fused with one or two 4 to 8 membered heterocycloaliphatic moieties (e.g., indolizyl, indolyl, isoindolyl, 3H-indolyl, indolinyl, benzo[b]furyl, benzo[b]thiophenyl, quinolinyl, or isoquinolinyl). Some examples of heteroaryl are azetidinyl, pyridyl, 1H-indazolyl, furyl, pyrrolyl, thienyl, thiazolyl, oxazolyl, imidazolyl, tetrazolyl, benzofuryl, isoquinolinyl, benzthiazolyl, xanthene, thioxanthene, phenothiazine, dihydroindole, benzo[1,3]dioxole, benzo[b]furyl, benzo[b]thiophenyl, indazolyl, benzimidazolyl, benzthiazolyl, puryl, cinnolyl, quinolyl, quinazolyl, cinnolyl, phthalazyl, quinazolyl, quinoxalyl, isoquinolyl, 4H-quinolizyl, benzo-1,2,5-thiadiazolyl, or 1,8-naphthyridyl.

Without limitation, monocyclic heteroaryls include furyl, thiophenyl, 2H-pyrrolyl, pyrrolyl, oxazolyl, thazolyl, imidazolyl, pyrazolyl, isoxazolyl, isothiazolyl, 1,3,4-thiadiazolyl, 2H-pyranyl, 4-H-pranyl, pyridyl, pyridazyl, pyrimidyl, pyrazolyl, pyrazyl, or 1,3,5-triazyl. Monocyclic heteroaryls are numbered according to standard chemical nomenclature.

Without limitation, bicyclic heteroaryls include indolizyl, indolyl, isoindolyl, 3H-indolyl, indolinyl, benzo[b]furyl, benzo[b]thiophenyl, quinolinyl, isoquinolinyl, indolizyl, isoindolyl, indolyl, benzo[b]furyl, bexo[b]thiophenyl, indazolyl, benzimidazyl, benzthiazolyl, purinyl, 4H-quinolizyl, quinolyl, isoquinolyl, cinnolyl, phthalazyl, quinazolyl, quinoxalyl, 1,8-naphthyridyl, or pteridyl. Bicyclic heteroaryls are numbered according to standard chemical nomenclature.

A heteroaryl is optionally substituted with one or more substituents such as aliphatic [e.g., alkyl, alkenyl, or alkynyl]; cycloaliphatic; (cycloaliphatic)aliphatic; heterocycloaliphatic; (heterocycloaliphatic)aliphatic; aryl; heteroaryl; alkoxy; (cycloaliphatic)oxy; (heterocycloaliphatic)oxy; aryloxy; heteroaryloxy; (araliphatic)oxy; (heteroaraliphatic)oxy; aroyl; heteroaroyl; amino; oxo (on a non-aromatic carbocyclic or heterocyclic ring of a bicyclic or tricyclic heteroaryl); carboxy; amido; acyl [e.g., aliphaticcarbonyl; (cycloaliphatic)carbonyl; ((cycloaliphatic)aliphatic)carbonyl; (araliphatic)carbonyl; (heterocycloaliphatic)carbonyl; ((heterocycloaliphatic)aliphatic)carbonyl; or (heteroaraliphatic)carbonyl]; sulfonyl [e.g., aliphatic-S(O)₂— or amino-S(O)₂—]; sulfinyl [e.g., aliphatic-S(O)—]; sulfanyl [e.g., aliphatic-S-]; nitro; cyano; halo; hydroxy; mercapto; sulfoxy; urea; thiourea; sulfamoyl; sulfamide; or carbamoyl. Alternatively, a heteroaryl can be unsubstituted.

Non-limiting examples of substituted heteroaryls include (halo)heteroaryl [e.g., mono- and di-(halo)heteroaryl]; (carboxy)heteroaryl [e.g., (alkoxycarbonyl)heteroaryl]; cyanoheteroaryl; aminoheteroaryl [e.g., ((alkylsulfonyl)amino)heteroaryl and ((dialkyl)amino)heteroaryll; (amido)heteroaryl [e.g., aminocarbonylheteroaryl, ((alkylcarbonyl)amino)heteroaryl, ((((alkyl)amino)alkyl)aminocarbonyl)heteroaryl, (((heteroaryl)amino)carbonyl)heteroaryl, ((heterocycloaliphatic)carbonyl)heteroaryl, and ((alkylcarbonyl)amino)heteroaryl]; (cyanoalkyl)heteroaryl; (alkoxy)heteroaryl; (sulfamoyl)heteroaryl [e.g., (aminosulfonyl)heteroaryl]; (sulfonyl)heteroaryl [e.g., (alkylsulfonyl)heteroaryl]; (hydroxyalkyl)heteroaryl; (alkoxyalkyl)heteroaryl; (hydroxy)heteroaryl; ((carboxy)alkyl)heteroaryl; [((dialkyl)amino)alkyl]heteroaryl; (heterocycloaliphatic)heteroaryl; (cycloaliphatic)heteroaryl; (nitroalkyl)heteroaryl; (((alkylsulfonyl)amino)alkyl)heteroaryl; ((alkylsulfonyl)alkyl)heteroaryl; (cyanoalkyl)heteroaryl; (acyl)heteroaryl [e.g., (alkylcarbonypheteroaryl]; (alkyl)heteroaryl, and (haloalkyl)heteroaryl [e.g., trihaloalkylheteroaryl].

A “heteroaraliphatic” (such as a heteroaralkyl group) as used herein, refers to an aliphatic group (e.g., a C₁₋₄ alkyl group) that is substituted with a heteroaryl group. “Aliphatic,” “alkyl,” and “heteroaryl” have been defined above.

A “heteroaralkyl” group, as used herein, refers to an alkyl group (e.g., a C₁₋₄ alkyl group) that is substituted with a heteroaryl group. Both “alkyl” and “heteroaryl” have been defined above. A heteroaralkyl is optionally substituted with one or more substituents such as alkyl (e.g., carboxyalkyl, hydroxyalkyl, and haloalkyl such as trifluoromethyl); alkenyl; alkynyl; cycloalkyl; (cycloalkyl)alkyl; heterocycloalkyl; (heterocycloalkyl)alkyl; aryl; heteroaryl; alkoxy; cycloalkyloxy; heterocycloalkyloxy; aryloxy; heteroaryloxy; aralkyloxy; heteroaralkyloxy; aroyl; heteroaroyl; nitro; carboxy; alkoxycarbonyl; alkylcarbonyloxy; aminocarbonyl; alkylcarbonylamino; cycloalkylcarbonylamino; (cycloalkylalkyl)carbonylamino; arylcarbonylamino; aralkylcarbonylamino; (heterocycloalkyl)carbonylamino; (heterocycloalkylalkyl)carbonylamino; heteroarylcarbonylamino; heteroaralkylcarbonylamino; cyano; halo; hydroxy; acyl; mercapto; alkylsulfanyl; sulfoxy; urea; thiourea; sulfamoyl; sulfamide; oxo; or carbamoyl.

As used herein, an “acyl” group refers to a formyl group or R^{X}—C(O)— (such as -alkyl-C(O)—, also referred to as “alkylcarbonyl”) where Rx and “alkyl” have been defined previously. Acetyl and pivaloyl are examples of acyl groups.

As used herein, an “aroyl” or “heteroaroyl” refers to an aryl-C(O)— or a heteroaryl-C(O)—. The aryl and heteroaryl portion of the aroyl or heteroaroyl is optionally substituted as previously defined.

As used herein, an “alkoxy” group refers to an alkyl-O— group where “alkyl” has been defined previously.

As used herein, a “carbamoyl” group refers to a group having the structure —O—CO—NR^{X}R^{Y} or —NR^{X}—CO—O—R^{Z}, wherein R^{X} and R^{Y} have been defined above and Rz can be aliphatic, aryl, araliphatic, heterocycloaliphatic, heteroaryl, or heteroaraliphatic.

As used herein, a “carboxy” group refers to —COOH, —COOR^{X}, —OC(O)H, —OC(O)R^{X} when used as a terminal group; or —OC(O)— or —C(O)O— when used as an internal group.

As used herein, a “haloaliphatic” group refers to an aliphatic group substituted with 1-3 halogen. For instance, the term haloalkyl includes the group —CF₃.

As used herein, a “mercapto” group refers to —SH.

As used herein, a “sulfo” group refers to —SO₃H or —SO₃R^{X} when used terminally or —S(O)₃— when used internally.

As used herein, a “sulfamide” group refers to the structure —NR^{X}—S(O)₂—NR^{Y}R^{Z} when used terminally and —NR^{X}—S(O)₂—NR^{Y}— when used internally, wherein R^{X}, R^{Y}, and R^{Z} have been defined above.

As used herein, a “sulfamoyl” group refers to the structure —S(O)₂—NR^{X}R^{Y} or —NR^{X}—S(O)₂—R^{Z} when used terminally; or —S(O)₂—NR^{X}— or —NR^{X}—S(O)₂— when used internally, wherein R^{X}, R^{Y}, and R^{Z} are defined above.

As used herein a “sulfanyl” group refers to —S—R^{X} when used terminally and —S— when used internally, wherein R^{X} has been defined above. Examples of sulfanyls include aliphatic-S—, cycloaliphatic-S—, aryl-S—, or the like.

As used herein a “sulfinyl” group refers to —S(O)—R^{X} when used terminally and —S(O)— when used internally, wherein R^{X} has been defined above. Exemplary sulfinyl groups include aliphatic-S(O)—, aryl-S(O)—, (cycloaliphatic(aliphatic))-S(O)—, cycloalkyl-S(O)—, heterocycloaliphatic-S(O)—, heteroaryl-S(O)—, or the like.

As used herein, a “sulfonyl” group refers to —S(O)₂—R^{X} when used terminally and —S(O)₂— when used internally, wherein R^{X} has been defined above. Exemplary sulfonyl groups include aliphatic-S(O)₂—, aryl-S(O)₂—, (cycloaliphatic(aliphatic))-S(O)₂—, cycloaliphatic-S(O)₂—, heterocycloaliphatic-S(O)₂—, heteroaryl-S(O)₂—, (cycloaliphatic(amido(aliphatic)))-S(O)₂— or the like.

As used herein, a “sulfoxy” group refers to —O—SO—R^{X} or —SO—O—R^{X}, when used terminally and —O—S(O)— or —S(O)—O— when used internally, where R^{X} has been defined above.

As used herein, a “halogen” or “halo” group refers to fluorine, chlorine, bromine or iodine.

As used herein, an “alkoxycarbonyl,” which is encompassed by the term carboxy, used alone or in connection with another group refers to a group such as alkyl-O—C(O)—.

As used herein, an “alkoxyalkyl” refers to an alkyl group such as alkyl-O-alkyl-, wherein alkyl has been defined above.

As used herein, a “carbonyl” refer to —C(O)—.

As used herein, an “oxo” refers to ═O.

As used herein, an “aminoalkyl” refers to the structure (R^{X})₂N-alkyl-.

As used herein, a “cyanoalkyl” refers to the structure (NC)-alkyl-.

As used herein, a “urea” group refers to the structure —NR^{X}—CO—NR^{Y}R^{Z} and a “thiourea” group refers to the structure —NR^{X}—CS—NR^{Y}R^{Z} when used terminally and —NR^{X}—CO—NR^{Y}— or —NR^{X}—CS—NR^{Y}— when used internally, wherein R^{X}, R^{Y}, and R^{Z} have been defined above.

As used herein, a “guanidino” group refers to the structure —N═C(N(R^{X}R^{Y}))N(R^{X}R^{Y}) wherein R^{X} and R^{Y} have been defined above.

As used herein, the term “amidino” group refers to the structure —C═(NR^{X})N(R^{X}R^{Y}) wherein R^{X} and R^{Y} have been defined above.

In general, the term “vicinal” refers to the placement of substituents on a group that includes two or more carbon atoms, wherein the substituents are attached to adjacent carbon atoms.

In general, the term “geminal” refers to the placement of substituents on a group that includes two or more carbon atoms, wherein the substituents are attached to the same carbon atom.

The terms “terminally” and “internally” refer to the location of a group within a substituent. A group is terminal when the group is present at the end of the substituent not further bonded to the rest of the chemical structure. Carboxyalkyl, i.e., R^{X}O(O)C-alkyl is an example of a carboxy group used terminally. A group is internal when the group is present in the middle of a substituent to at the end of the substituent bound to the rest of the chemical structure. Alkylcarboxy (e.g., alkyl-C(O)O— or alkyl-OC(O)—) and alkylcarboxyaryl (e.g., alkyl-C(O)O-aryl- or alkyl-O(CO)-aryl-) are examples of carboxy groups used internally.

As used herein, the term “amidino” group refers to the structure —C═(NR^{X})N(R^{X}R^{Y}) wherein R^{X} and R^{Y} have been defined above.

As used herein, a “bridged bicyclic ring system” refers to a bicyclic heterocyclicalipahtic ring system or bicyclic cycloaliphatic ring system in which the rings are bridged. Examples of bridged bicyclic ring systems include, but are not limited to, adamantanyl, norbornanyl, bicyclo[3.2.1]octyl, bicyclo[2.2.2]octyl, bicyclo[3.3.1]nonyl, bicyclo[3.2.3]nonyl, 2-oxa-bicyclo[2.2.2]octyl, 1-aza-bicyclo[2.2.2]octyl, 3-aza-bicyclo[3.2.1]octyl, and 2,6-dioxa-tricyclo[3.3.1.^{3,7}]nonyl. A bridged bicyclic ring system can be optionally substituted with one or more substituents such as alkyl (including carboxyalkyl, hydroxyalkyl, and haloalkyl such as trifluoromethyl), alkenyl, alkynyl, cycloalkyl, (cycloalkyl)alkyl, heterocycloalkyl, (heterocycloalkyl)alkyl, aryl, heteroaryl, alkoxy, cycloalkyloxy, heterocycloalkyloxy, aryloxy, heteroaryloxy, aralkyloxy, heteroaralkyloxy, aroyl, heteroaroyl, nitro, carboxy, alkoxycarbonyl, alkylcarbonyloxy, aminocarbonyl, alkylcarbonylamino, cycloalkylcarbonylamino, (cycloalkylalkyl)carbonylamino, arylcarbonylamino, aralkylcarbonylamino, (heterocycloalkyl)carbonylamino, (heterocycloalkylalkyl)carbonylamino, heteroarylcarbonylamino, heteroaralkylcarbonylamino, cyano, halo, hydroxy, acyl, mercapto, alkylsulfanyl, sulfoxy, urea, thiourea, sulfamoyl, sulfamide, oxo, or carbamoyl.

As used herein, “cyclic group” or “cyclic moiety” include mono-, bi-, and tri-cyclic ring systems including cycloaliphatic, heterocycloaliphatic, aryl, or heteroaryl, each of which has been previously defined.

As used herein, an “aliphatic chain” refers to a branched or straight aliphatic group (e.g., alkyl groups, alkenyl groups, or alkynyl groups). A straight aliphatic chain has the structure —[CH₂]ᵥ—, where v is 1-12. A branched aliphatic chain is a straight aliphatic chain that is substituted with one or more aliphatic groups. A branched aliphatic chain has the structure —[CQQ]ᵥ— where Q is independently hydrogen or an aliphatic group; however, Q shall be an aliphatic group in at least one instance. The term aliphatic chain includes alkyl chains, alkenyl chains, and alkynyl chains, where alkyl, alkenyl, and alkynyl are defined above.

The phrase “optionally substituted” is used interchangeably with the phrase “substituted or unsubstituted.” As described herein, compounds of the invention can optionally be substituted with one or more substituents, such as are illustrated generally above, or as exemplified by particular classes, subclasses, and species of the invention. As described herein, the variables R₁, R₂, R₃, R₄, R₅, R₆, R₇, R₈, R₉, R₁₀, R₁₁, R₁₂, R₁₃, R₂₀, R₂₁, R₂₂, R₂₃, and other variables contained therein encompass specific groups, such as alkyl and aryl. Unless otherwise noted, each of the specific groups for the variables R₁, R₂, R₃, R₄, R₅, R₆, R₇, R₈, R₉, R₁₀, R₁₁, R₁₂, R₁₃, R₂₀, R₂₁, R₂₂, R₂₃, and other variables contained therein can be optionally substituted with one or more substituents described herein. Each substituent of a specific group is further optionally substituted with one to three of halo, cyano, oxoalkoxy, hydroxy, amino, nitro, aryl, haloalkyl, and alkyl. For instance, an alkyl group can be substituted with alkylsulfanyl and the alkylsulfanyl can be optionally substituted with one to three of halo, cyano, oxoalkoxy, hydroxy, amino, nitro, aryl, haloalkyl, and alkyl. As an additional example, the cycloalkyl portion of a (cycloalkyl)carbonylamino can be optionally substituted with one to three of halo, cyano, alkoxy, hydroxy, nitro, haloalkyl, and alkyl. When two alkoxy groups are bound to the same atom or adjacent atoms, the two alkoxy groups can form a ring together with the atom(s) to which they are bound.

In general, the term “substituted,” whether preceded by the term “optionally” or not, refers to the replacement of hydrogen radicals in a given structure with the radical of a specified substituent. Specific substituents are described above in the definitions and below in the description of compounds and examples thereof. Unless otherwise indicated, an optionally substituted group can have a substituent at each substitutable position of the group, and when more than one position in any given structure can be substituted with more than one substituent selected from a specified group, the substituent can be either the same or different at every position. A ring substituent, such as a heterocycloalkyl, can be bound to another ring, such as a cycloalkyl, to form a spiro-bicyclic ring system, e.g., both rings share one common atom. As one of ordinary skill in the art will recognize, combinations of substituents envisioned by this invention are those combinations that result in the formation of stable or chemically feasible compounds.

The phrase “stable or chemically feasible,” as used herein, refers to compounds that are not substantially altered when subjected to conditions to allow for their production, detection, and preferably their recovery, purification, and use for one or more of the purposes disclosed herein. In some embodiments, a stable compound or chemically feasible compound is one that is not substantially altered when kept at a temperature of 40° C. or less, in the absence of moisture or other chemically reactive conditions, for at least a week.

Unless otherwise stated, structures depicted herein are also meant to include all isomeric (e.g., enantiomeric, diastereomeric, and geometric (or conformational)) forms of the structure; for example, the R and S configurations for each asymmetric center, (Z) and (E) double bond isomers, and (Z) and (E) conformational isomers. Therefore, single stereochemical isomers as well as enantiomeric, diastereomeric, and geometric (or conformational) mixtures of the present compounds are within the scope of the invention.

Unless otherwise stated, all tautomeric forms of the compounds of the invention are within the scope of the invention.

Additionally, unless otherwise stated, structures depicted herein are also meant to include compounds that differ only in the presence of one or more isotopically enriched atoms. For example, compounds having the present structures except for the replacement of hydrogen by deuterium or tritium, or the replacement of a carbon by a ¹³C- or ¹⁴C-enriched carbon are within the scope of this invention. Such compounds are useful, for example, as analytical tools or probes in biological assays.

### II. COMPOUNDS AND LIGANDS

One aspect of the present invention provides a compound of Formula I:

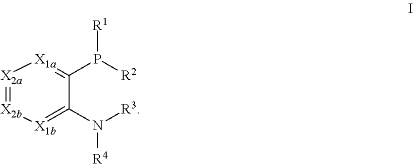

In Formula I, each of R¹ and R² is independently selected from tert-butyl, cyclohexyl, 2-tolyl, or 1-adamantyl. Each of R³ and R⁴ is independently selected from a C₁₋₅ alkyl, or R³, R⁴, and the nitrogen atom to which they are attached form an optionally substituted 4-10 membered heterocyclic ring. Each of X₁ₐ and X_{1b}, is independently selected from N or C—R⁵; and each of X₂ₐ and X_{2b}, is independently selected from N or C—R⁶. Each R⁵ is independently selected from —H, —CH₃, —OCH₃, halogen, or —CF₃; and each R⁶ is independently selected from —H, —CH₃, —OCH₃, —N(CH₃)₂, halogen, or —CF₃; or vicinal R⁵ and R⁶ groups together with the carbon atoms to which they are attached form an optionally substituted 5-7 membered heterocyclic or carbocyclic ring; or two R⁶ groups together with the carbon atoms to which they are attached form an optionally substituted 5-7 membered heterocyclic or carbocyclic ring. And, no more than one of X₁ₐ, X_{1b}, X₂ₐ, or X_{2b} is N.

A. R¹ and R²Groups

In some embodiments, each of R¹ and R² is independently selected from tert-butyl, cyclohexyl, 2-tolyl, or 1-adamarityl.

In some embodiments, each of R¹ and R² is independently selected from tert-butyl, cyclohexyl, 2-tolyl, or 1-adamantyl, and R¹ is a different moiety than R².

In other embodiments, both R¹ and R² are tert-butyl, cyclohexyl, 2-tolyl, or 1-adamantyl. For example, both of R¹ and R² are tert-butyl or 1-adamantyl. In some instances, both of R¹ and R² are 1-adamantyl. In some instances, both of R¹ and R² are tert-butyl. In some instances, both of R¹ and R² are cyclohexyl. In some instances, both of R¹ and R² are 2-tolyl.

B. R³ and R⁴Groups

In some embodiments, each of R³ and R⁴ is independently selected from a C₁₋₅ alkyl, or R³, R⁴, and the nitrogen atom to which they are attached form an optionally substituted 4-10 membered heterocyclic ring.

In some embodiments, both of R³ and R⁴ are C₁₋₅ alkyl. For example, both of R³ and R⁴ are methyl, ethyl, propyl, iso-propyl, or tert-butyl. And, in some instances, both of R³ and R⁴ are methyl, ethyl, or propyl.

In some embodiments, R³, R⁴, and the nitrogen atom to which they are attached form an optionally substituted 4-10 membered heterocyclic ring. In some examples, R³, R⁴, and the nitrogen atom to which they are attached form an optionally substituted ring selected from

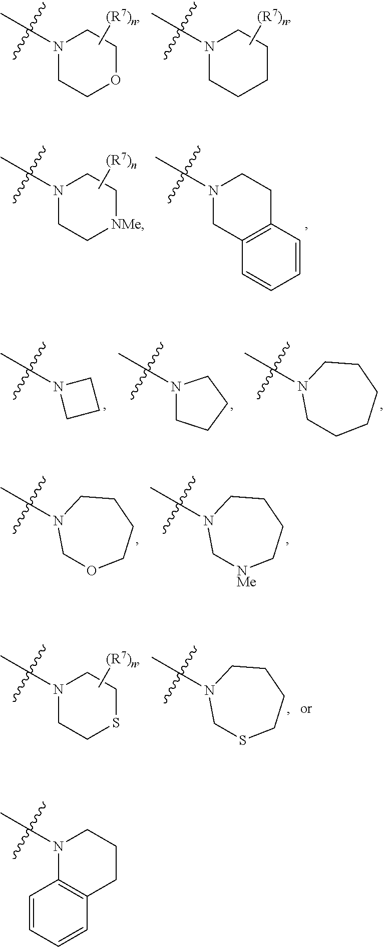

wherein n is 0-2, and R⁷ is —CH₃.

In other embodiments, R³, R⁴, and the nitrogen atom to which they are attached form

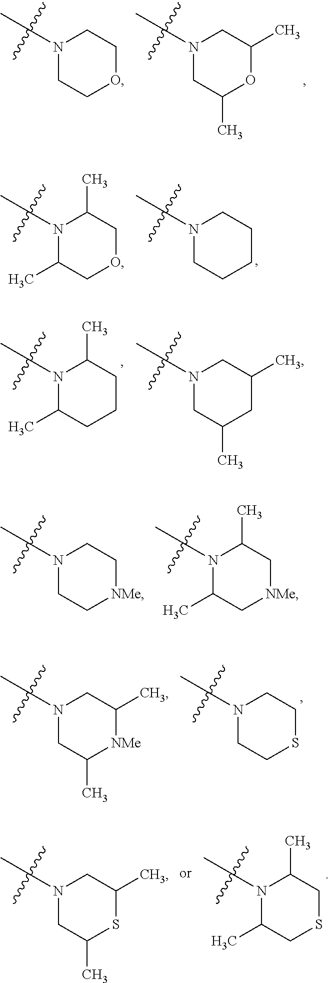

C. X₁ₐ, X_{1b}, X₂ₐ, and X_{2b}

In some embodiments, each of X₁ₐ and X_{1b} is independently selected from N or C—R⁵; and each of X₂ₐ and X_{2b}, is independently selected from N or C—R⁶. Each R⁵ is independently selected from —H, —CH₃, —OCH₃, halogen, or —CF₃; and each R⁶ is independently selected from —H, —CH₃, —OCH₃, —N(CH₃)₂, halogen, or —CF₃; or an R⁵ and an R⁶ located on adjacent, i.e., vicinal, carbon atoms together with the carbon atoms to which they are attached form an optionally substituted 5-7 membered heterocyclic or cycloaliphatic ring; or two R⁶ groups together with the carbon atoms to which they are attached form an optionally substituted 5-7 membered heterocyclic or carbocyclic ring. No more than one of X₁ₐ, X_{1b}, X₂ₐ, or X_{2b} is N.

In some embodiments, X₁ₐ is N, X_{1b}, is C—R⁵, and each of X₂ₐ and X_{2b} are C—R⁶.

In some embodiments, X_{1b} is N, X₁ₐ is C—R⁵, and each of X₂ₐ and X_{2b} are C—R⁶.

In some embodiments, X₂ₐ is N, X_{2b} is C—R⁶, and each of X₁ₐ and X₁ₐ are C—R⁵.

In some embodiments, X_{2b} is N, X₂ₐ is C—R⁶, and each of X₁ₐ and X_{1b} are C—R⁵.

In some embodiments, each of X₁ₐ and X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or an R⁵ and an R⁶ located on adjacent carbon atoms together with the carbon atoms to which they are attached form an optionally substituted 5-7 membered heterocyclic or carbocyclic ring. For example, each of X₁ₐ, X_{1b}, X₂ₐ, and X_{2b} is C—H.

D. Sub-Generic Compounds and Ligands

In other embodiments, the compound of Formula I is a compound of Formula IA:

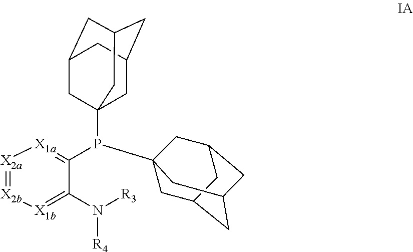

wherein each of R³, R⁴, X₁ₐ, X_{1b}, X₂ₐ, and X_{2b} is defined above in Formula I.

In some embodiments, the compound of Formula I is a compound of Formula IB:

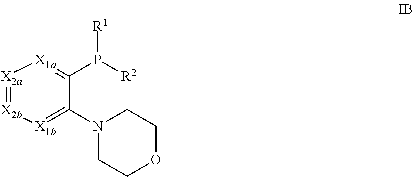

wherein each of R¹, R², X₁ₐ, X_{1b}, X₂ₐ, and X_{2b} is defined above in Formula I.

In some embodiments, the compound of Formula I is a compound of Formula IC:

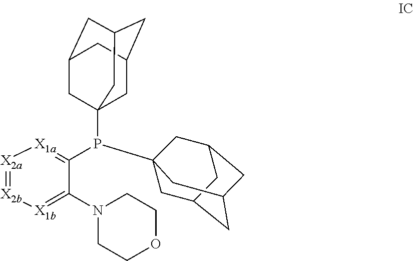

wherein each of X₁ₐ, X_{1b}, X₂ₐ, and X_{2b} is defined above in Formula I.

And in some embodiments, the compound of Formula I is selected from

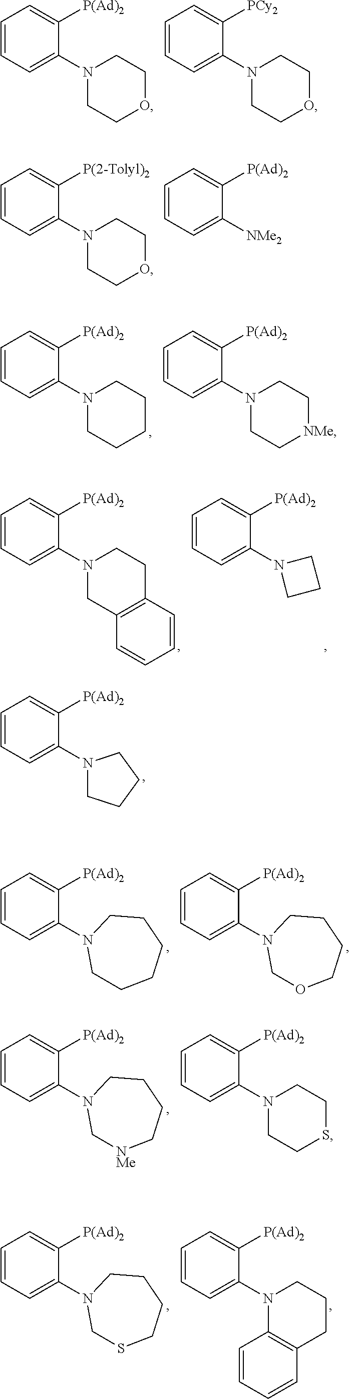

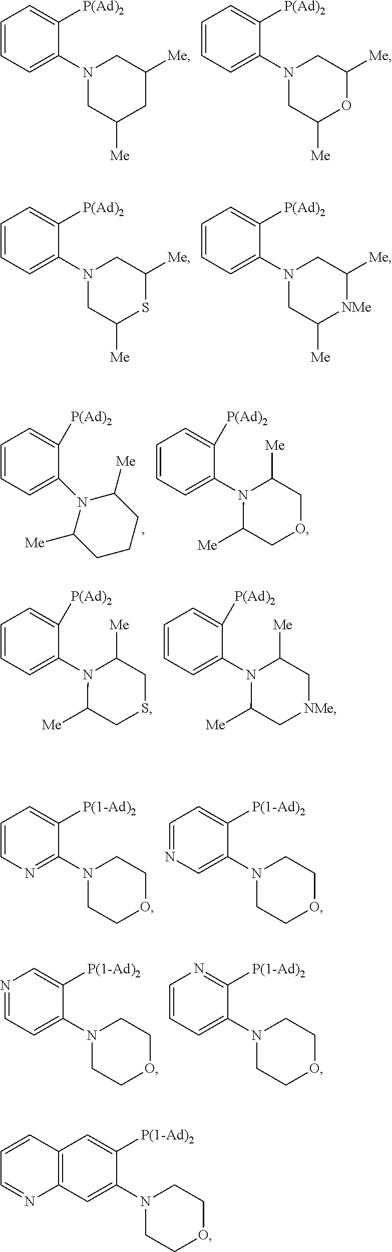

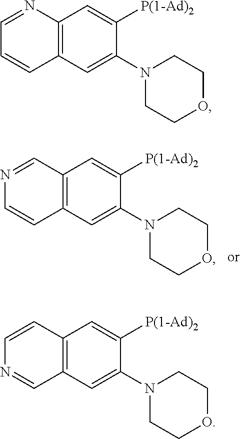

### III. METHODS OF PREPARING COMPOUNDS AND LIGANDS

Another aspect of the present invention provides a method for preparing a compound of Formula I:

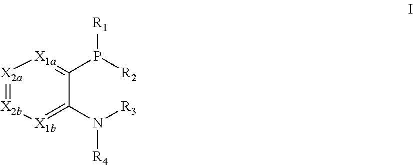

wherein each of R¹ and R² is independently selected from tert-butyl, cyclohexyl, 2-tolyl, or 1-adamantyl; each of R³ and R⁴ is independently selected from a C₁₋₅ alkyl, or R³, R⁴, and the nitrogen atom to which they are attached form an optionally substituted 4-10 membered heterocyclic ring; each of X₁ₐ and X_{1b}, is independently selected from N or C—R⁵; each of X₂ₐ and X_{2b}, is independently selected from N or C—R⁶; each R⁵ is independently selected from —H, —CH₃, —OCH₃, halogen, or —CF₃; each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring; or two R⁶ groups together with the carbon atoms to which they are attached form an optionally substituted 5-7 membered heterocyclic or carbocyclic ring; and no more than one of X₁ₐ, X_{1b}, X₂ₐ, or X_{2b} is N;

comprising the step of:

reacting a compound of Formula 2:

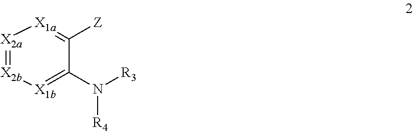

wherein Z is —Cl, —Br, or —I, with a compound of Formula 3:

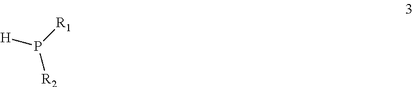

in the presence of

a) a metal catalyst,

b) a complexing agent,

c) a base, and

d) a solvent.

In some methods, the metal catalyst comprises palladium. For example, the metal catalyst comprises Pd(OAc)₂ or PdCl₂. In some instances, the metal catalyst comprises Pd(OAc)₂.

In some methods, the complexing agent comprises 1,1′-bis(isopropylphosphino)ferrocene or 1,1′-bis(diphenylphosphino)ferrocene. For example, the complexing agent comprises 1,1′-bis(isopropylphosphino)ferrocene.

In some methods, the base comprises a hydroxide of a Group 1 metal, a carbonate of a Group 1 metal, an alkoxide of a Group 1 metal, or any combination thereof. For example, the base comprises a hydroxide of a Group 1 metal or an alkoxide of a Group 1 metal. In some instances, the base comprises a hydroxide of a Group 1 metal (e.g., LiOH, NaOH, KOH, or any combination thereof). In other instances, the base comprises an alkoxide of a Group 1 metal (e.g., sodium alkoxide or lithium alkoxide). For example, the base comprises a sodium C₁₋₄ alkoxide (e.g., sodium tertbutoxide, sodium methoxide, sodium ethoxide, sodium propoxide, or any combination thereof) or a lithium C₁₋₄ alkoxide (e.g., lithium tertbutoxide, lithium methoxide, lithium ethoxide, lithium propoxide, or any combination thereof).

In some methods, the solvent comprises a nonpolar solvent. For example, the solvent comprises solvent comprises toluene, 1,4-dioxane, benzene, cyclohexane, hexane, tetrahydrofuran, diglyme, triglyme, or any combination thereof. In other examples, the solvent comprises toluene.

In some methods, both of R¹ and R² are tert-butyl, cyclohexyl, 2-tolyl, or 1-adamantyl. For example, both of R¹ and R² are 1-adamantyl.

In other methods, both of R³ and R⁴ are methyl, ethyl or propyl.

In some methods, R³, R⁴, and the nitrogen atom to which they are attached form

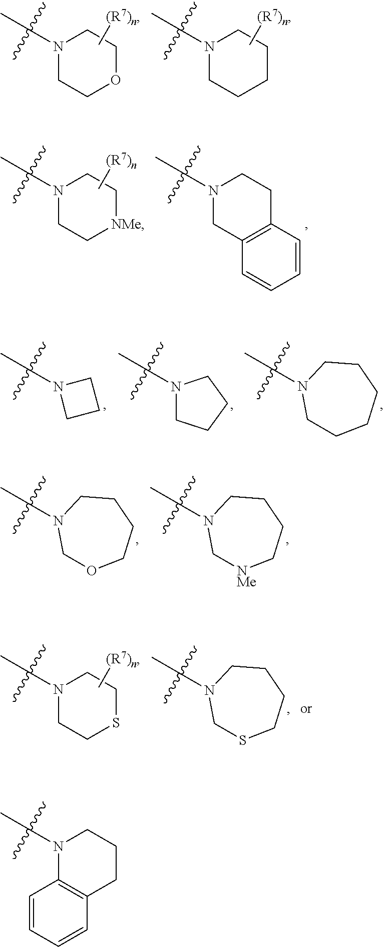

wherein n is 0-2, and R⁷ is —CH₃.

In some methods, R³, R⁴, and the nitrogen atom to which they are attached form

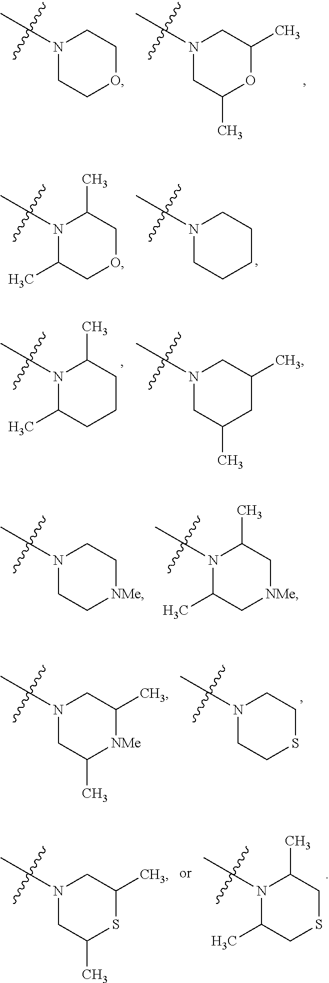

Synthetic Schemes for Compounds and Ligands

Compounds and ligands of the present invention may also be synthesized according to the synthetic scheme, below.

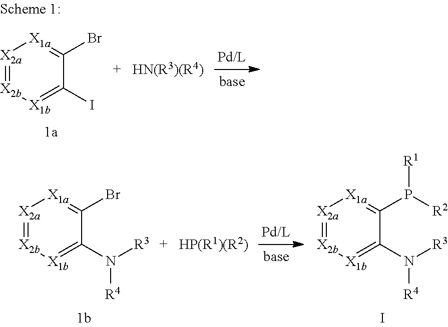

In Scheme 1, compound 1a and the amine, HN(R³)(R⁴), undergo cross-coupling (e.g., Buchwald-Hartwig cross-coupling) to generate intermediate 1b. And, intermediate 1b and the phosphine, HP(R¹)(R²), undergo cross-coupling to generate a compound of Formula I. See Chem. Eur. J. 2010 16, 1983 and Angew. Chem. Int. Ed. 2010 49, 4071.

### IV. REACTIONS

The compounds and ligands of the present invention are useful in the catalysis of several reactions.

A. C—N Cross Coupling Reactions

One aspect of the present invention provides a method for preparing a compound of Formula IV:

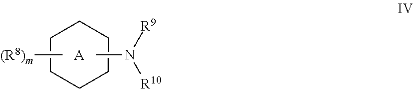

wherein

Ring A is a phenyl or a six membered heteroaryl having 1 to 2 nitrogen atoms located at any chemically feasible position on Ring A;

Each of R⁸ is -Z^{A}R¹¹, wherein each Z^{A} is independently a bond or an optionally substituted branched or straight C₁₋₈ aliphatic chain wherein up to two carbon units of Z^{A} are optionally and independently replaced by —CO—, —CS—, —CONR^{A}—, —CONR^{A}NR^{A}—, —CO₂—, —Si(R^{A1})₂—, —OCO—, —NR^{A}CO₂—, —O—, —NR^{A}CONR^{A}—, —OCONR^{A}—, —S—, —S(O)—, —S(O)₂—, —NR^{A}—, —S(O)₂NR^{A}—, —NR^{A}S(O)₂—, or —NR^{A}S(O)₂NR^{A}—;

Each R¹¹ is independently R^{A}, —OH, —NH₂, —NO₂, —CN, —CF₃, or —OCH₃;

Each R^{A} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl;

Each R^{A1} is independently an optionally substituted C₁₋₆ alkyl group; or

two vicinal R⁸ groups taken together with the atoms to which they are attached form an optionally substituted 5-7 membered saturated or partially unsaturated ring having up to 1 nitrogen atom;

Each of R⁹ and R¹⁰ is -Z^{B}R¹², wherein each Z^{B} is independently a bond or an optionally substituted branched or straight C₁₋₈ aliphatic chain wherein up to two carbon units of Z^{B} are optionally and independently replaced by —CO—, —CS—, —CONR^{B}—, —CONR^{B}NR^{B}—, —CO₂—, —OCO—, —NR^{B}CO₂—, —O—, —NR^{B}CONR^{B}—, —OCONR^{B}—, —S—, —S(O)—, —S(O)₂—, —NR^{B}—, —S(O)₂NR^{B}—, —NR^{B}S(O)₂—, or —NR^{B}S(O)₂NR^{B}—;

Each R¹² is independently R^{B}, —OH, —NH₂, —NO₂, —CN, —CF₃, or —OCH₃; and

Each R^{B} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl; or

R⁹ and R¹⁰ taken together with the nitrogen atom to which they are attached form an optionally substituted 5-8 membered heterocycloaliphatic having up to 1 additional heteroatom independently selected from N, O, or S; and

m is 0-3;

comprising the step of:

reacting a compound of Formula 5:

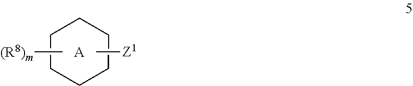

wherein Z¹ is —Cl, —Br, —I, or —OTs; with a compound of Formula 6:

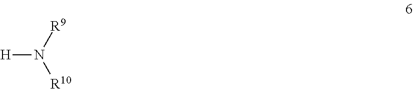

in the presence of:
a) a base;
b) a solvent; and
c) a catalyst comprising a palladium complex and a ligand of Formula I:

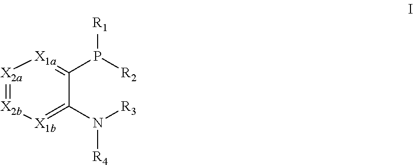

wherein

Each of R¹ and R² is independently selected from tert-butyl, cyclohexyl, 2-tolyl, or 1-adamantyl;

Each of R³ and R⁴ is independently selected from a C₁₋₅ alkyl, or
R³, R⁴, and the nitrogen atom to which they are attached form an optionally substituted 4-10 membered heterocyclic ring;

Each of X₁ₐ and X_{1b}, is independently selected from N or C—R⁵;

Each of X₂ₐ and X_{2b}, is independently selected from N or C—R⁶;

Each R⁵ is independently selected from —H, —CH₃, —OCH₃, halogen, or —CF₃;

Each R⁶ is independently selected from —H, —CH₃, —OCH₃, —N(CH₃)₂, halogen, or —CF₃; or
A vicinal R⁵ group and R⁶ group together with the carbon atoms to which they are attached form an optionally substituted 5-7 membered heterocyclic or carbocyclic ring; or
two R⁶ groups together with the carbon atoms to which they are attached form an optionally substituted 5-7 membered heterocyclic or carbocyclic ring; and

No more than one of X₁ₐ, X_{1b}, X₂ₐ, or X_{2b} is N.

In some methods, both of R¹ and R² are tert-butyl, cyclohexyl, 2-tolyl, or 1-adamantyl. For example, both of R¹ and R² are tert-butyl or 1-adamantyl. In some instances, both of R¹ and R² are 1-adamantyl.

In some methods, R³ and R⁴ are methyl, ethyl or propyl.

In some methods, R³, R⁴, and the nitrogen atom to which they are attached form an optionally substituted 4-10 membered heterocyclic ring. For example, R³, R⁴, and the nitrogen atom to which they are attached form

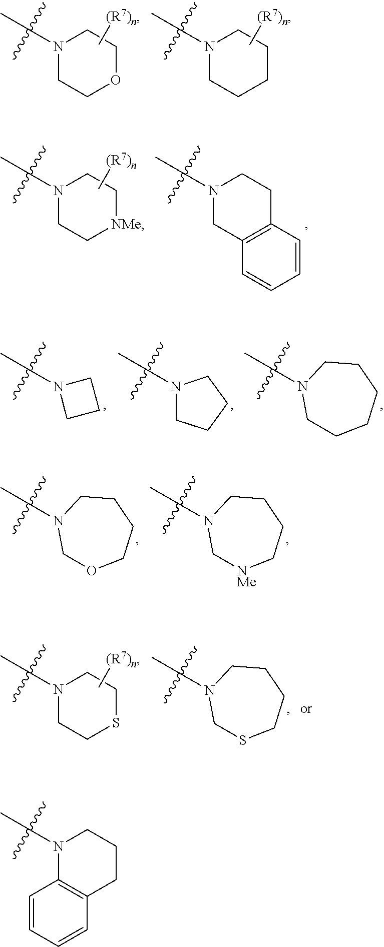

wherein n is 0-2, and R⁷ is —CH₃. And, in some instances, R³, R⁴, and the nitrogen atom to which they are attached form

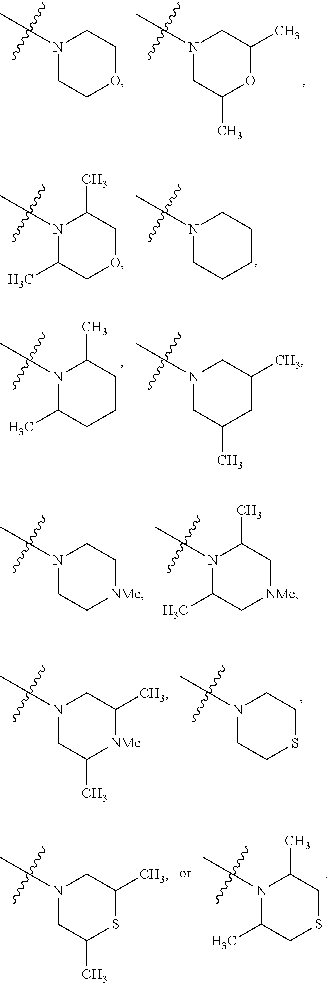

In some methods, each of X₁ₐ and X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring.

In some methods, each of X₁ₐ, X_{1b}, X₂ₐ, and X_{2b} is C—H.

And, in other methods, the ligand of Formula I is selected from

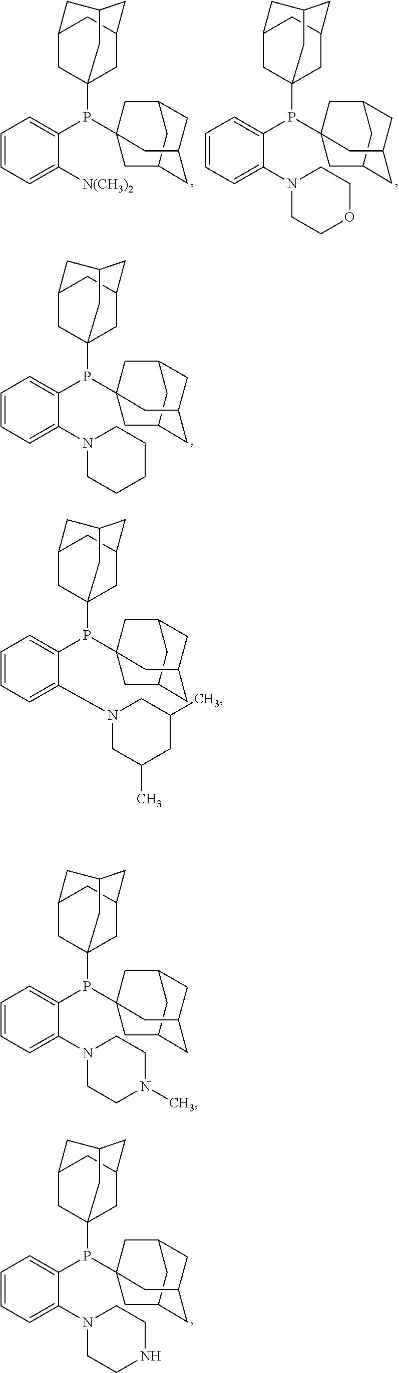

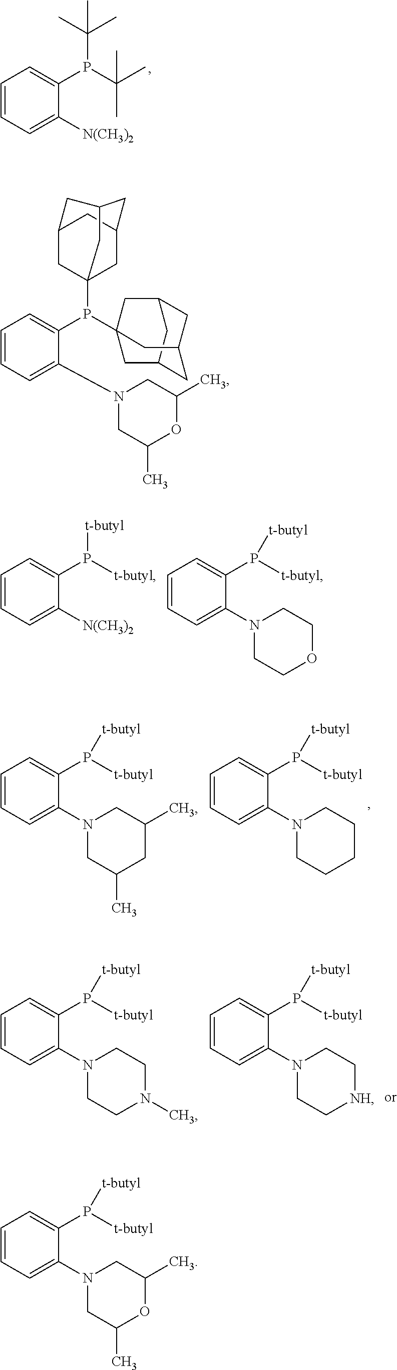

In some methods, the palladium complex is [Pd/(cinnamyl)Cl]₂, PdCl₂(MeCN)₂, Pd(dba)₂, Pd(OAc)₂, PdCl₂, [PdCl₂/(cod)], [Pd(allyl)Cl]₂, or any combination thereof. For example, the palladium complex is [Pd/(cinnamyl)Cl]₂.

In some methods, the base comprises a hydroxide of a Group 1 metal, a carbonate of a Group 1 metal, an alkoxide of a Group 1 metal, or any combination thereof. For example, the base comprises a hydroxide of a Group 1 metal or an alkoxide of a Group 1 metal. In some instances, the base comprises an alkoxide of a Group 1 metal. In other instances, the base comprises a sodium alkoxide or a lithium alkoxide. For example, the base comprises a sodium alkoxide (e.g., sodium tert-butoxide, sodium methoxide, sodium ethoxide, sodium propoxide, or any combination thereof).

In some methods, the base comprises sodium tert-butoxide, Cs₂CO₃, or LiHMDS.

In some methods, the solvent comprises a toluene, 1,4-dioxane, benzene, cyclohexane, hexane, THF, or any combination thereof.

In some methods, the compound of Formula 6 is a compound of Formula 6a:

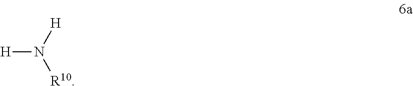

In some methods, R¹⁰ is -Z^{B}R¹², wherein Z^{B} is —NH—, and R¹² is hydrogen, an optionally substituted C₁₋₆ aliphatic, an optionally substituted aryl, or an optionally substituted heteroaryl.

In other methods, the compound of Formula 6 is selected from

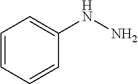

### or H₂NNH₂.

In alternative methods, the compound of Formula 5 is a compound of Formula 5a:

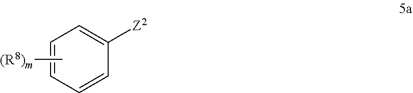

wherein Z² is —Cl or —OTs.

In some methods, the compound of Formula 5a is selected from

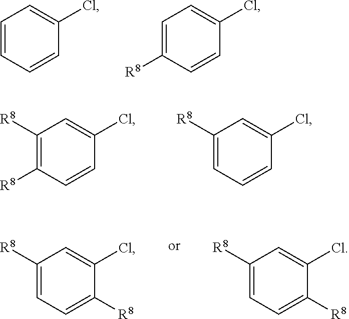

In other methods, the compound of Formula 5a is selected from

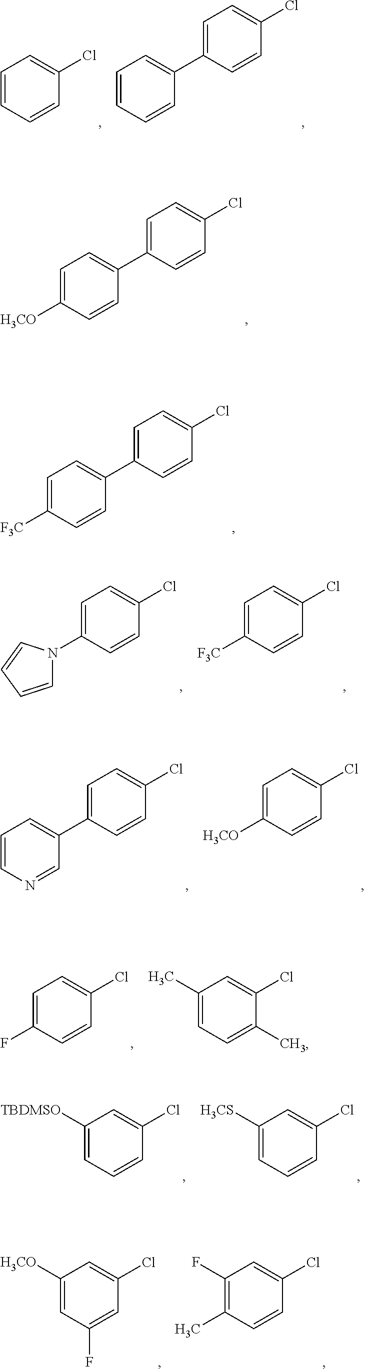

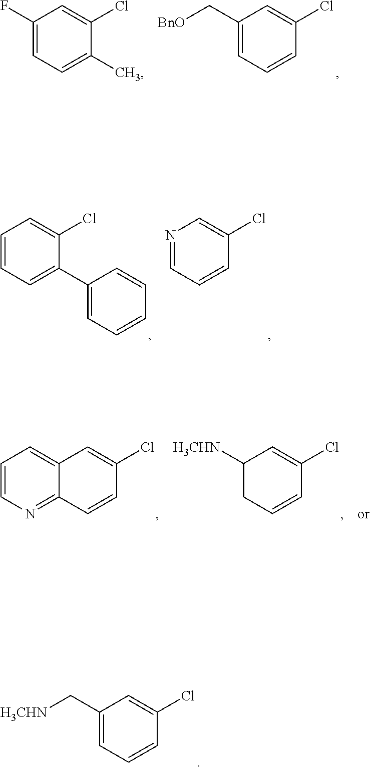

In some methods, R¹⁰ is -Z^{B}R¹², Z^{B} is a bond or an optionally substituted branched or straight C₁₋₈ aliphatic chain wherein up to two carbon units of Z^{B} are optionally and independently replaced by —CO—, —CS—, —CONR^{B}—, —CONR^{B}NR^{B}—, —CO₂—, —OCO—, —NR^{B}CO₂—, —O—, —NR^{B}CONR^{B}—, —OCONR^{B}—, —S—, —S(O)—, —S(O)₂—, —NR^{B}—, —S(O)₂NR^{B}—, —NR^{B}S(O)₂—, or —NR^{B}S(O)₂NR^{B}—; each R¹² is independently R^{B}, —OH, —NO₂, —CN, —CF₃, or —OCH₃; and each R^{B} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl. For example, R¹⁰ is -Z^{B}R¹², Z^{B} is a bond and R¹² is hydrogen.

In some methods, the compound of Formula 5 is a compound of Formula 5a:

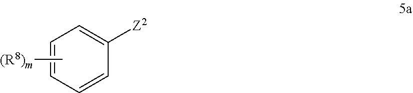

wherein Z² is —Cl or —OTs.

In other methods, the compound of Formula 5 is selected from

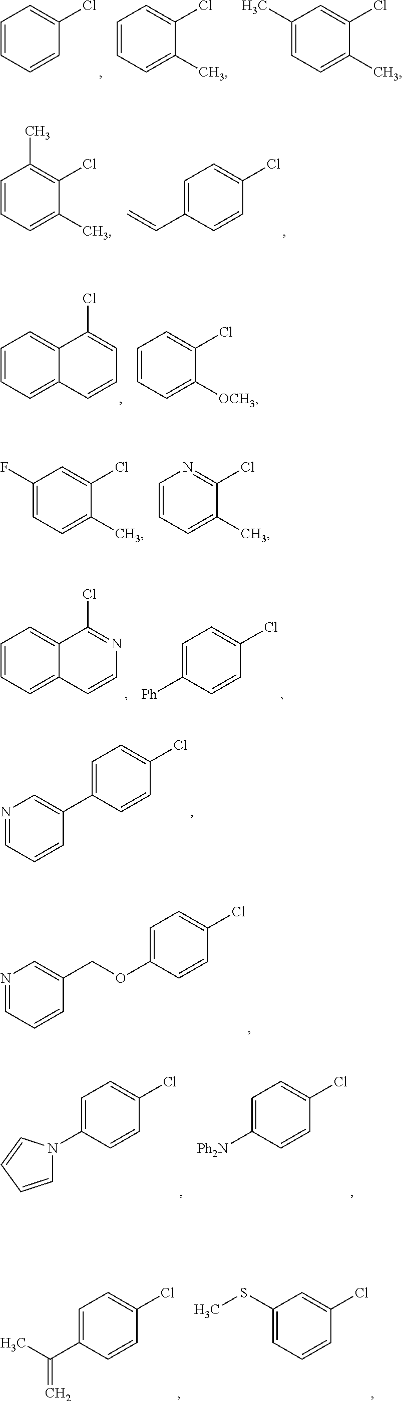

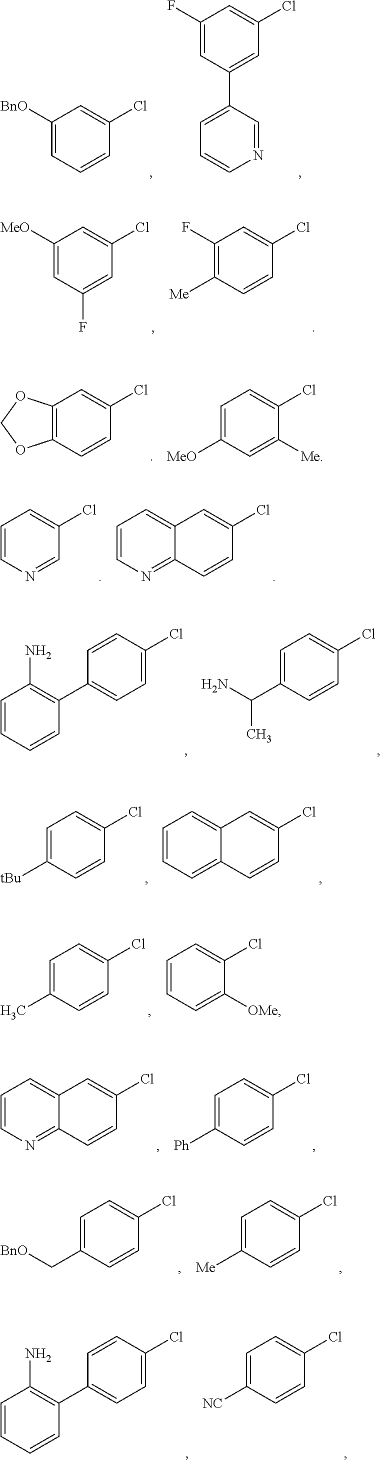

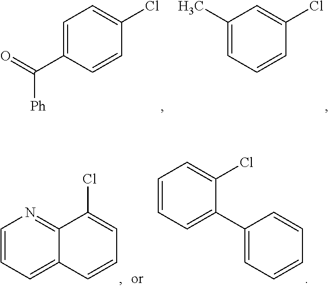

In other methods, R¹⁰ is -ZBR¹², Z^{B} is independently a bond or an optionally substituted branched or straight C₁₋₈ aliphatic chain wherein up to two carbon units of Z^{B} are optionally and independently replaced by —CO—, —CS—, —CONR^{B}—, —CONR^{B}NR^{B}—, —CO₂—, —OCO—, —NR^{B}CO₂—, —O—, —NR^{B}CONR^{B}—, —OCONR^{B}—, —S—, —S(O)—, —S(O)₂—, —NR^{B}—, —S(O)₂NR^{B}—, —NR^{B}S(O)₂—, or —NR^{B}S(O)₂NR^{B}—; R¹² is independently R^{BI}, —OH, —NO₂, —CN, —CF₃, or —OCH₃; and each R^{B} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl; and R^{B1} is independently an optionally substituted C₁₋₆ aliphatic group, an optionally substituted cycloaliphatic, an optionally substituted heterocycloaliphatic, an optionally substituted aryl, or an optionally substituted heteroaryl. For example, R¹⁰ is -Z^{B}R¹², Z^{B} is a bond, —CH₂—, —(CH₂)₂—, or —O—, and R¹² is a branched or straight C₁₋₆ aliphatic, cycloaliphatic, heterocycloaliphatic, aryl, or heteroaryl, each of which is optionally substituted with 1-3 groups independently selected from methyl, methoxy, t-butyl, t-butoxy, fluoro, phenyl, cyclopentyl, cyclohexyl, cycloheptyl, piperidinyl, or piperazinyl.

In other methods, the compound of Formula 6a is selected from

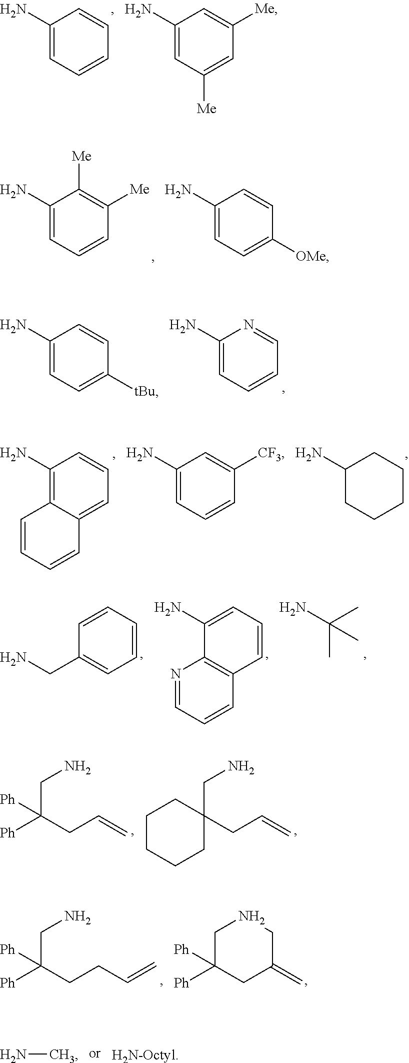

In other methods, the compound of Formula 5 is a compound of Formula 5a:

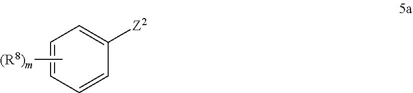

wherein Z² is —Cl or —OTs.

And, in some methods, the compound of Formula 5 is a compound of Formula 5b:

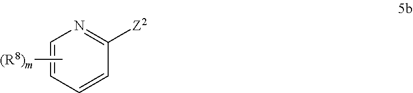

wherein Z² is —Cl or —OTs.

In other methods, m is 1, and R⁸ is selected from —CH₃, —OCH₃, —CF₃, phenyl, pyridinyl, cyclohexyl, or t-butyl.

In some methods, the compound of Formula 5 is selected from

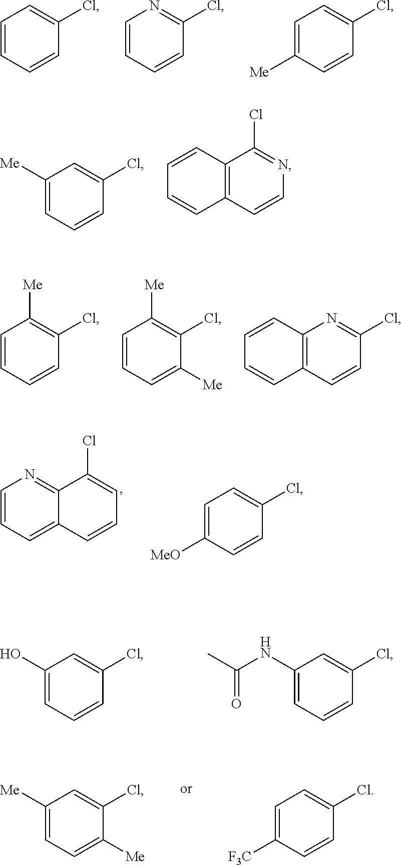

In some methods, each of R⁹ and R¹⁰ is -Z^{B}R¹², wherein each Z^{B} is independently a bond or an optionally substituted branched or straight C₁₋₈ aliphatic chain wherein up to two carbon units of Z^{B} are optionally and independently replaced by —CO—, —CS—, —CONR^{B}—, —CONR^{B}NR^{B}—, —CO₂—, —OCO—, —NR^{B}CO₂—, —O—, —NR^{B}CONR^{B}—, —OCONR^{B}—, —S—, —S(O)—, —S(O)₂—, —NR^{B}—, —S(O)₂NR^{B}—, —NR^{B}S(O)₂—, or —NR^{B}S(O)₂NR^{B}—; each R¹² is independently R^{B1}, —OH, —NO₂, —CN, —CF₃, or —OCH₃; and each R^{B} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl; and each R^{B1} is independently an optionally substituted C₁₋₆ aliphatic group, an optionally substituted cycloaliphatic, an optionally substituted heterocycloaliphatic, an optionally substituted aryl, or an optionally substituted heteroaryl; or R⁹ and R¹⁰ together with the nitrogen atom to which they are attached form an optionally substituted five to 8 membered heterocycloaliphatic having up to 1 additional heteroatom independently selected from N, O, or S.

In some methods, each of R⁹ and R¹⁰ is independently selected from methyl, ethyl, propyl, isopropyl, butyl, t-butyl, cyclopentyl, cyclohexyl, cycloheptyl, phenyl, or pyridinyl.

In other methods, R⁹ and R¹⁰ together with the nitrogen atom to which they are attached form an optionally substituted 5-8 membered heterocycloaliphatic having up to 1 additional heteroatom independently selected from N, O, or S.

In some methods, the compound of Formula 6 is selected from

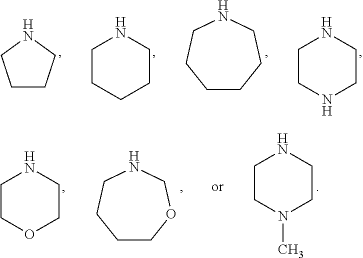

In some methods, the palladium complex is present at a concentration of from about 0.1 to 10.0 mol % based on the compound of Formula 5.

In some methods, the ligand of Formula I is present at a concentration of from about 0.2 to about 20 mol % based on the compound of Formula 5.

And, in some methods, the base is present in the amount of from about 1 to about 3 equivalents.

Another aspect of the present invention provides a method for preparing a compound of Formula VII:

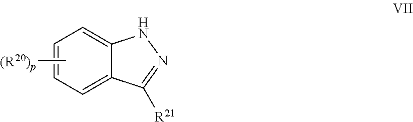

wherein

Each of R²⁰ is -Z^{C}R³⁰, wherein each Z^{c} is independently a bond or an optionally substituted branched or straight C₁₋₈ aliphatic chain wherein up to two carbon units of Z^{C} are optionally and independently replaced by —CO—, —CS—, —CONR^{C}—, —CONR^{C}NR^{C}—, —CO₂—, —OCO—, —NR^{C}CO₂—, —O—, —NR^{C}CONR^{C}—, —OCONR^{C}—, —S—, —S(O)—, —S(O)₂—, —NR^{C}—, —S(O)₂NR^{C}—, —NR^{C}S(O)₂—, or —NR^{A}S(O)₂NR^{C}—;
Each R³⁰ is independently R^{D}, —OH, —NH₂, —NO₂, —CN, —CF₃, or —OCH₃; and
Each R^{D} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl; or
two vicinal R²⁰ groups together with the carbon atoms to which they are attached form an optionally substituted 5-7 membered fully saturated or partially unsaturated ring having 0-2 heteroatoms independently selected from N, O, and S;

R²¹ is —H, methyl, ethyl, propyl, t-butyl, cyclopentyl, cyclohexyl, cycloheptyl, or phenyl; and

p is 0-3;

comprising the step of:

reacting a compound of Formula 8:

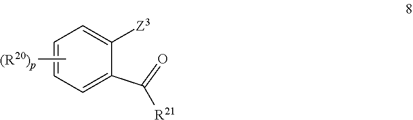

wherein Z³ is —Cl, —Br, I, or —OTs, and H₂NNH₂ in the presence of

a) a base;

b) a palladium complex;

c) a solvent; and

d) a ligand of Formula I

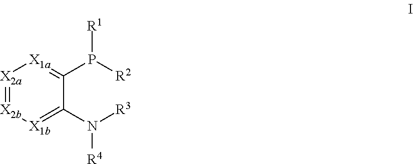

wherein

Each of R¹ and R² is independently selected from tert-butyl, cyclohexyl, 2-tolyl, or 1-adamantyl;

Each of R³ and R⁴ is independently selected from a C₁₋₅ alkyl, or
R³, R⁴, and the nitrogen atom to which they are attached form an optionally substituted 4-10 membered heterocyclic ring;

Each of X₁ₐ and X_{1b}, is independently selected from N or C—R⁵;

Each of X₂ₐ and X_{2b}, is independently selected from N or C—R⁶;

Each R⁵ is independently selected from —H, —CH₃, —OCH₃, halogen, or —CF₃;

Each R⁶ is independently selected from —H, —CH₃, —OCH₃, —N(CH₃)₂, halogen, or —CF₃; or
a vicinal R⁵ group and R⁶ group together with the carbon atoms to which they are attached form an optionally substituted 5-7 membered heterocyclic or carbocyclic ring; or
two R⁶ groups together with the carbon atoms to which they are attached form an optionally substituted 5-7 membered heterocyclic or carbocyclic ring; and

wherein no more than one of X₁ₐ, X_{1b}, X₂ₐ, or X_{2b} is N.

In some methods, Z³ is —Cl.

In some methods, both of R¹ and R² are tert-butyl, cyclohexyl, 2-tolyl, or 1-adamantyl. For example, both of R¹ and R² are tert-butyl or 1-adamantyl. And, in some instances, both of R¹ and R² are 1-adamantyl.

In some methods, both of R³ and R⁴ are methyl, ethyl or propyl.

In some methods, R³, R⁴, and the nitrogen atom to which they are attached form an optionally substituted 4-10 membered heterocyclic ring. For example, R³, R⁴, and the nitrogen atom to which they are attached form

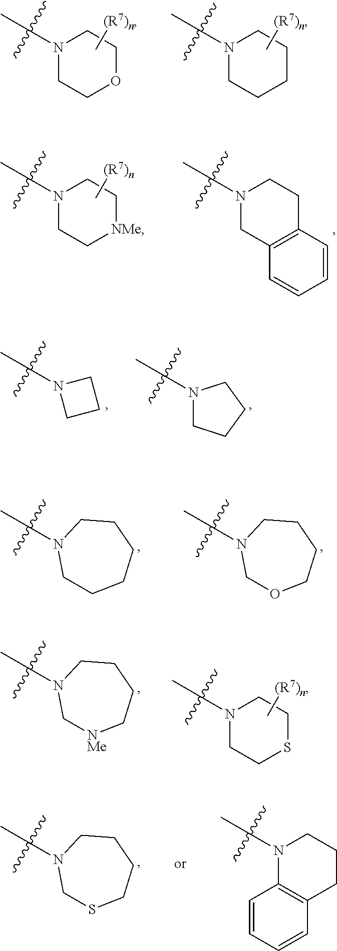

wherein n is 0-2, and R⁷ is —CH₃. In other instances, R³, R⁴, and the nitrogen atom to which they are attached form

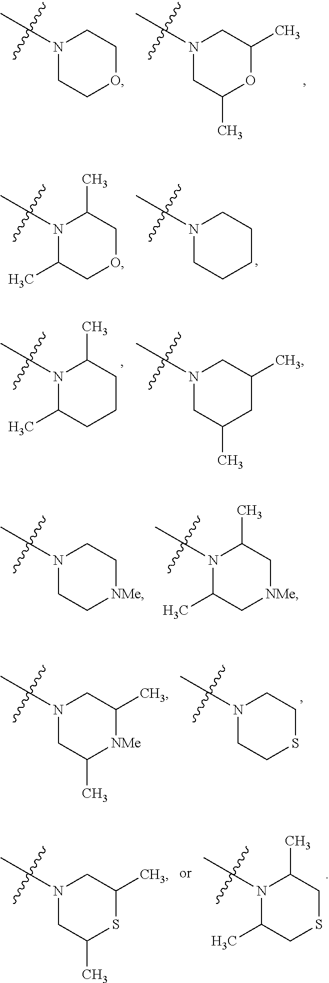

In some methods, each of X₁ₐ and X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring.

In some methods, each of X₁ₐ, X_{1b}, X₂ₐ, and X_{2b} is C—H.

In some methods, R²¹ is selected from hydrogen or methyl.

In some methods, each R²⁰ is hydrogen.

B. Alpha Arylations

One aspect of the present invention provides a method for preparing a compound of Formula IX:

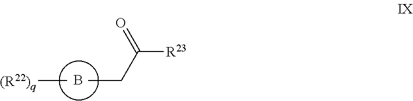

wherein

Ring B is a phenyl or a 5-6 membered heteroaryl having 1-2 heteroatoms independently selected from N, O, or S located at any chemically feasible position on Ring B;

Each R²² is -Z^{D}R³¹, wherein each Z^{D} is independently a bond or an optionally substituted branched or straight C₁₋₈ aliphatic chain wherein up to two carbon units of Z^{D} are optionally and independently replaced by —CO—, —CS—, —CONR^{D}—, —CONR^{D}NR^{D}—, —CO₂—, —OCO—, —NR^{D}CO₂—, —O—, —N(R^{D})—, —NR^{D}CONR^{D}—, —OCONR^{D}—, —S—, —S(O)—, —S(O)₂—, —S(O)₂NR^{D}—, —NR^{D}S(O)₂—, or —NR^{D}S(O)₂NR^{C}—;
Each R³¹ is independently R^{D}, —OH, —NH₂, —NO₂, —CN, —CF₃, or —OCH₃; and
Each R^{D} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl; or
two vicinal R²² groups together with the carbon atoms to which they are attached form an optionally substituted 5-7 membered fully saturated or partially unsaturated ring having 0-2 heteroatoms independently selected from N, O, and S;

R²³ is —H, methyl, ethyl, propyl, t-butyl, cyclopentyl, cyclohexyl, cycloheptyl, or phenyl; and

q is 0-3;

comprising the step of:

reacting a compound of Formula 10:

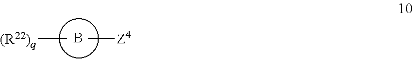

wherein Z⁴ is —Cl, —Br, —I, or —OTs; with a compound of Formula 11:

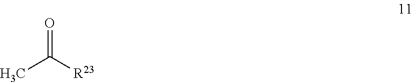

in the presence of:

a) a base;

b) a solvent; and

c) a catalyst comprising a palladium complex and a ligand of Formula I:

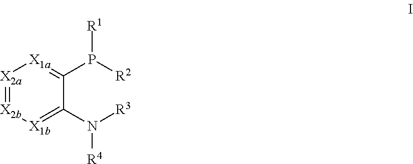

wherein

Each of R¹ and R² is independently selected from tert-butyl, cyclohexyl, 2-tolyl, or 1-adamantyl;

Each of R³ and R⁴ is independently selected from a C₁₋₅ alkyl, or
R³, R⁴, and the nitrogen atom to which they are attached form an optionally substituted 4-10 membered heterocyclic ring;

Each of X₁ₐ and X_{1b}, is independently selected from N or C—R⁵;

Each of X₂ₐ and X_{2b}, is independently selected from N or C—R⁶;

Each R⁵ is independently selected from —H, —CH₃, —OCH₃, halogen, or —CF₃;

Each R⁶ is independently selected from —H, —CH₃, —OCH₃, —N(CH₃)₂, halogen, or —CF₃; or
a vicinal R⁵ group and R⁶ group together with the carbon atoms to which they are attached form an optionally substituted 5-7 membered heterocyclic or carbocyclic ring; or
two R⁶ groups together with the carbon atoms to which they are attached form an optionally substituted 5-7 membered heterocyclic or carbocyclic ring; and
No more than one of X₁ₐ, X_{1b}, X₂ₐ, or X_{2b} is N.

In some methods, both of R¹ and R² are tert-butyl, cyclohexyl, 2-tolyl, or 1-adamantyl. For example, both of R¹ and R² are tert-butyl or 1-adamantyl. And, in some instances, both of R¹ and R² are 1-adamantyl.

In other methods, both of R³ and R⁴ are methyl, ethyl or propyl.

In other methods, R³, R⁴, and the nitrogen atom to which they are attached form an optionally substituted 4-10 membered heterocyclic ring. For example, R³, R⁴, and the nitrogen atom to which they are attached form

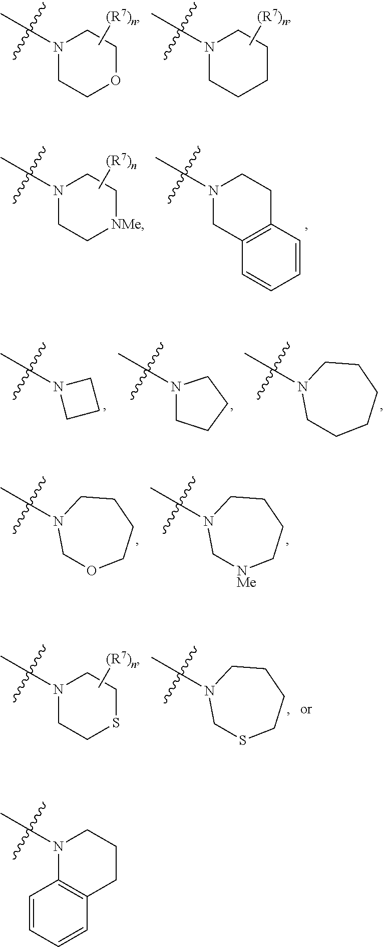

wherein n is 0-2, and R⁷ is —CH₃.

In some methods, R³, R⁴, and the nitrogen atom to which they are attached form

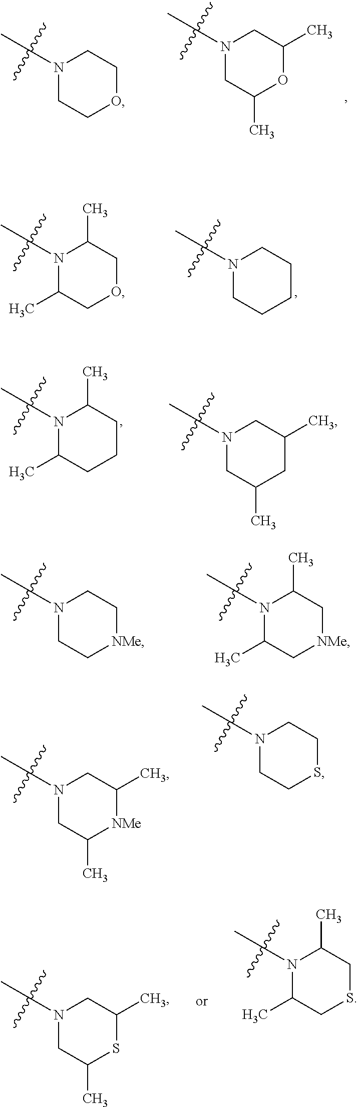

In some methods, each of X₁ₐ and X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring. For example, each of X₁ₐ, X_{1b}, X₂ₐ, and X_{2b} is C—H.

In some methods, the ligand of Formula I is selected from

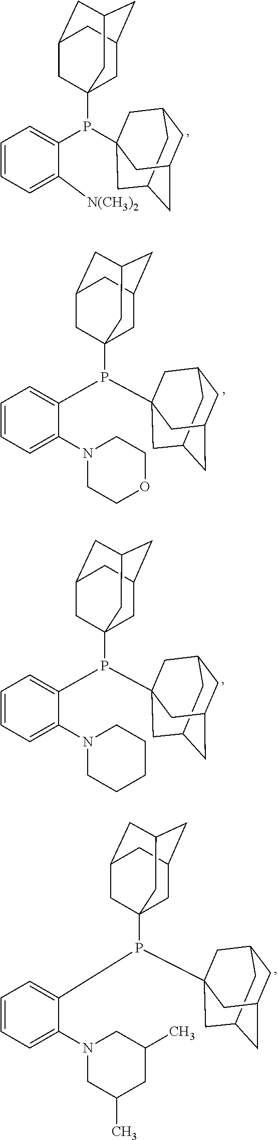

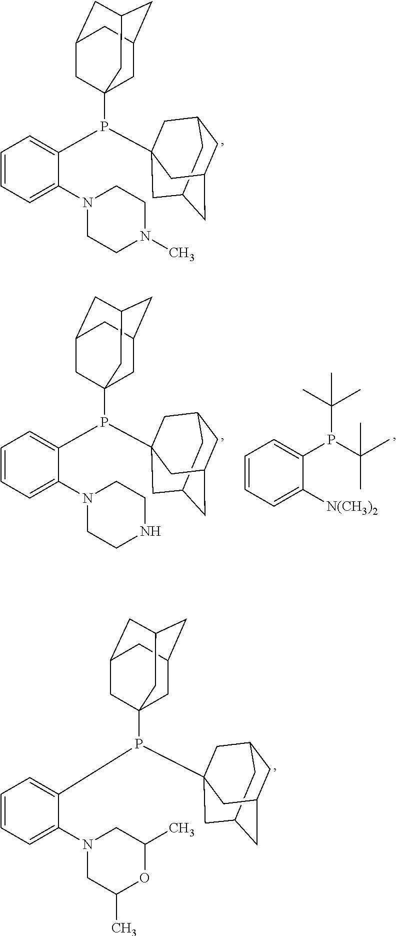

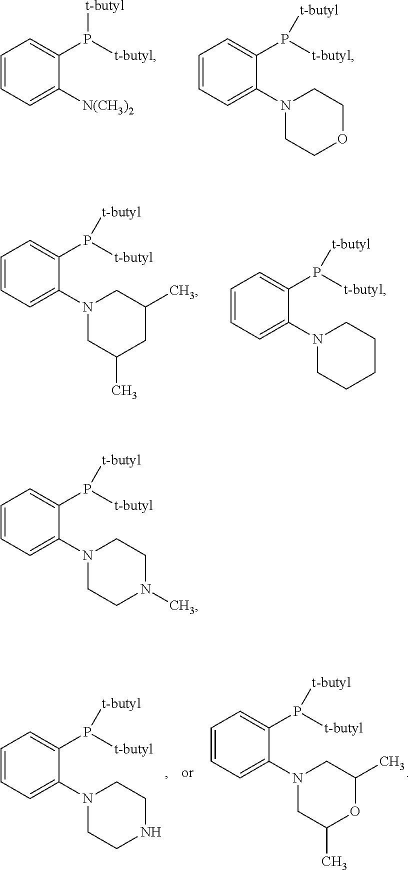

In some methods, the palladium complex is [Pd(allyl)Cl]₂ or [Pd(cinnamyl)Cl]₂. For example, the palladium complex is [Pd(allyl)Cl]₂. In other instances, the palladium is [Pd(cinnamyl)Cl]₂.

In some methods, the palladium complex is present at a concentration of from about 0.1 to about 10.0 mol % based on the compound of Formula 10.

In some methods, the ligand of Formula I is present at a concentration of from about 0.2 to about 20 mol % based on the compound of Formula 10.

In some methods, the base comprises Cs₂CO₃.

In some methods, the base is present in the amount of from about 1 to about 3 equivalents.

In some methods, the solvent comprises 1,4-dioxane or toluene.

In some methods, the compound of Formula 10 is selected from

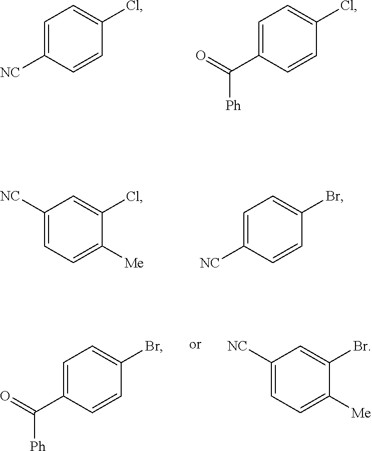 [SMILES: N#Cc1ccc(Cl)cc1 ; O=C(c1ccccc1)c1ccc(Cl)cc1 ; Cc1ccc(C#N)cc1Cl ; N#Cc1ccc(Br)cc1 ; O=C(c1ccccc1)c1ccc(Br)cc1 ; Cc1ccc(C#N)cc1Br]

In other methods, the compound of Formula 10 is selected from

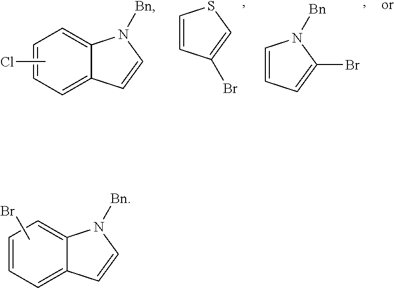

Another aspect of the present invention provides a method for preparing a compound of Formula IXa:

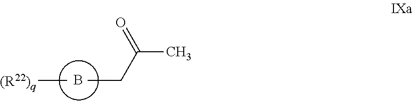

wherein

Ring B is a phenyl or a 5-6 membered heteroaryl having 1-2 heteroatoms independently selected from N, O, or S located at any chemically feasible position on Ring B;

Each of R²² is -Z^{D}R³¹, wherein each Z^{D} is independently a bond or an optionally substituted branched or straight C₁₋₈ aliphatic chain wherein up to two carbon units of Z^{D} are optionally and independently replaced by —CO—, —CS—, —CONR^{D}—, —CONR^{D}NR^{D}—, —CO₂—, —OCO—, —NR^{D}CO₂—, —O—, —N(R^{D})—, —NR^{D}CONR^{D}—, —OCONR^{D}—, —S—, —S(O)—, —S(O)₂—, —S(O)₂NR^{D}—, —NR^{D}S(O)₂—, or —NR^{D}S(O)₂NR^{C}—;
Each R³¹ is independently R^{D}, —OH, —NH₂, —NO₂, —CN, —CF₃, or —OCH₃; and
Each R^{D} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl; or
two vicinal R²² groups together with the carbon atoms to which they are attached form an optionally substituted 5-7 membered fully saturated or partially unsaturated ring having 0-2 heteroatoms independently selected from N, O, and S;

R²³ is —H, methyl, ethyl, propyl, t-butyl, cyclopentyl, cyclohexyl, cycloheptyl, or phenyl; and

q is 0-3;

comprising the step of:

reacting a compound of Formula 10:

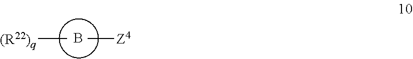

wherein Z⁴ is —Cl, —Br, —I, or —OTs; with acetone

in the presence of:

a) a base;

b) a solvent; and

c) a catalyst comprising a palladium complex and a ligand of Formula I:

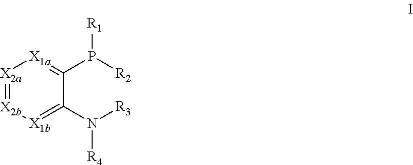

wherein

Each of R¹ and R² is independently selected from tert-butyl, cyclohexyl, 2-tolyl, or 1-adamantyl;

Each of R³ and R⁴ is independently selected from a C₁₋₅ alkyl, or
R³, R⁴, and the nitrogen atom to which they are attached form an optionally substituted 4-10 membered heterocyclic ring;

Each of X₁ₐ and X_{1b}, is independently selected from N or C—R⁵;

Each of X₂ₐ and X_{2b}, is independently selected from N or C—R⁶;

Each R⁵ is independently selected from —H, —CH₃, —OCH₃, halogen, or —CF₃;

Each R⁶ is independently selected from —H, —CH₃, —OCH₃, —N(CH₃)₂, halogen, or —CF₃; or
a vicinal R⁵ group and R⁶ group together with the carbon atoms to which they are attached form an optionally substituted 5-7 membered heterocyclic or carbocyclic ring; or
two R⁶ groups together with the carbon atoms to which they are attached form an optionally substituted 5-7 membered heterocyclic or carbocyclic ring; and
No more than one of X₁ₐ, X_{1b}, X₂ₐ, or X_{2b} is N.

In some methods, both of R¹ and R² are tert-butyl, cyclohexyl, 2-tolyl, or 1-adamantyl. For example, both of R¹ and R² are tert-butyl or 1-adamantyl. And, in some instances, both of R¹ and R² are 1-adamantyl.

In other methods, both of R³ and R⁴ are methyl, ethyl or propyl.

In other methods, R³, R⁴, and the nitrogen atom to which they are attached form an optionally substituted 4-10 membered heterocyclic ring. For example, R³, R⁴, and the nitrogen atom to which they are attached form

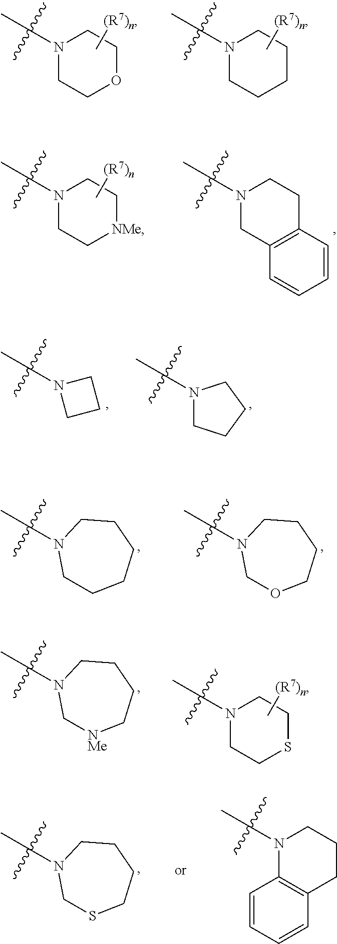

wherein n is 0-2, and R⁷ is —CH₃.

In some methods, R³, R⁴, and the nitrogen atom to which they are attached form

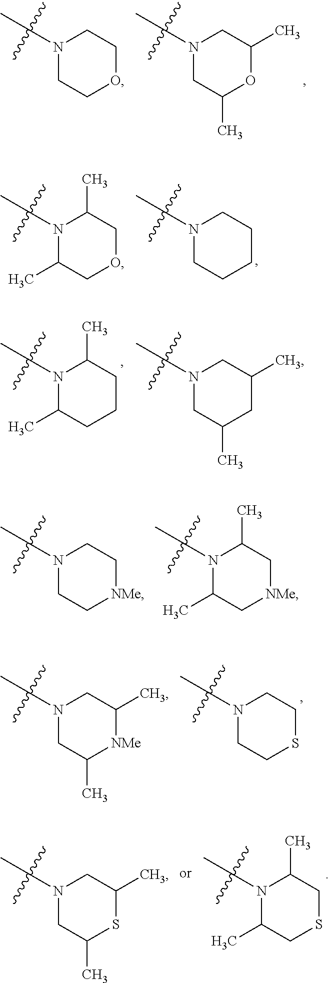

In some methods, each of X₁ₐ and X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring. For example, each of X₁ₐ, X_{1b}, X₂ₐ, and X_{2b} 15 C—H.

In some methods, the ligand of Formula I is selected from

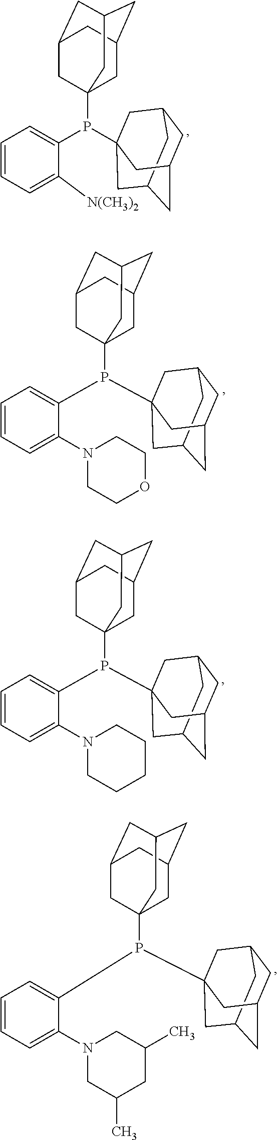

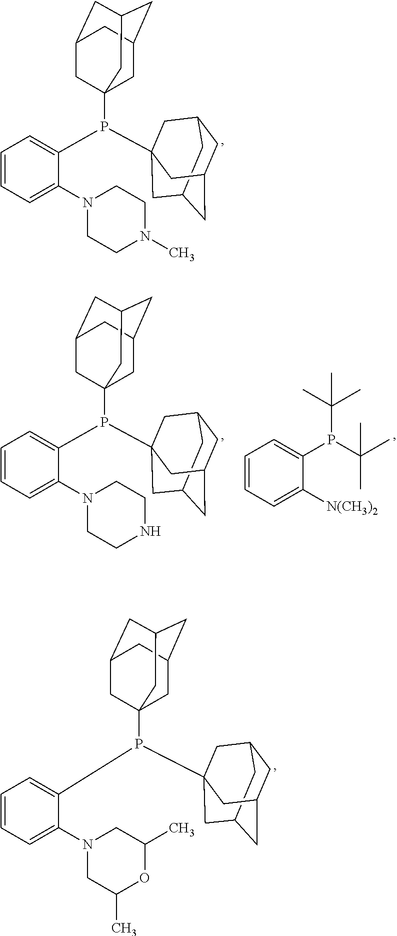

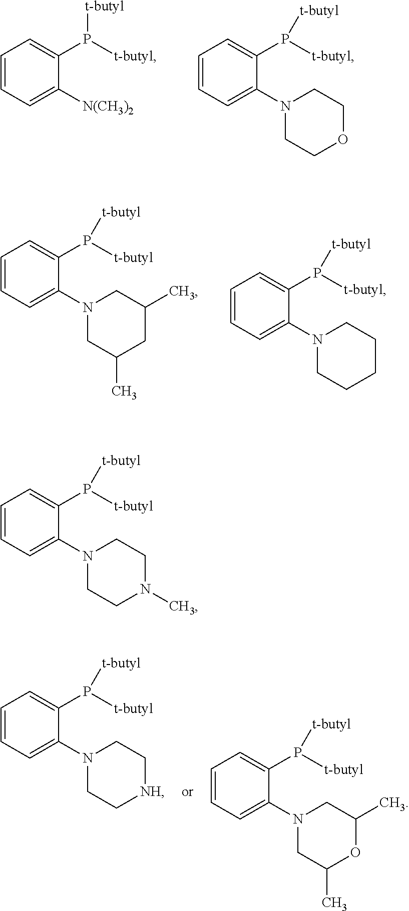

In some methods, the palladium complex is [Pd(allyl)Cl]₂ or [Pd(cinnamyl)Cl]₂. For example, the palladium complex is [Pd(allyl)Cl]₂. In other instances, the palladium is [Pd(cinnamyl)Cl]₂.

In some methods, the palladium complex is present at a concentration of from about 0.1 to about 10.0 mol % based on the compound of Formula 10.

In some methods, the ligand of Formula I is present at a concentration of from about 0.2 to about 20 mol % based on the compound of Formula 10.

In some methods, the base comprises Cs₂CO₃.

In some methods, the base is present in the amount of from about 1 to about 3 equivalents.

In some methods, the solvent comprises 1,4-dioxane or toluene.

In some methods, the compound of Formula 10 is selected from

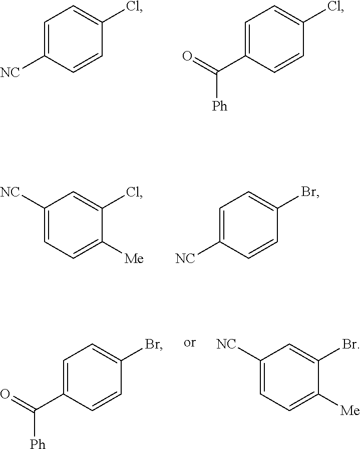 [SMILES: N#Cc1ccc(Cl)cc1 ; O=C(c1ccccc1)c1ccc(Cl)cc1 ; Cc1ccc(C#N)cc1Cl ; N#Cc1ccc(Br)cc1 ; O=C(c1ccccc1)c1ccc(Br)cc1 ; Cc1ccc(C#N)cc1Br]

In other methods, the compound of Formula 10 is selected from

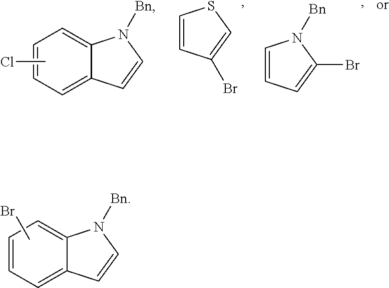

C. Hydroamination of Internal Alkynes

One aspect of the present invention provides a method for preparing a compound of Formula XII:

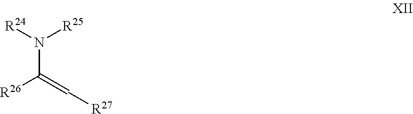

wherein

R²⁴ and R²⁵ are independently selected from a C₁₋₈ alkyl or C₅₋₈ cycloalkyl, either of which is optionally substituted with phenyl; or R²⁴, R²⁵ and the nitrogen atom to which they are attached form an optionally substituted 5-8 membered heterocycloaliphatic having up to 1 additional ring heteroatom selected from N, O, or S; and
R²⁶ and R²⁷ are independently -Z^{E}R³², wherein each Z^{E} is independently a bond or an optionally substituted branched or straight C₁₋₆ aliphatic chain wherein up to two carbon units of Z^{E} are optionally and independently replaced by —CO—, —CS—, —CONR^{E}—, —CONR^{E}NR^{E}—, —CO₂—, —OCO—, —NR^{E}CO₂—, —O—, —N(R^{E})—, —NR^{E}CONR^{E}—, —OCONR^{E}—, —S—, —S(O)—, —S(O)₂—, —S(O)₂NR^{E}—, —NR^{E}S(O)₂—, or —NR^{E}S(O)₂NR^{E}—;
Each R³² is independently R^{E}, —OH, —NH₂, —NO₂, —CN, —CF₃, or —OCH₃; and
Each R^{E} is independently hydrogen, an optionally substituted C₁₋₆ aliphatic group, an optionally substituted cycloaliphatic, an optionally substituted heterocycloaliphatic, an optionally substituted aryl, or an optionally substituted heteroaryl;

comprising the step of:

reacting a compound of Formula 13:

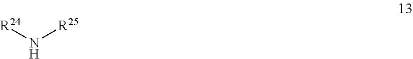

with a compound of Formula 14:

R²⁶—≡—R²⁷ 14

in the presence of

a) a base;

b) a solvent; and

c) a catalyst comprising a gold complex and a ligand of Formula I

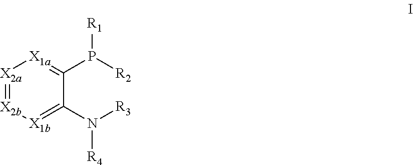

wherein

Each of R¹ and R² is independently selected from tert-butyl, cyclohexyl, 2-tolyl, or 1-adamantyl;

Each of R³ and R⁴ is independently selected from a C₁₋₅ alkyl, or
R³, R⁴, and the nitrogen atom to which they are attached form an optionally substituted 4-10 membered heterocyclic ring;

Each of X₁ₐ and X_{1b}, is independently selected from N or C—R⁵;

Each of X₂ₐ and X_{2b}, is independently selected from N or C—R⁶;

Each R⁵ is independently selected from —H, —CH₃, —OCH₃, halogen, or —CF₃;

Each R⁶ is independently selected from —H, —CH₃, —OCH₃, —N(CH₃)₂, halogen, or —CF₃; or
a vicinal R⁵ group and R⁶ group together with the carbon atoms to which they are attached form an optionally substituted 5-7 membered heterocyclic or carbocyclic ring; or
two R⁶ groups together with the carbon atoms to which they are attached form an optionally substituted 5-7 membered heterocyclic or carbocyclic ring; and

No more than one of X₁ₐ, X_{1b}, X₂ₐ, or X_{2b} is N.

In some methods, both of R¹ and R² are tert-butyl, cyclohexyl, 2-tolyl, or 1-adamantyl. For example, both of R¹ and R² are tert-butyl or 1-adamantyl. In some instances, both of R¹ and R² are 1-adamantyl.

In some methods, both of R³ and R⁴ are methyl, ethyl or propyl.

In some methods, R³, R⁴, and the nitrogen atom to which they are attached form an optionally substituted 4-10 membered heterocyclic ring. For example, R³, R⁴, and the nitrogen atom to which they are attached form

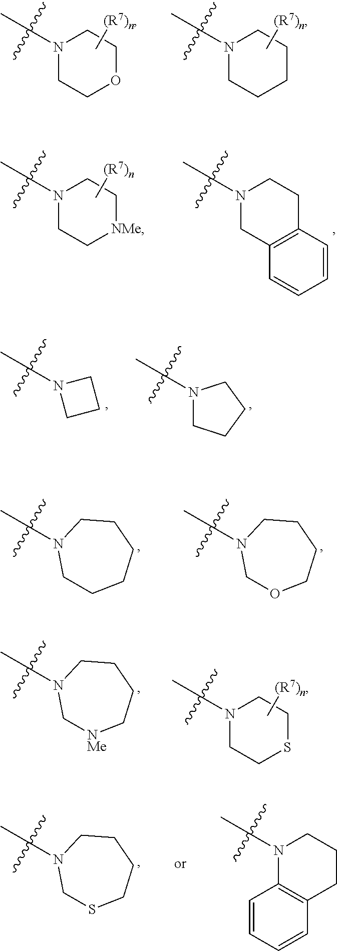

wherein n is 0-2, and R⁷ is —CH₃.

In other methods, R³, R⁴, and the nitrogen atom to which they are attached form

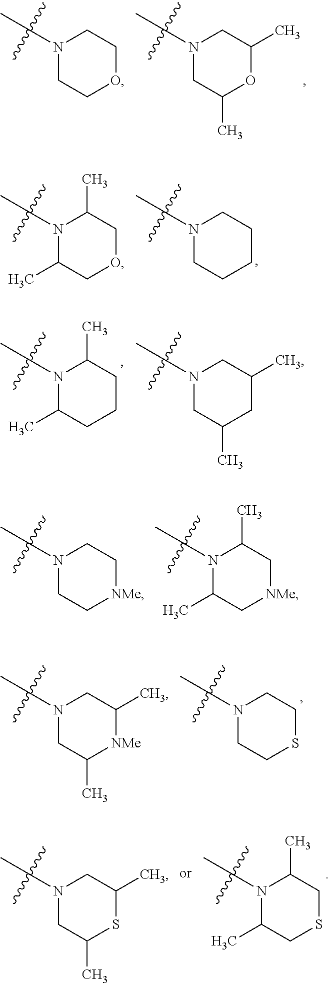

In some methods, each of X₁ₐ and X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring. For example, each of X₁ₐ, X_{1b}, X₂ₐ, and X_{2b} is C—H.

In other methods, the ligand of Formula I is selected from

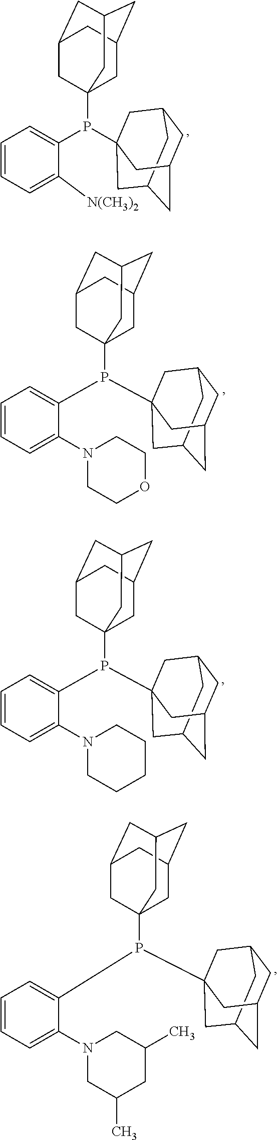

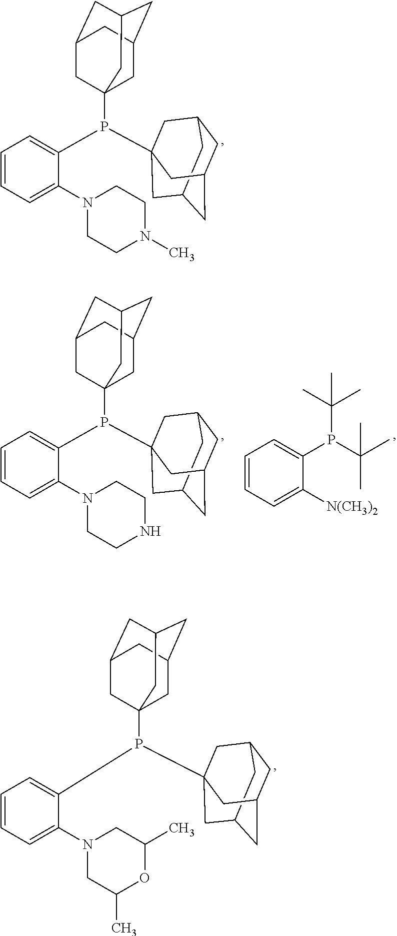

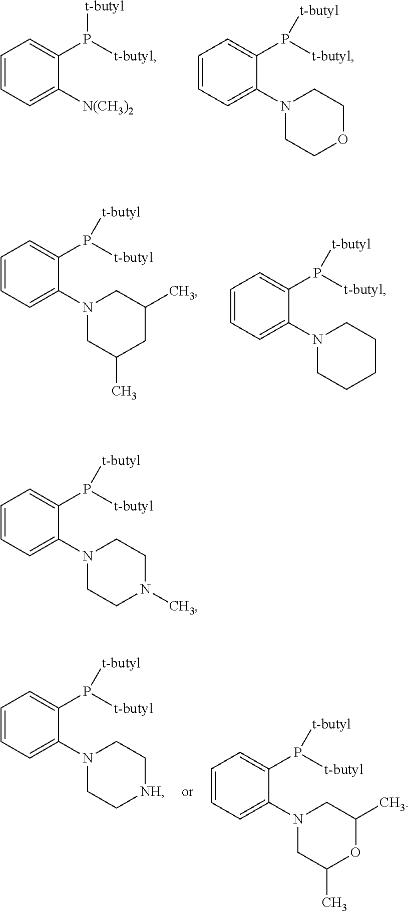

In some methods, the gold complex is Au(SMe₂)Cl.

In some methods, the gold complex is present at a concentration of from about 0.1 to about 10.0 mol % based on the compound of Formula 14.

In some methods, the ligand of Formula I is present at a concentration of from about 0.2 to about 20 mol % based on the compound of Formula 14.

In some methods, LiB(C₆H₅)₄.2.5OEt₂ is present at a concentration of from about 0.2 to about 20 mol % based on the compound of Formula 14.

In some methods, the solvent comprises 1,4-dioxane or toluene.

In some methods, R²⁴ and R²⁵ are independently selected from a C₁₋₈ alkyl or C₅₋₈ cycloalkyl, either of which is optionally substituted with phenyl. For example, R²⁴ and R²⁵ are independently selected from methyl, ethyl, propyl, isopropyl, butyl, tert-butyl, phenylmethyl, or cyclohexyl.

In other methods, R²⁴, R²⁵ and the nitrogen atom to which they are attached form an optionally substituted 5-8 membered heterocycloaliphatic having up to 1 additional ring heteroatom selected from N, O, or S.

In some methods, the compound of Formula 13 is selected from

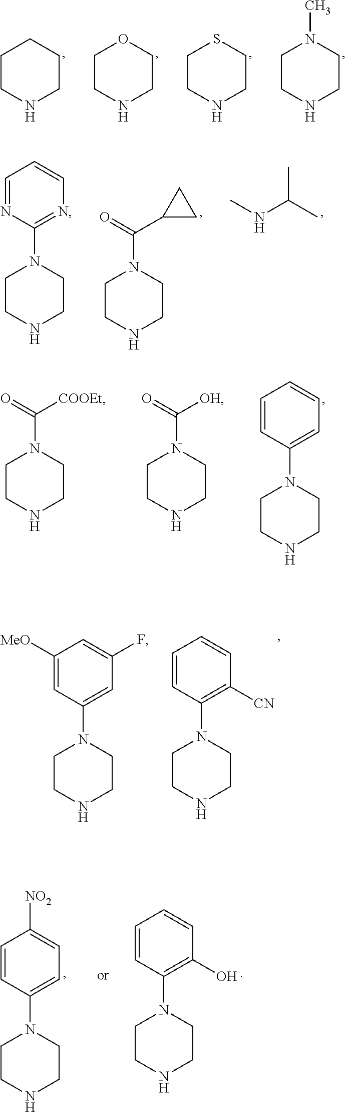

In other methods, the compound of Formula 14 is selected from

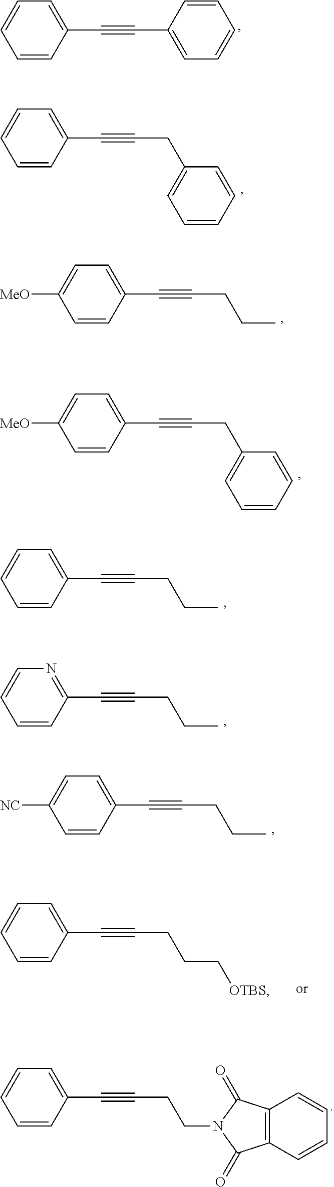

### V. EXAMPLES

The following examples are not intended to limit the scope of the claims.

### Example 1

### Hydroamination of Diphenylacetylene with Morpholine

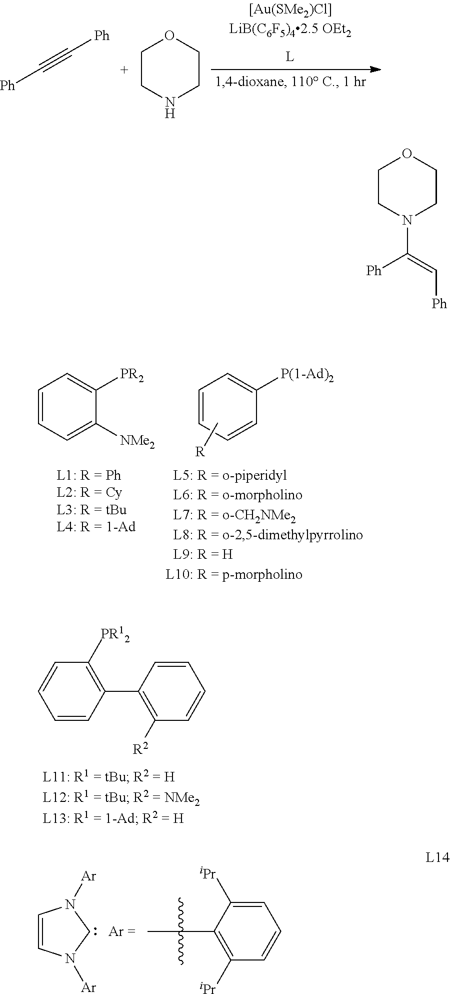

Hydroamination of diphenylacetylene with morpholine was performed employing 5 mol % [Au(SMe₂)Cl], 5 mol % LiB(C₆F₅)₄.2.5OEt₂, and 6 mol % of ligand L at 110° C. in 1,4-dioxane for 1 h.

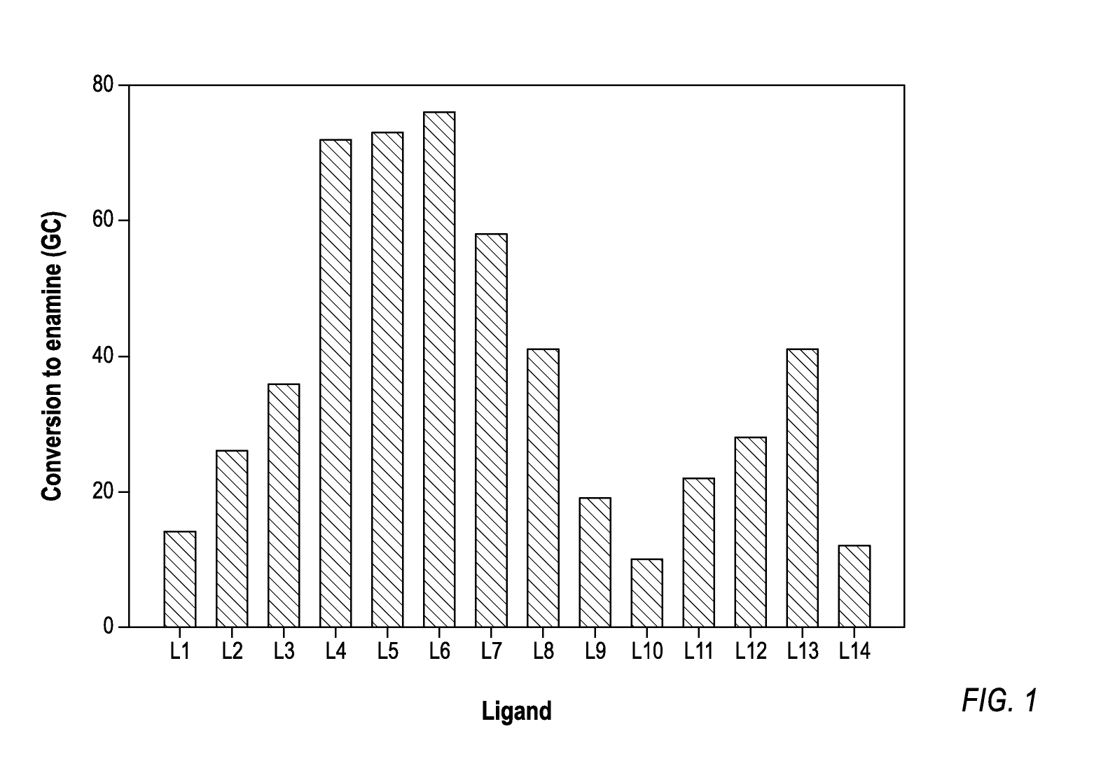

The conversions to enamine are provided in FIG. 1.

### Example 2

### Hydroamination of Diphenylacetylene with Primary and Secondary Alkylamines

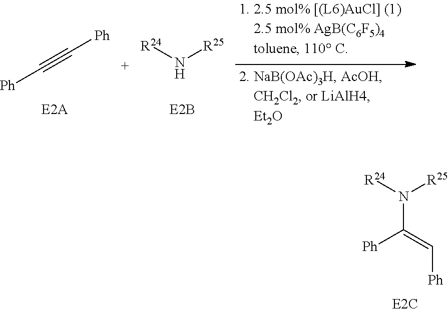

The enamine yield and a description of the primary and secondary alkyl amines are provided in Tables 1 and 2.

TABLE 1
Hydroamination yields.

| entry | amine | yield^{b} |
|---|---|---|
| 1 | E2Ca | 86 |
| 2^{c} | E2Cb | 80 |
| 3 | E2Cc | 92 |
| 4 | E2Cd | 90 |
| 5^{c} | E2Ce | 80 |
| 6 | E2Cf | 91 |
| 7^{d} | E2Cg | 90^{e} |
| 8 | E2Ch | 80 |
| 9 | E2Ci | 83 |
| 10 | E2Cj | 84^{e} |
| 11 | E2Ck | 72^{e} |
| 12 | E2Cl | 75 |
| 13 | E2Cm | 84 |
| 14^{c,f} | E2Cn | 90 |
| 15^{c,f} | E2Co | 85 |
| 16 | E2Cp | 91 |
| 17 | E2Cq | 86 |
| 18^{c,f} | E2Cr | 93 |
| 19 | E2Cs | 76 |
| 20^{c,g} | E2Ct | 80ⁱ |

Conditions. alkyne:amine:1:AgB(C₆F₅)₄=1:1.1:0.025:0.025 (0.8 mmol of alkyne) in 0.8 mL of toluene at 110° C. for 16 h. ^{b} Isolated yield of reduction product. ^{c} 5 mol % 1 and 5 mol % AgB(C₆F₅)₄ used. ^{d} In THF/1,4-dioxane (3:2) at 90° C. for 16 h. ^{e} GC yield of E-enamine relative to dodecane as an internal standard. ^{f} Reaction time=24 h. ^{g} In 1,4-dioxane ([alkyne]=0.5 mM). ^{h 1}H NMR yield relative to 1,3,5-trimethoxybenzene as an internal standard. ⁱ Isolated as the enamine hydrolysis product.⁹

TABLE 2
Description of amine used in hydroamination
Amines

| | | | |
|---|---|---|---|
| 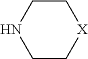 | E2Ca: X = O E2Cb: X = S E2Cc: X = NBoc | 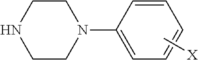 | E2Cm: X = m-F, or m-OMe E2Cn: X = o-CN E2Cp: X = p-NO₂, E2Cq: X = o-OH |
| 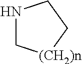 | E2Cd: n = 1 E2Ce: n = 2 E2Cf: n = 3 | E2Co: | 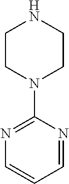 [SMILES: c1cnc(N2CCNCC2)nc1] |
| HNR²⁴R²⁵ | E2Cg: R²⁴ = R²⁵ = Me E2Ch: R²⁴ = R²⁵ = n-hexyl E2Ci: R²⁴ = Me; R²⁵ = i-Pr E2Cj: R²⁴ = H; R²⁵ = n-octyl E2Ck: R²⁴ = H; R²⁵ = cyclohexyl E2Cl: R²⁴ = H; R²⁵ = benzyl | E2Cr: | 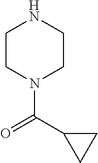 [SMILES: O=C(C1CC1)N1CCNCC1] |
| 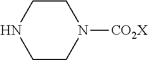 | E2Cs: X = Et E2Ct: X = H | | |

### Example 3

### Hydroamination of Asymmetrical Alkynes with Dialkylamines

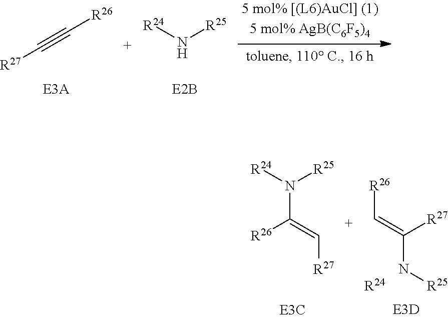

Enamine products generated by this reaction are provided in Table 3.

TABLE 3
Asymmetrical enamine products.
Description of Asymmetric Enamine Products

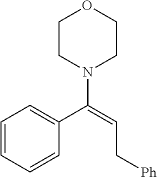 [SMILES: C(/Cc1ccccc1)=C(/c1ccccc1)N1CCOCC1]

E3Ca; 86% (4:1)^{b}

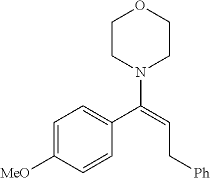 [SMILES: COc1ccc(/C(=C\Cc2ccccc2)N2CCOCC2)cc1]

E3Cb; 88% (>20:1)^{b}

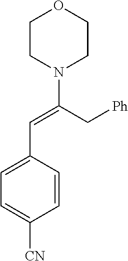 [SMILES: N#Cc1ccc(/C=C(\Cc2ccccc2)N2CCOCC2)cc1]

E3Dc; 76% (19:1)^{b}

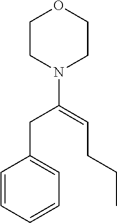 [SMILES: CCC/C=C(\Cc1ccccc1)N1CCOCC1]

E3Cd; 86% (3:1)^{c}

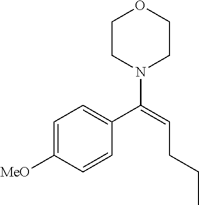 [SMILES: CCC/C=C(\c1ccc(OC)cc1)N1CCOCC1]

E3Ce; 75% (18:1)^{b}

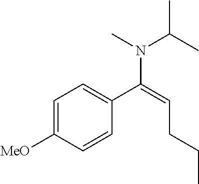 [SMILES: CCC/C=C(\c1ccc(OC)cc1)N(C)C(C)C]

E3Cf; 83% (4:1)^{c}

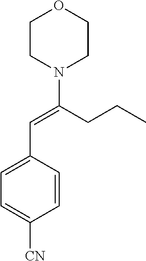 [SMILES: CCC/C(=C\c1ccc(C#N)cc1)N1CCOCC1]

E3Dg; 0%

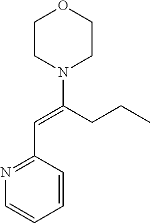 [SMILES: CCC/C(=C\c1ccccn1)N1CCOCC1]

E3Dh; 80% (>20:1)^{c}

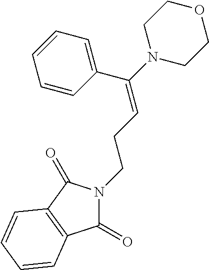 [SMILES: O=C1c2ccccc2C(=O)N1CC/C=C(\c1ccccc1)N1CCOCC1]

E3Ci; 73% (>20:1)^{b}

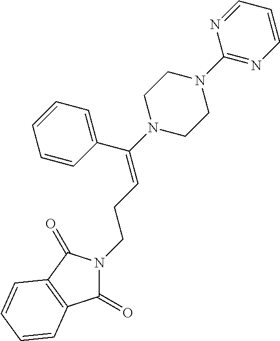 [SMILES: O=C1c2ccccc2C(=O)N1CC/C=C(\c1ccccc1)N1CCN(c2ncccn2)CC1]

E3Cj; 88% (>20:1)^{c}

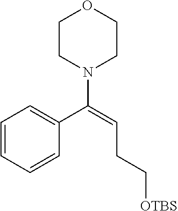 [SMILES: CC(C)(C)[Si](C)(C)OCC/C=C(\c1ccccc1)N1CCOCC1]

E3Ck; 79% (3:1)^{b}

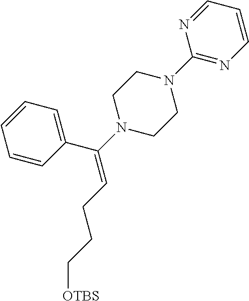 [SMILES: CC(C)(C)[Si](C)(C)OCCC/C=C(\c1ccccc1)N1CCN(c2ncccn2)CC1]

E3Cl; 76% (5:1)^{c}

Conditions. alkyne:amine:1:AgB(C₆F₅)₄=1:1.1:0.05:0.05 (0.8 mmol of alkyne) in 0.8 mL of toluene at 110° C. for 16 h; major regioisomer shown with ratio of regioisomers in parentheses. In all cases <5% of the Z-enamine product was observed (¹H NMR and nOe experiments). ^{b} Isolated yield of combined enamine reduction products; regiochemistry determined by ¹H NMR relative to 1,3,5-trimethoxybenzene prior to reduction. ^{c 1}H NMR yield of enamine relative to 1,3,5-trimethoxybenzene. TBS=tert-butyldimethylsilyl.

### Example 4

### Palladium-Catalyzed Cross-Coupling of Aryl Chlorides and Tosylates with Hydrazine

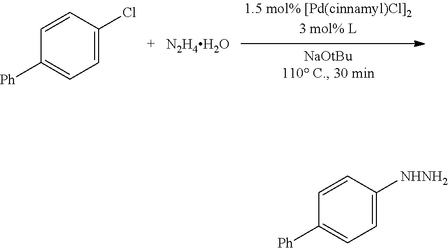

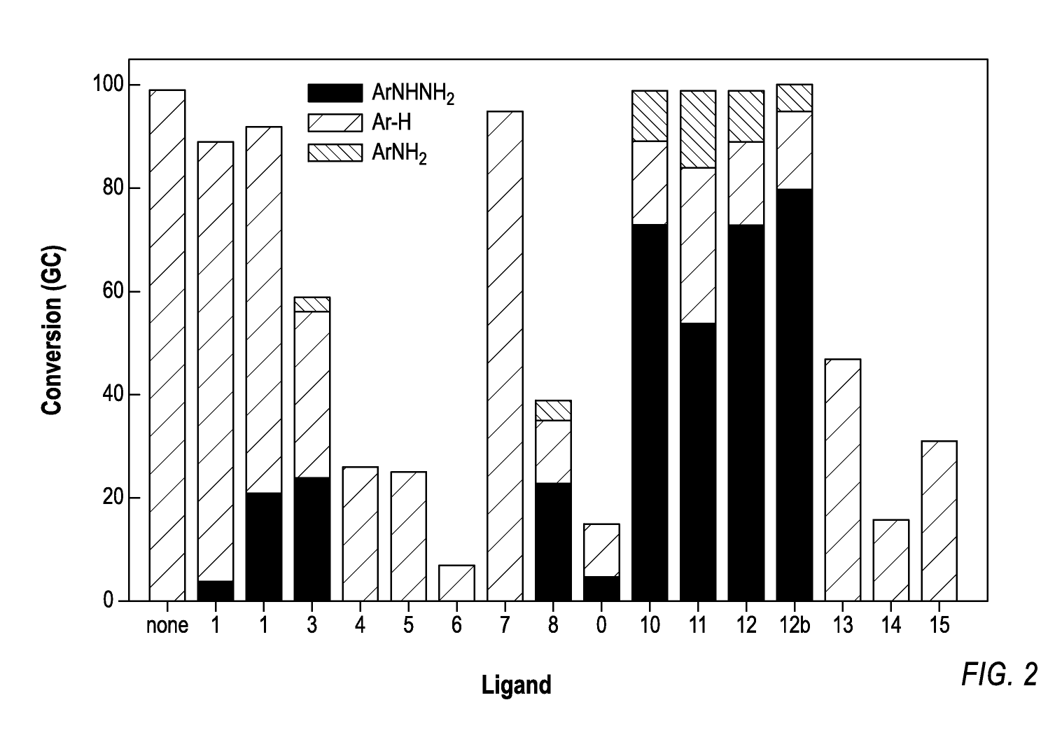

The following ligands were screened for cross-coupling activity using the reaction above. The results of the ligand screen are provided in FIG. 2.

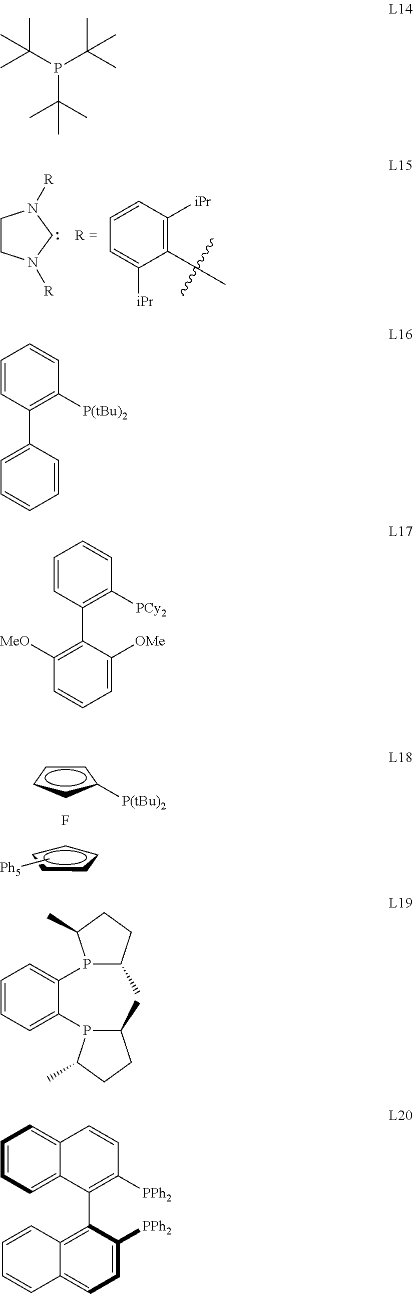

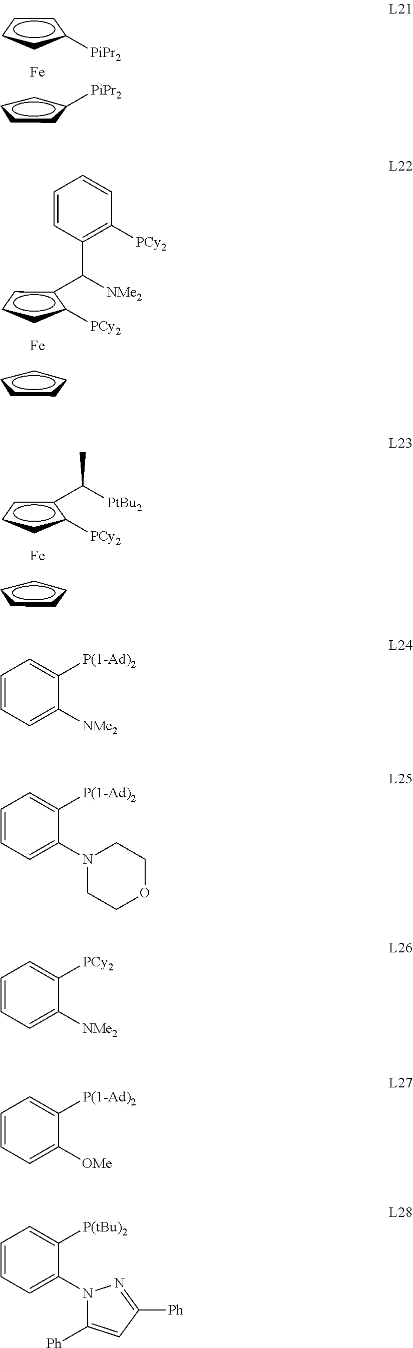

Ligand screen for the Pd-catalyzed cross-coupling of 4-phenylchlorobenzene and N₂H₄.H₂O. Conditions: 0.15 mmol scale, 110° C. 0.1M in 1,4-dioxane. Conversions determined by GC. 12b=6 mol % L25 employed.

### Example 5

### Palladium-Catalyzed Cross-Coupling of 4-Phenylhalobenzenes and Hydrazine

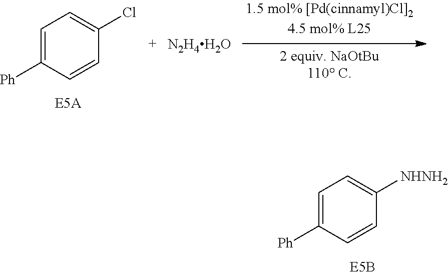

The following reaction conditions were evaluated

TABLE 4
Reaction conditions for cross-coupling reactions

| Entry | Variation from Standard Conditions | Conv. (%) | Yield |
|---|---|---|---|
| 1 | None | >99 | 73 |
| 2 | 9 mol % L25 | >99 | 61 |
| 3 | toluene instead of 1,4-dioxane | >99 | 79 |
| 4 | DMA instead of 1,4-dioxane | <10 | 0 |
| 5 | DCE instead of 1,4-dioxane | 0 | 0 |
| 6 | 0.3M ArCl instead of 0.1M | 65 | 25 |
| 7 | 4 equiv. hydrazine instead of 2 equiv. | 51 | 34 |
| 8 | 3 equiv. of NaOtBu instead of 2 equiv. | 90 | 66 |
| 9 | KOH instead of NaOtBu | 45 | 24 |
| 10 | Cs₂CO₃ instead of NaOtBu | 65 | 14 |
| 11 | ArBr instead of ArCl | 95 | 45 |
| 12^{[b]} | N₂H₄•HCl instead of N₂H₄•H₂O | >99 | 80 |
| 13^{[b]} | N₂H₄•HCl instead of N₂H₄•H₂O, 65° C. | 99 | 76 |
| 14^{[b,c]} | PdCl₂(MeCN)₂ instead of [Pd(cinnamyl)Cl]₂ | >99 | 69 |
| 15^{[b,c]} | Pd(dba)₂ instead of [Pd(cinnamyl)Cl]₂ | 99 | 60 |
| 16 | no Pd, no ligand | <10 | 0 |

[a] Standard conditions: 0.2 mmol scale, [Pd]:L=1:1.5, 2 equiv. N₂H₄.H₂O and NaOtBu, 110° C., in 1,4-dioxane (0.1 M). Conversions and yields determined by GC. [b] Employing N₂H₄.HCl and 3.5 equiv. NaOtBu. [c] At 90° C. dba=dibenzylideneacetone.

### Example 6

### Palladium-Catalyzed Cross-Coupling of Aryl Chlorides or Heteroaryl Chlorides and Hydrazine

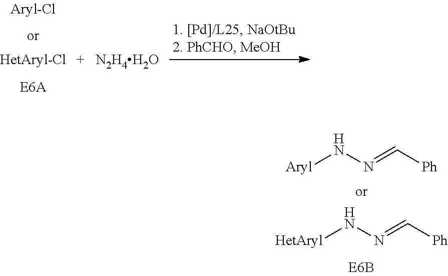

Starting materials and products are provided in Table 5.

TABLE 5
Starting materials and products for reactions of Example 6.

| | | mol % | Temp/time | Yield |
|---|---|---|---|---|
| Entry | ArCl | Pd | [° C./h] | [%]^{[b]} |
| 1 | 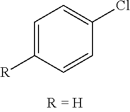 | 5 | 90/1 | 2b 86 |
| 2 | R = Me | 5 | 90/1 | 2c 93 |
| 3 | R = Ph | 3 | 90/1 | 2a 86 |
| 4 | R = 4-OMeC₆H₄ | 5 | 90/0.5 | 2d 82 |
| 5^{[c]} | R = 4-CF₃C₆H₄ | 3 | 90/0.5 | 2e 83 |
| 6 | R = N-pyrrole | 5 | 90/1 | 2f 78 |
| 7 | R = CF₃ | 5 | 90/1 | 2g 50 |
| | | (2.5) | | (44)^{[d]} |
| 8 | R = 3-pyridine | 5 | 65/2 | 2h 97 |
| 9^{[c]} | R = OMe | 10 | 110/1 | 2i 27 |
| 10^{[c,e]} | R = F | 5 | 90/0.33 | 2j 49 |
| 11 | 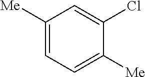 | 5 | 90/1 | 2k 88 |
| 12^{[c,f]} | 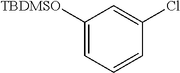 [SMILES: CC(C)(C)[Si](C)(C)Oc1cccc(Cl)c1] | 5 | 90/0.5 | 2l 83 |
| 13 | 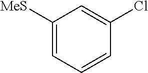 | 10 | 110/0.5 | 2m 95 |
| 14 | 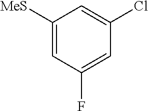 | 5 | 90/1 | 2n 72 |
| 15 | 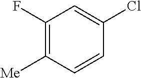 | 5 | 90/1 | 2o 77 |
| 16 | 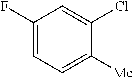 | 5 | 90/0.5 | 2p 75 |
| 17 | 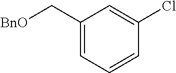 [SMILES: Clc1cccc(COCc2ccccc2)c1] | 5 | 65/1 | 2q 83 |
| 18^{[c]} | 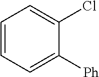 [SMILES: Clc1ccccc1-c1ccccc1] | 10 | 90/1 | 2r 71 |
| 19 | 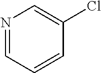 | 5 | 65/1.5 | 2s 69 |
| 20^{[f]} | 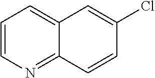 [SMILES: Clc1ccc2ncccc2c1] | 3 | 65/1 | 2t 81 |
| 21 | 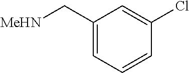 | 5 | 90/0.5 | 2u 75 |
| 22 | 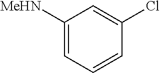 | 5 | 90/0.5 | 2v 58 |

[a] Conditions: ArCl:N₂H₄.H₂O:NaOtBu=1:2:2-1.8, [Pd]=[Pd(cinnamyl)Cl]₂, [Pd]:L12=1:1.5, in toluene (0.1 M). [b] Isolated yield. [c] Employing N₂H₄.HCl and 3.5 equiv. NaOtBu. [d] >95% cony. of ArCl, yield at 2.5 mol % Pd in brackets. [e] In 1,4-dioxane. [f] Isolated aryl hydrazine. TBDMS=tert-butyldimethylsilyl.

### Example 7

### Palladium-Catalyzed Cross-Coupling of Aryl Chlorides or Heteroaryl Chlorides and Hydrazine

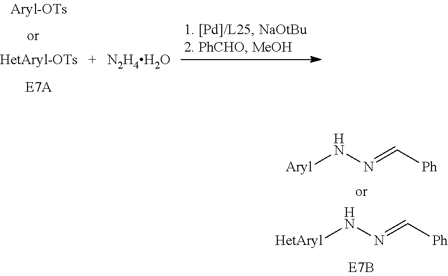

Starting materials and products are provided in Table 6.

TABLE 6
Starting materials and products for reactions of Example 7.

| | | mol % | Temp/time | Yield |
|---|---|---|---|---|
| Entry | ArOTs | Pd | [° C./h] | [%]^{[b]} |
| 1^{[c]} | 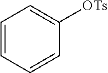 [SMILES: Cc1ccc(S(=O)(=O)Oc2ccccc2)cc1] | 5 | 90/1 | 2b 86 |
| 2^{[c]} | 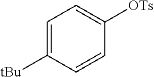 [SMILES: Cc1ccc(S(=O)(=O)Oc2ccc(C(C)(C)C)cc2)cc1] | 5 | 90/1 | 2c 93 |
| 3 | 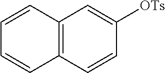 [SMILES: Cc1ccc(S(=O)(=O)Oc2ccc3ccccc3c2)cc1] | 3 | 90/1 | 2a 86 |
| 4^{[d]} | 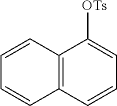 [SMILES: Cc1ccc(S(=O)(=O)Oc2cccc3ccccc23)cc1] | 5 | 90/0.5 | 2d 82 |
| 5 | 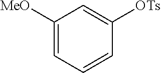 [SMILES: COc1cccc(OS(=O)(=O)c2ccc(C)cc2)c1] | 3 | 90/0.5 | 2e 83 |
| 6 | 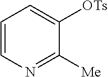 [SMILES: Cc1ccc(S(=O)(=O)Oc2cccnc2C)cc1] | 5 | 90/1 | 2f 78 |
| 7 | 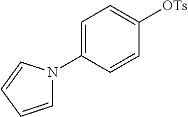 [SMILES: Cc1ccc(S(=O)(=O)Oc2ccc(-n3cccc3)cc2)cc1] | 5 (2.5) | 90/1 | 2g 50 (44)^{[d]} |

[a] Conditions: Identical to Table 5. [b] Isolated yield. [c] Employing N₂H₄.HCl and 3.5 equiv. NaOtBu. [d] Isolated aryl hydrazine.

### Example 8

### Indazole Synthesis Via Cross-Coupling/Condensation Reactions Employing 2-Chlorobenzaldehydes and Hydrazine

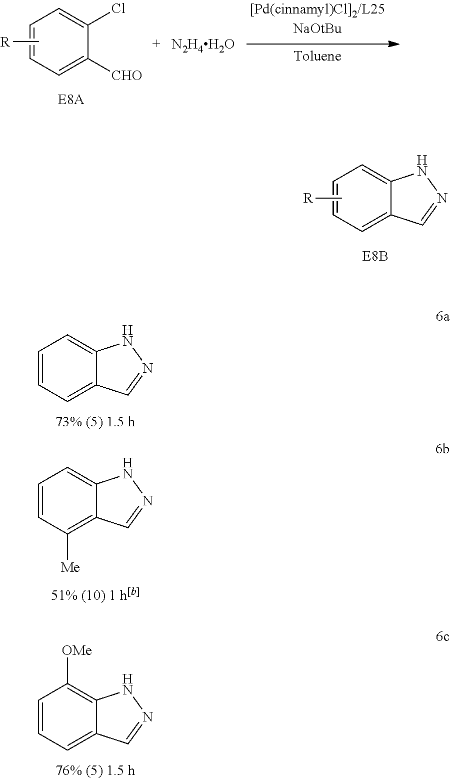

[a] Conditions: ArCl:N₂.H₄—H₂O:NaOtBu=1:2:2, [Pd]:L=1:1.5, [ArCl]=0.20 M in toluene at 65° C., mol % Pd employing indicated in brackets. [b] Employing N₂H₄.HCl and 3.5 equiv. NaOtBu at 90° C.

In Example 8,1-H-indazoles were prepared directly from 2-chlorobenzaldehydes and hydrazine. The protocol above allows for the generation of substituted NH-indazoles with moderate to good yields in short reaction times (1-1.5 h) and under relatively mild conditions (65-90° C.).

### Example 9

### Pd-Catalyzed Cross-Coupling of Ammonia and 4-Chlorotoluene

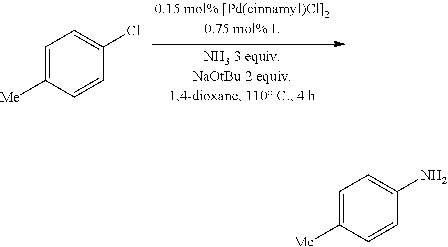 [SMILES: Cc1ccc(Cl)cc1 ; Cc1ccc(N)cc1]

Conversions and ArNH₂:Ar₂NH ratio (indicated in parenthesis) determined by GC. [b] 99% conversion (15:1) after 16 h.

The following ligands, L, were employed in the reaction protocol above.

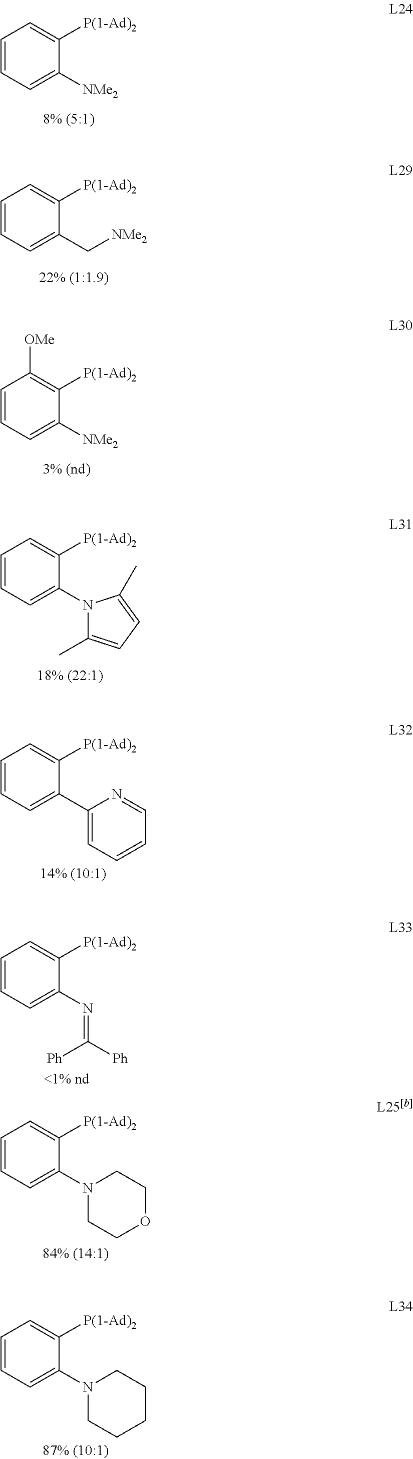

### Example 10

### Ammonia Cross-Coupling to Aryl Chlorides and Tosylates

The following compounds were generated using the reaction protocol of Example 9 and ligand L25.

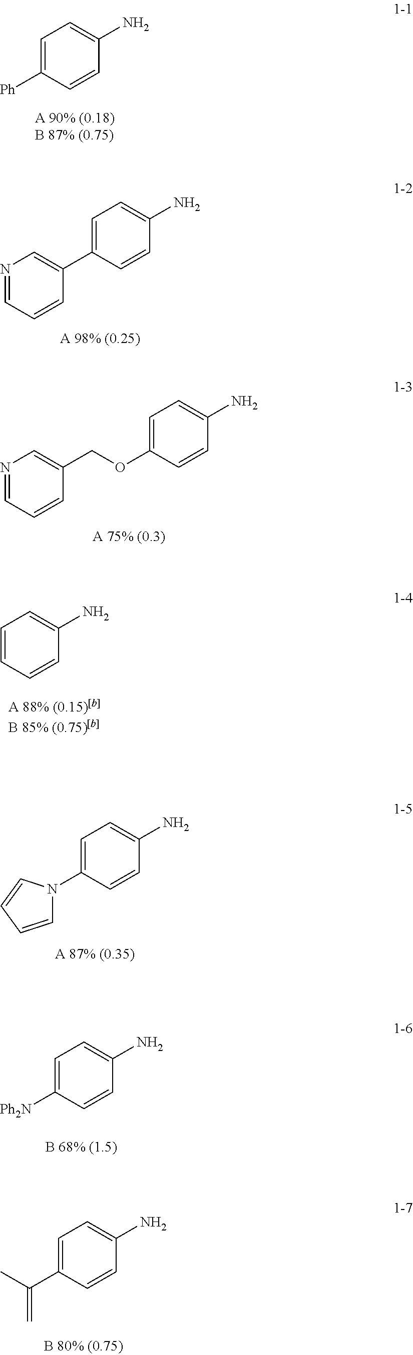

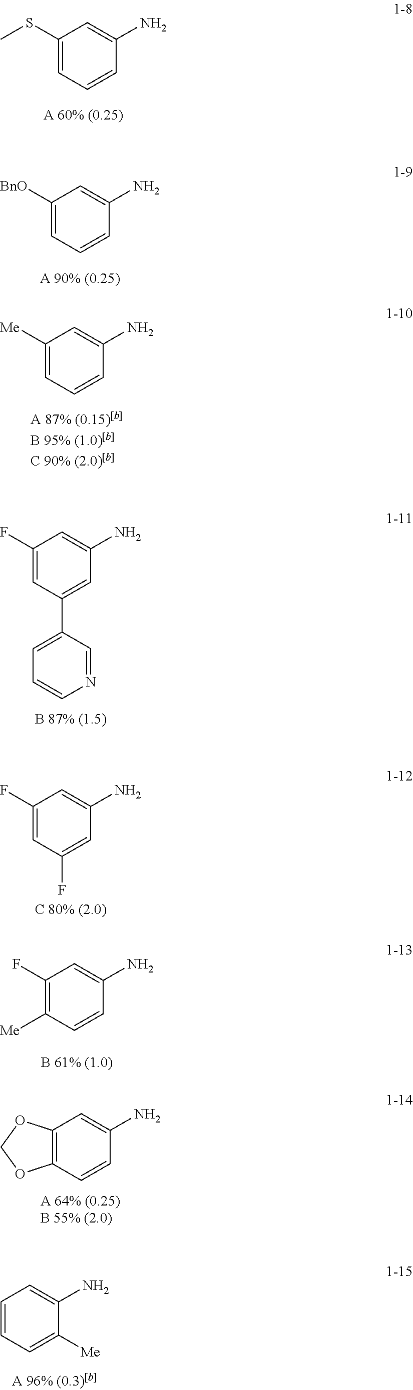

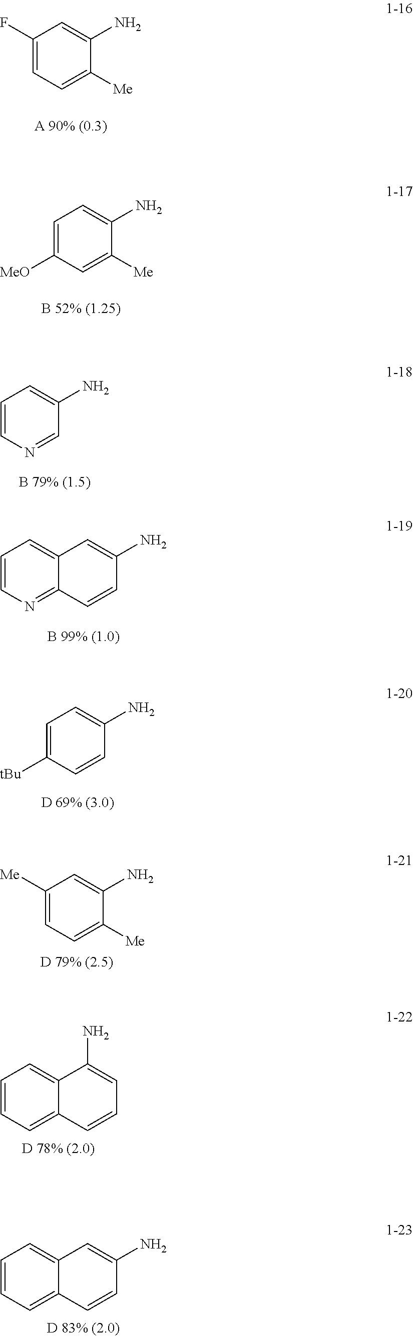

[a] ArCl:NH₃:NaOtBu=1:3-4:2, [Pd]:L25=1:2, [ArCl]=0.10-0.05 M, (2-48 h; see Supporting Information). Yields are of isolated material, mol % [Pd(cinnamyl)Cl]₂ indicated in parentheses. A: T=110° C. B: T=65° C. C: T=50° C. D: From the corresponding ArOTs at room temperature with [Pd]:L25=1:1.5. [b] Determined by GC.

### Example 11

### Chemoselective Ammonia Cross-Coupling

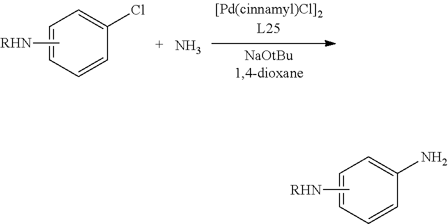

The following compounds were generated using the reaction protocol of Example 11.

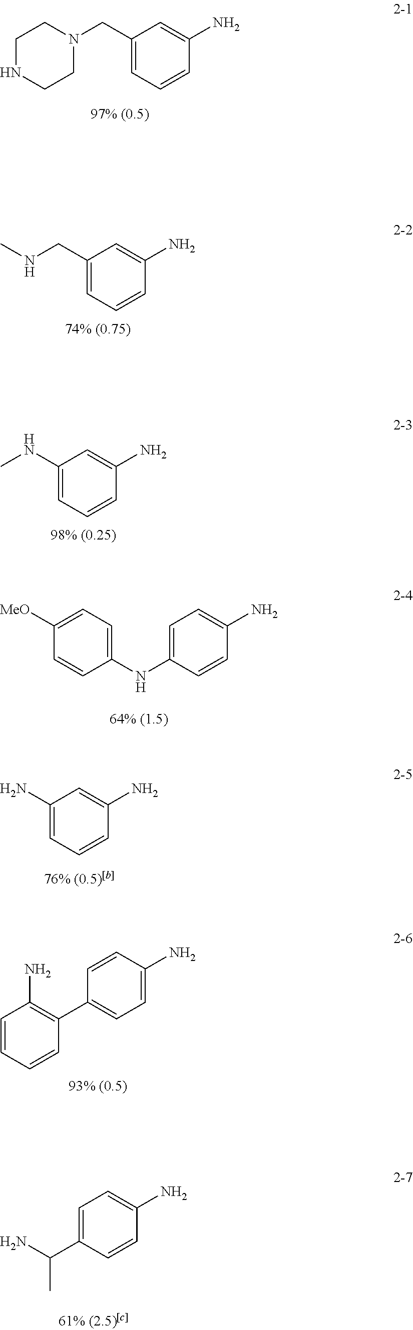

[a] AminoarylCl:NH₃:NaOtBu=1:3-4:2, [Pd]:L25=1:2, 110° C., [ArCl]=0.10-0.05 M. Yields are of isolated material, mol % [Pd(cinnamyl)Cl]₂ indicated in brackets. [b] Isolated as a 8:1 mixture of mono- and diarylation product in 96% combined yield. [c] At 65° C.

### Example 12A

### Paladium-Ligand Complexes

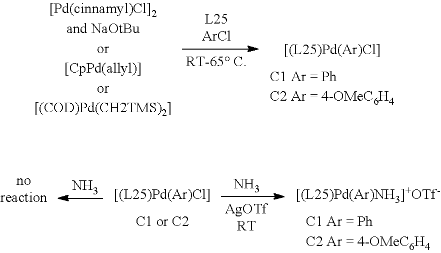

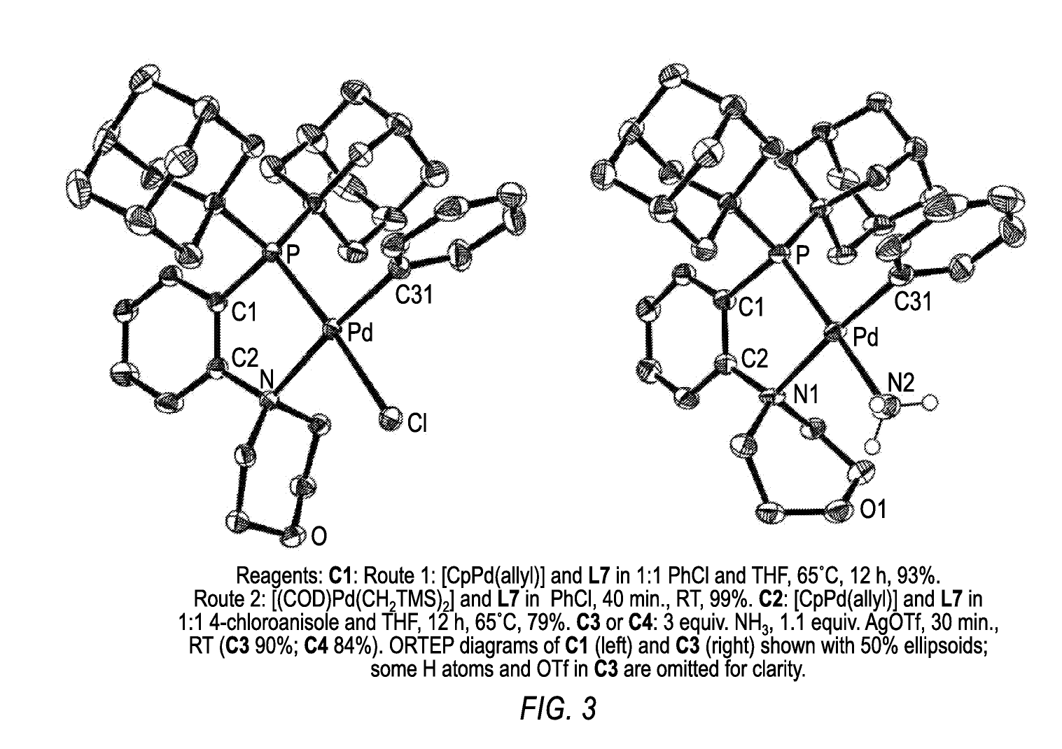

Treatment of [Pd(cinnamyl)Cl]₂ and 2 equivalents of L25 with NaOtBu in chlorobenzene at room temperature resulted in the quantitative formation (³¹P NMR) of a new species after 3 h (FIG. 3). Solution NMR and X-ray crystallographic studies confirmed the identity of this species as being the square planar Pd(H) complex C1, in which L25 is coordinated in a κ²-P,N fashion with Cl trans to P.^{[19-21]} Complex C1 was also prepared successfully from alternative Pd-sources in excellent yield ([CpPd(allyl)], 93%; [(COD)Pd(CH₂TMS)₂], 99%).

Referring to FIG. 3, complex C1, was characterized with solution NMR and X-ray crystallographic studies that confirmed the identity of this species as being the square planar Pd(II) complex Cl, in which L25 is coordinated in a κ²-P,N fashion with Cl trans to P. Complex C1 was also prepared successfully from alternative Pd-sources in excellent yield ([CpPd(allyl)], 93%; [(COD)Pd(CH₂TMS)₂], 99%). The analogous 4-anisolyl derivative C2 was prepared in a similar manner and displayed solution and solid state characteristics analogous to C1. Interestingly, no reaction was observed (³¹P NMR) upon exposure of C1 to ammonia (2-10 equiv.), suggesting that the N-donor arm of L25 is not readily displaced from Pd during catalysis employing ammonia as a substrate. In an effort to examine the reactivity of ammine ligated L25Pd(II) species, the cationic ammonia adducts C3 and C4 were prepared in high isolated yield via addition of AgOTf to either C1 or C2 in the presence of NH₃ (FIG. 1). Treatment of C3 with NaN(TMS)₂ at room temperature promoted the rapid reductive elimination of aniline from the unobserved intermediate [(L25)Pd(Ph)NH₂], which in turn regenerated C1 as the major species (by ³¹P NMR) in the presence of chlorobenzene.

### Example 13

### Room Temperature Cross-Coupling of Aryl Chlorides and Ammonia

The following compounds were generated using a room temp cross-coupling reaction protocol:

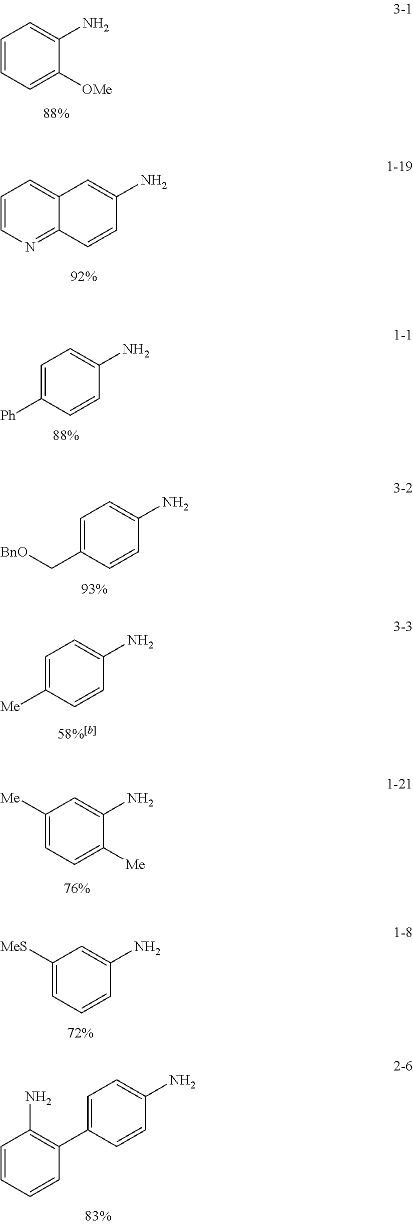

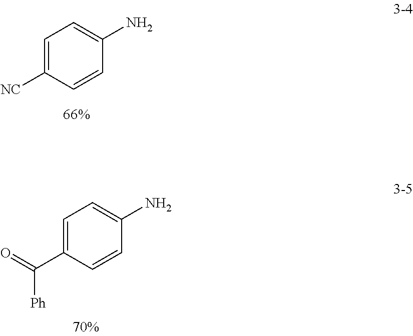 [SMILES: N#Cc1ccc(N)cc1 ; Nc1ccc(C(=O)c2ccccc2)cc1]

[a] 5 mol % Cl, ArCl:NH₃:NaOtBu=1:3:2, [ArCl]=0.10-0.06 M, at room temperature (1-24 h). Yields are of isolated material. [b] Conversions determined by GC.

### Example 14

### Palladium-Ligand Mediated Cross-Coupling of Aniline or Ammonia to Chlorobenzene

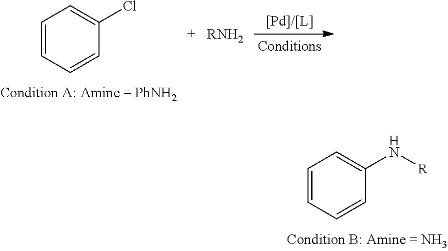

This reaction protocol was followed for the cross-coupling reactions described in Table 7.

TABLE 7
Cross-coupling of aniline or ammonia with chlorobenzene.

| | | | | Yield |
|---|---|---|---|---|
| entry | | [L] | Conditions | (%) |
| 1 2 | L3 | 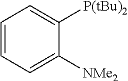 | A B | 92 77 (1:1:3) |
| 3 4 | L24 | 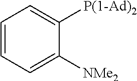 | A B | 87 >99 (2.9:1) |
| 5 6 | L2 | 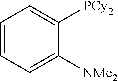 | A B | <10 13 (1:6) |
| 7 8 | L1 | 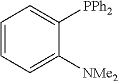 | A B | <10 nd |
| 9 10 | L29 | 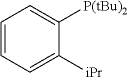 | A B | <10 nd |
| 11 12 | L30 | 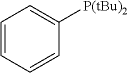 | A B | <10 56 (1:16) |
| 13 14 | L31 | 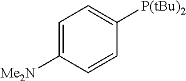 | A B | 17 67 (<1:20) |
| 15 16 | L32 | 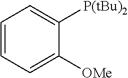 | A B | <10 49 (<1:20) |

Condition A: ArCl:Aniline:NaOtBu=1:1.2:1.4, 1.0 mmol scale in 2 mL toluene at 100° C., 2.5 h, 0.25 mol % [Pd(cinnamyl)Cl]₂ and Pd:L=1:2. Yields of isolated product. Condition B: ArCl:NH₃:NaOtBu=1:10:1.4-1.6, [ArCl]=0.025 M, 1 mol % [Pd(allyl)Cl]₂, Pd:L=1:4, 20 h at 110° C. in 1,4-dioxane. Conversions determined by consumption of chlorobenzene, with PhNH₂:Ph₂NH indicated in parenthesis as determined on the basis of calibrated GC data. Data represents an average of two runs. nd=not determined.

### Example 15

### Cross-Coupling of Aryl and Heteroaryl Chlorides with Ammonia

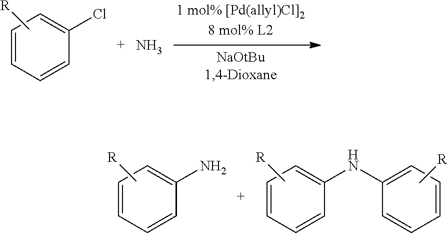

ArCl:NH₃:NaOtBu=1:10:1.4-1.6, [ArCl]=0.025-0.04 M, conversions determined by consumption of ArCl, with ArNH₂:Ar₂NH indicated in parenthesis as determined on the basis of calibrated GC data, 16-20 h, 110-120° C. in 1,4-dioxane. [a] Isolated yield. [b] From ca. 90% pure 1-chloronaphthalene. [c] Using Pd:L=1:2. [d] Using 4 mol % Pd.

The reaction protocol in this example was used to generate the following compounds:

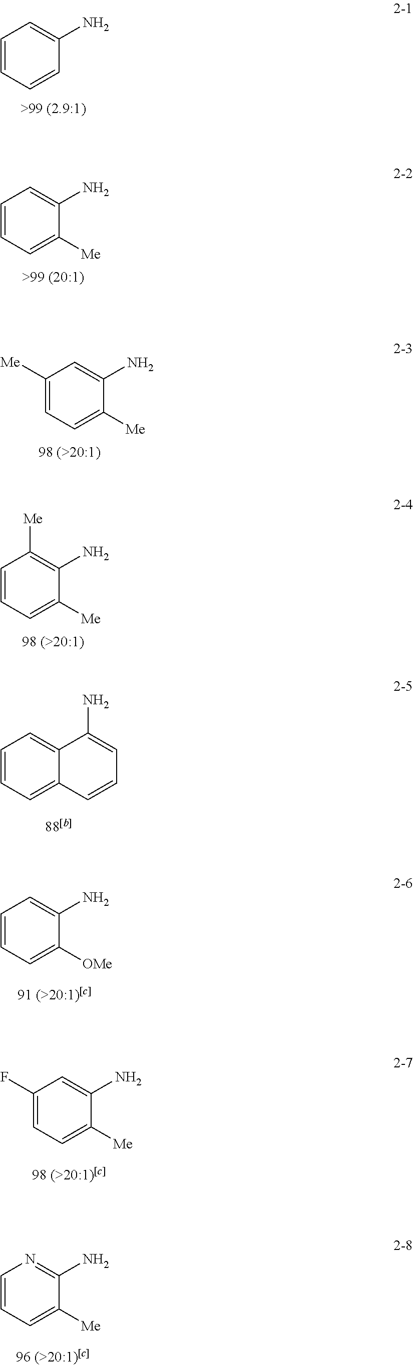

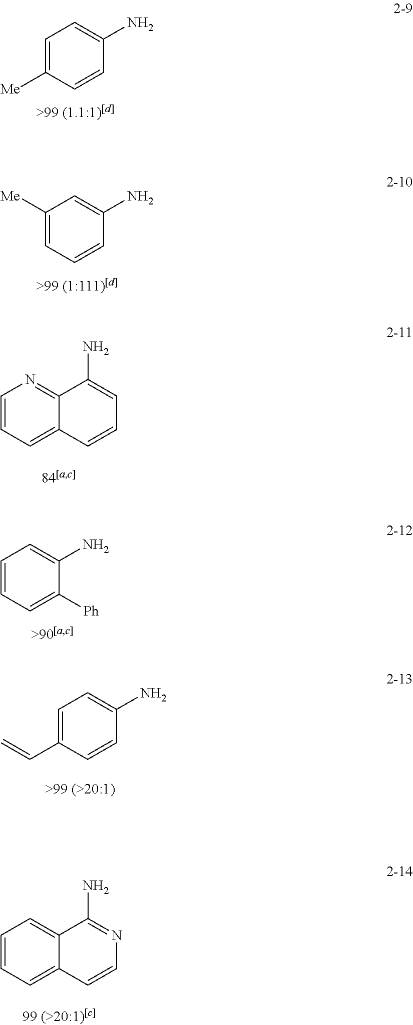

### Example 16

### Cross-Coupling of Aryl and Heteroaryl Chlorides with Primary Amines

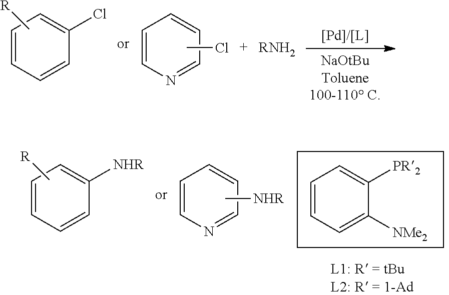

This reaction protocol was used to generate the following compounds:

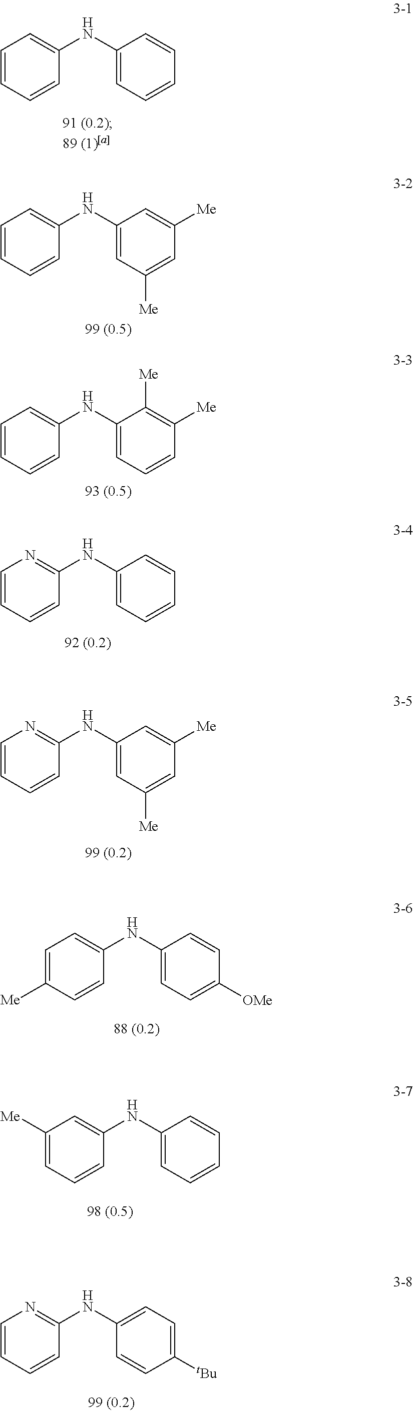

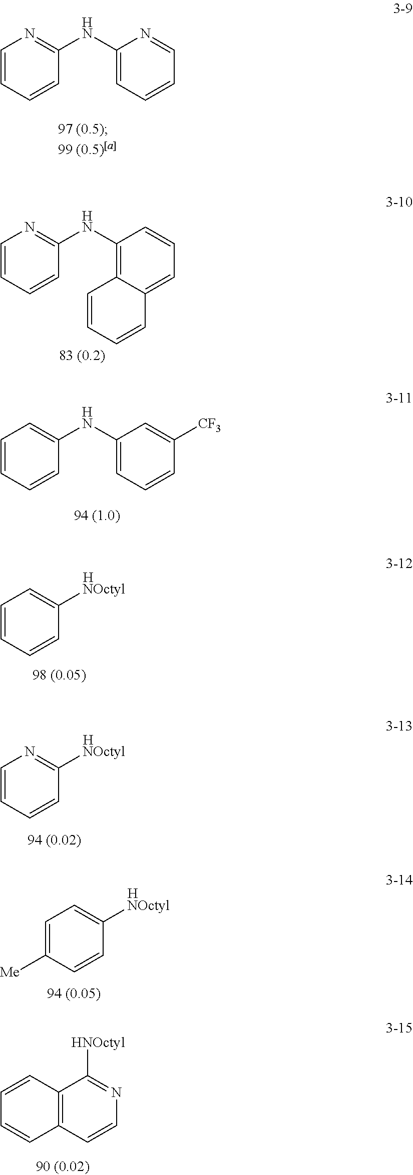

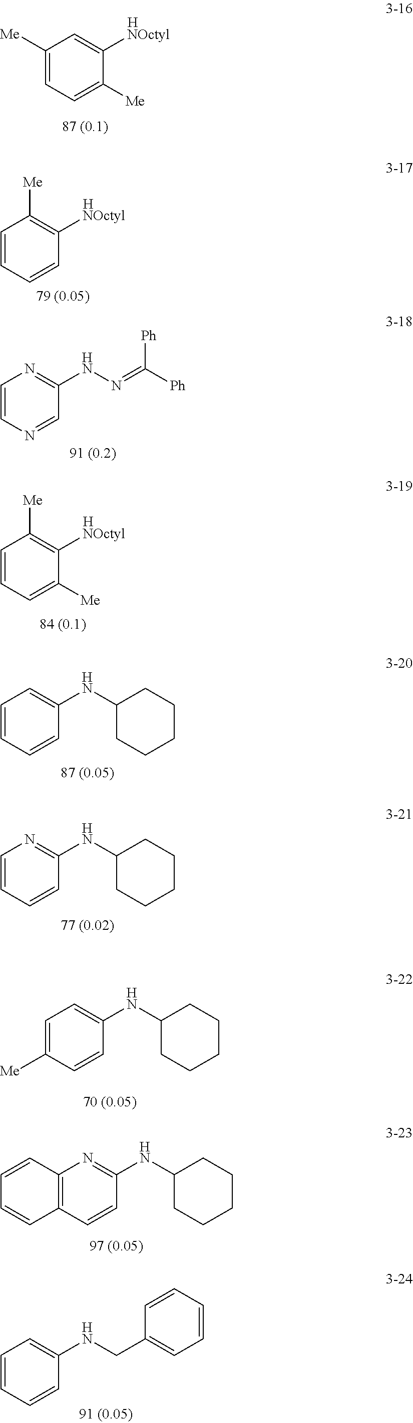

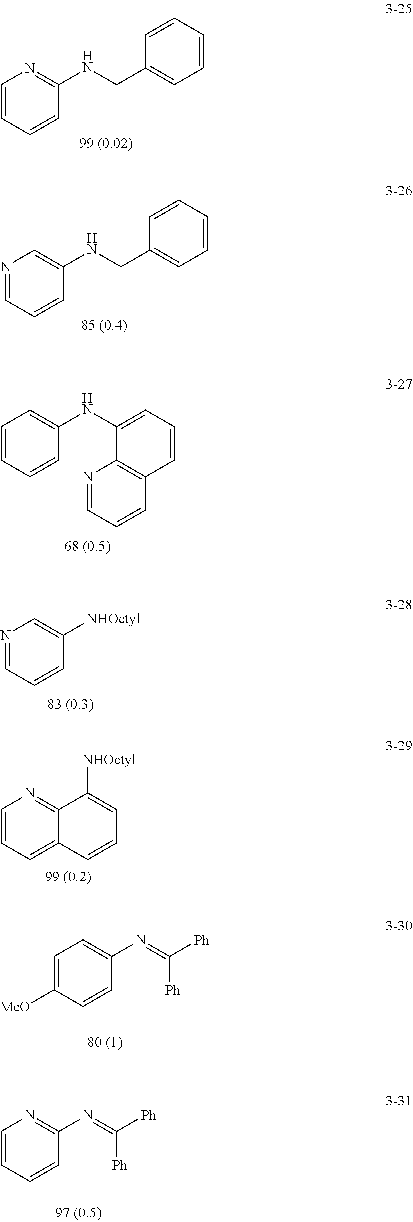

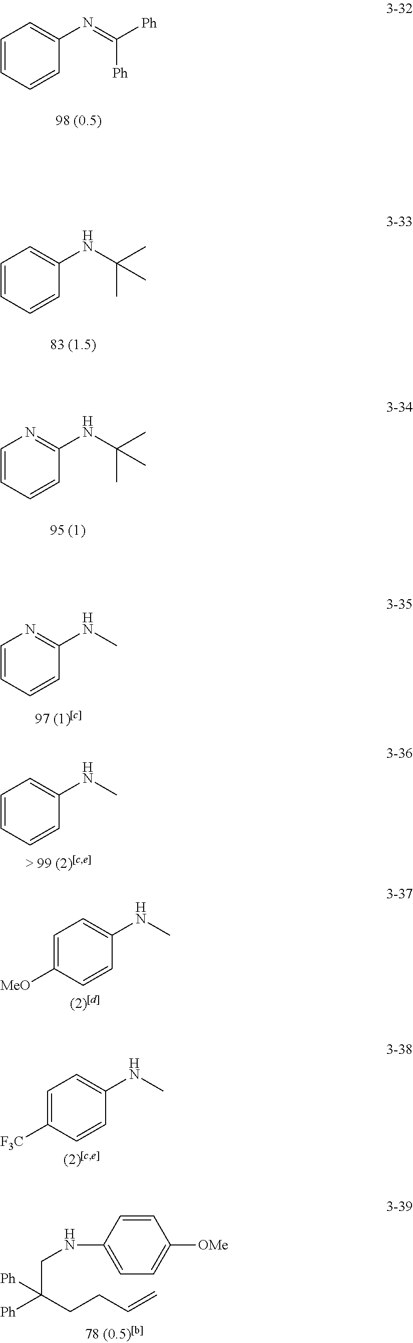

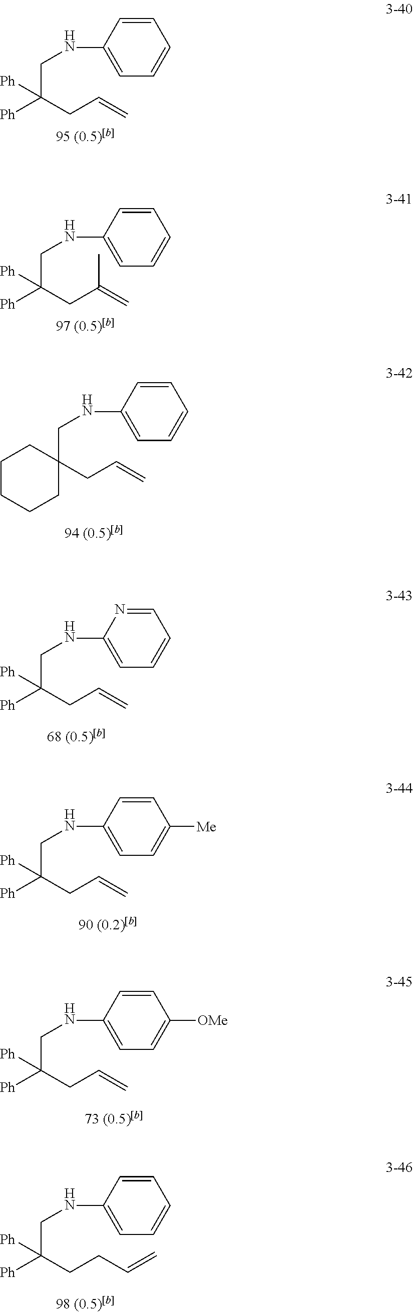

ArCl:Amine:NaOtBu=1:1.2:1.4, 1.0 mmol scale, 3-48 h (reaction times not optimized; see supporting information). Isolated yields are an average of two runs, mol % Pd employed (from [Pd(allyl)Cl]₂ or [Pd(cinnamyl)Cl]₂) indicated in parentheses (Pd:L=1:2). [a] Using 10 equiv. of LiNH₂, [ArCl]=0.2 M. [b] Using 1.05 equiv. of amine. [c] Using 4 equiv. H₂NMe at 65° C. [d] Using 4 equiv. H₂NMe at 85° C. [e] Percent conversion determined on the basis of GC data. Where ambiguous, the left portion of the product is derived from the aryl chloride.

### Example 17

### Cross-Coupling of Aryl and Heteroaryl Chlorides with Secondary Amines

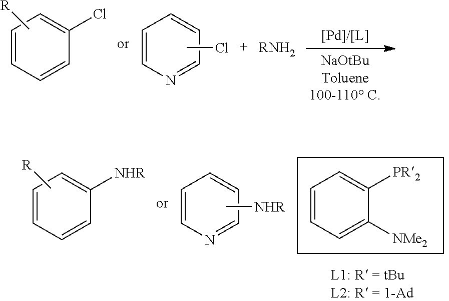

The following cross-coupling products were generated according to the reaction protocol of this example:

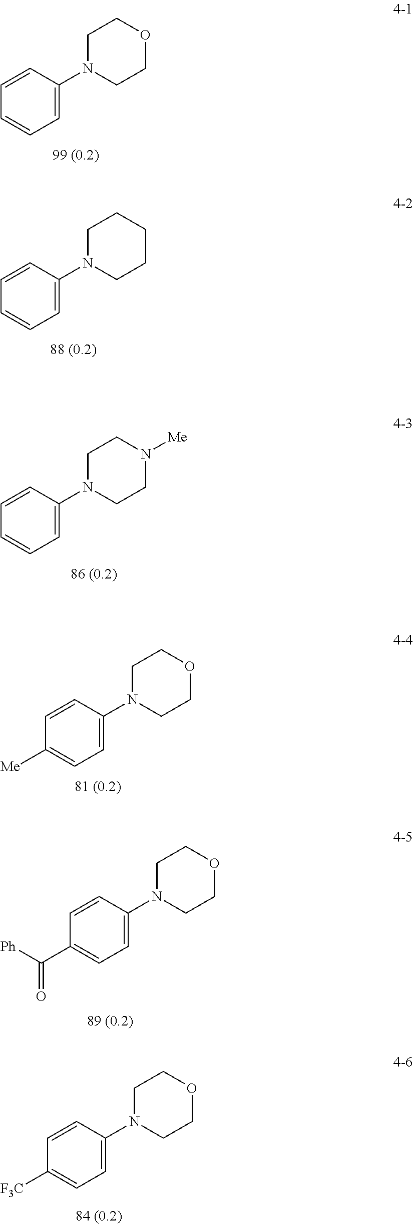 [SMILES: c1ccc(N2CCOCC2)cc1 ; c1ccc(N2CCCCC2)cc1 ; CN1CCN(c2ccccc2)CC1 ; Cc1ccc(N2CCOCC2)cc1 ; O=C(c1ccccc1)c1ccc(N2CCOCC2)cc1 ; FC(F)(F)c1ccc(N2CCOCC2)cc1]

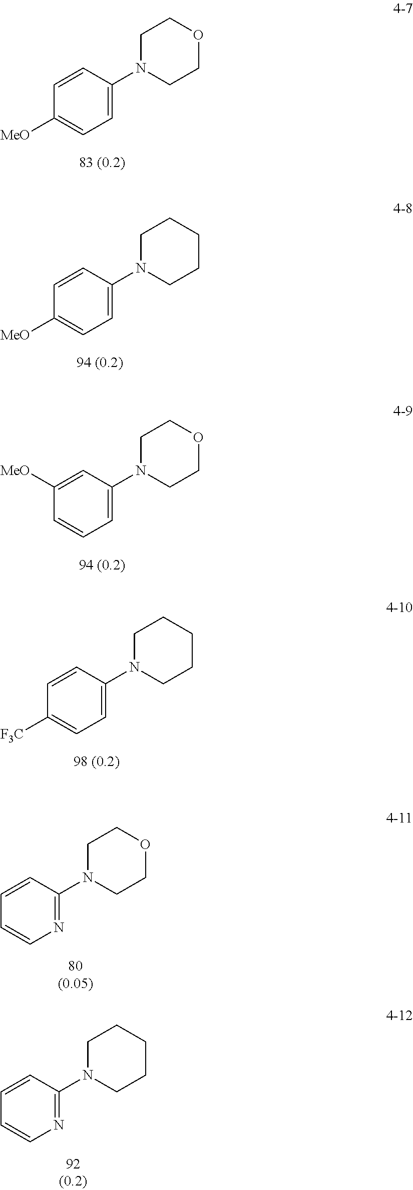 [SMILES: COc1ccc(N2CCOCC2)cc1 ; COc1ccc(N2CCCCC2)cc1 ; COc1cccc(N2CCOCC2)c1 ; FC(F)(F)c1ccc(N2CCCCC2)cc1 ; c1ccc(N2CCOCC2)nc1 ; c1ccc(N2CCCCC2)nc1]

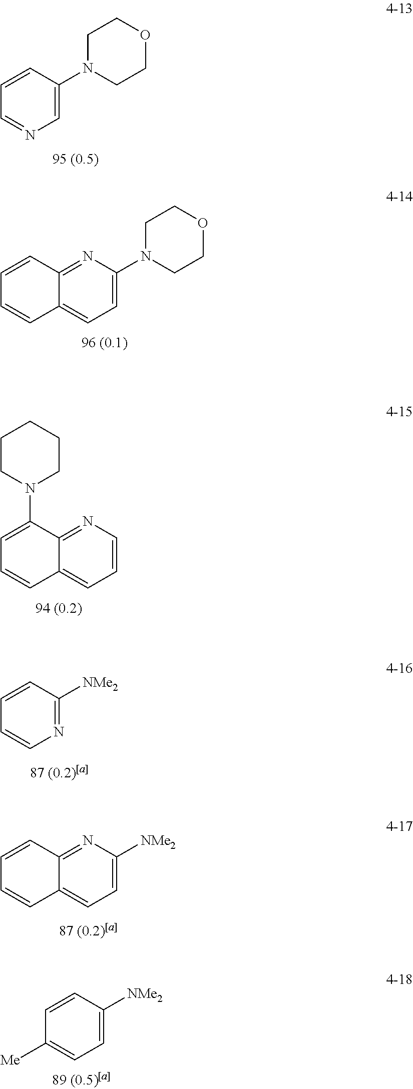 [SMILES: c1cncc(N2CCOCC2)c1 ; c1ccc2nc(N3CCOCC3)ccc2c1 ; c1cnc2c(N3CCCCC3)cccc2c1 ; CN(C)c1ccccn1 ; CN(C)c1ccc2ccccc2n1 ; Cc1ccc(N(C)C)cc1]

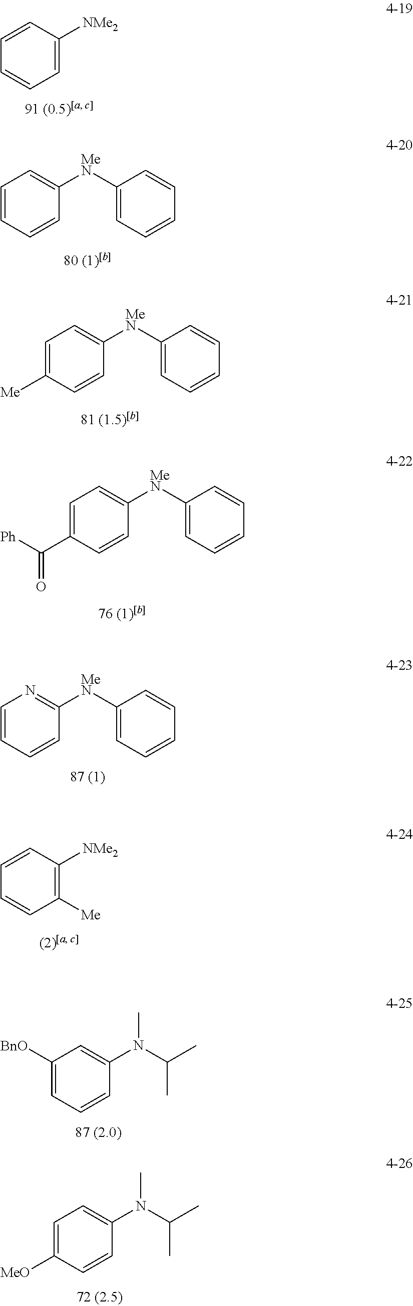

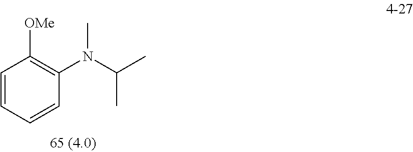

ArCl:Amine:NaOtBu=1:1.2:1.4, 1.0 mmol scale, 3-48 h (reaction times not optimized; see supporting information). Isolated yields are an average of two runs, mol % Pd employed (from [Pd(allyl)Cl]₂ or [Pd(cinnamyl)Cl]₂) indicated in parentheses (Pd:L=1:2). [a] ArCl:HNMe₂=1:2, at 65° C. in 1:1 toluene/THF. [b] Pd:L=1:0.9 in 1,4-dioxane. [c] Percent conversion determined on the basis of GC data. Where ambiguous, the left portion of the product is derived from the aryl chloride.

### Example 18

### Cross-Coupling of Base Sensitive Substrates

The following compounds were generated using the reaction protocols in Examples 15 and 16 and specific reaction descriptions provided below.

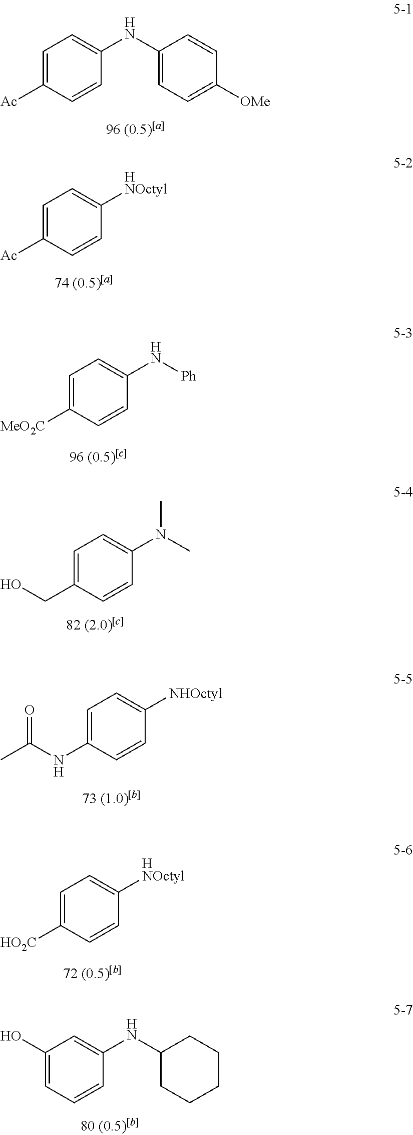

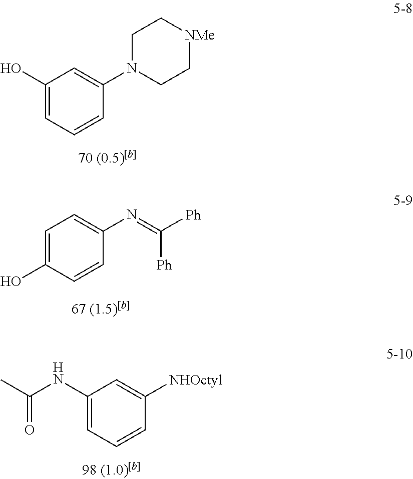

ArCl:Amine:Base=1:1.2:2.2, 0.5-1.0 mmol scale, 2-4 mol % NaOtBu, 2-48 h (reaction times not optimized; see supporting information), 110° C. Mol % Pd employed (from [Pd(allyl)Cl]₂ or [Pd(cinnamyl)Cl]₂) indicated in parentheses (Pd:L=1:2). [a] Using Cs₂CO₃ in 1,4-dioxane. [b] Using LiHMDS in toluene. [c] Using LiHMDS in THF/dioxane at 65° C.

### Example 19

### Experimental Descriptions

General Considerations. Unless noted, all reactions were setup inside a dinitrogen-filled inert atmosphere glovebox. Toluene was deoxygenated by sparging with dinitrogen followed by passage through a double column solvent purification system purchased from mBraun Inc. 1,4-Dioxane (Aldrich) was dried over Na/benzophenone followed by distillation under an atmosphere of dinitrogen. 1,2-Dimethoxyethane was deoxygenated by sparging with dinitrogen gas followed by storage over activated 4 Å molecular sieves for 48 h prior to use. Chloroform-d₁ (Cambridge Isotopes) was used as received. All solvents used within the glovebox were stored over activated 4 Å molecular sieves. Aniline was distilled under reduced pressure prior to use. [Pd(cinnamyl)Cl]₂, diphenyl-2-dimethylaminophenylphosphane (L4), di(tert-butyl)-2-(isopropylphenyl)phosphane (L5), di(tert-butyl)phenylphosphane (L6), di-1-adamantylphosphane, and amino alkene substrates were prepared according to literature procedures. Di(tert-butyl)-2-(methoxyphenyl)phosphane (L8) was prepared in a manner similar to L2, and the spectroscopic features of the isolated complex agreed with those reported previously. Pd starting materials as well as NaOtBu and Cs₂CO₃ were evacuated under reduced pressure for 24 h prior to use and stored in an inert atmosphere glove box. All other reagents were used as received from commercial sources. Conversions based on gas chromatography data obtained for the arylation of aniline and ammonia were determined by calibration with standards of chlorobenzene, aniline and diphenylamine; product identity was confirmed on the basis of ¹H NMR, GC-MS data, and/or by comparison with authentic samples. ¹H, ¹³C, and ³¹P NMR characterization data were collected at 300 K on a Bruker AV-500 spectrometer operating at 500.1, 125.8, and 202.5 MHz (respectively) with chemical shifts reported in parts per million downfield of SiMe₄ for ¹H and ¹³C, and 85% H₃PO₄ in D₂O for ³¹P.

### Improved synthesis of 2-(di-tert-butylphosphino)-N,N-dimethylaniline (L1)

In an analogous manner to the synthesis of L2 (vide infra), the title compound was prepared by Pd-catalyzed cross-coupling of tBu₂PH and bromo-N,N-dimethylaniline. The product was isolated in 71% yield after recrystallization from hexane at −35° C. The spectral properties agreed with those reported previously.

### Synthesis of 2-(di-1-adamantylphosphino)-N,N-dimethylaniline (L2)

Pd(OAc)₂ (6.3 mg, 0.028 mmol) was added to a glass vial and dissolved in toluene (2 mL). This solution was then transferred to a vial containing DiPPF (1,1′-bis(diisopropylphosphino)ferrocene; 14.2 mg, 0.034 mmol) and was left to stir for 10 minutes. To a separate glass vial containing NaOtBu (192 mg, 2.0 mmol) was added a solution of (1-adamantyl)₂PH (410 mg, 1.36 mmol) in 2 mL toluene, followed by 2-bromo-N,N-dimethylaniline (230 μL, 1.4 mmol), and the Pd(OAc)₂/DiPPF solution, after which the vial was sealed with a cap containing a PTFE septum. The mixture was stirred for 20 h at 110° C., at which point the reaction was deemed complete on the basis of ³¹P NMR data obtained from an aliquot of the reaction mixture. The reaction mixture was then allowed to cool and was passed through a plug of silica, followed by washing of the plug with 40 mL of CH₂Cl₂. The combined eluent was collected and the solvent was removed in vacuo. The resulting pale orange solid was washed with cold hexanes (2×4 mL). Removal of volatile materials in vacuo yielded the product as an off-white powder (0.424 g, 1.01 mmol; 74% yield). ¹H NMR (CDCl₃): δ 7.71 (m, 1H, Ar—H), 7.32 (m, 1H, Ar—H), 7.20 (m, 1H, Ar—H), 7.05 (m, 1H, Ar—H), 2.71 (s, 6H, N(CH₃)₂), 2.01-1.89 (m, 18H, 1-Ad), 1.67 (s, 12H, 1-Ad). ¹³C{¹H} NMR (CDCl₃): δ 161.6 (d, J_{PC}=21.6 Hz, C_{quat}), 137.4 (d, J_{PC}=3.3 Hz), 131.1 (d, J_{PC}=22.9 Hz, C_{quat}), 129.6, 122.2, 120.6 (d, J_{PC}=3.9 Hz), 46.1 (d, J_{PC}=4.2 Hz, N(CH₃)₂), 41.8 (d, J_{PC}=13.0 Hz, CH₂), 37.1 (CH₂), 29.0 (d, J_{PC}=8.6 Hz, CH). ³¹P{¹H} NMR (CDCl₃): δ 20.1. HRMS (ESI/[M+H]⁺) calcd. for C₂₈H₄₀N₁P₁: 422.2971. Found: 422.2978. Anal. Calcd for C₂₈H₄₀P₁N₁: C, 79.77; H, 9.56; N, 3.32. Found: C, 79.47; H, 9.46; N, 3.31.

### Synthesis of 2-(dicyclohexylphosphino)-N,N-dimethylaniline (L3)

To a glass vial containing 2-bromo-N,N-dimethylaniline (288 μL, 2.0 mmol) in 3 mL Et₂O (pre-cooled to −35° C.), was added n-BuLi (759 μL, 2.2 mmol). After 30 minutes at −35° C. and an additional 15 minutes at room temperature, the resulting yellow precipitate was isolated by removing the solvent by using a pipette, followed by washing of the remaining solid with cold hexanes (3×2 mL), after which the volatile materials were removed in vacuo. The resulting solid was dissolved in 6 mL Et2O and ClPCy2 (440 μL, 2.0 mmol) was added dropwise. The mixture was stirred magnetically at room temperature for 48 h. The solvent and volatile materials were then removed in vacuo. The resulting mixture was dissolved in CH₂Cl₂ and washed with 10 mL of saturated NaHCO₃ and 10 mL of water. The organic layer was extracted, dried in vacuo and passed through a plug of silica as a pentane solution. Removal of the solvent in vacuo yielded the product as a white solid (0.162 g, 0.51 mmol, 25% yield). ¹H NMR (CDCl₃): δ 7.35 (d of t, J=7.6, 1.9 Hz, 1H), 7.28 (m, 1H), 7.13 (d of d of d, J=8.0, 4.3, 1.2, 1H), 7.05 (d of t, J=7.4, 1.3, 1H), 2.72 (s, 6H), 1.90-1.74 (m, 12H), 1.30-0.99 (m, 10H). ¹³C {¹H} NMR (CDCl₃): δ 160.8, 133.8 (d, J=2.7 Hz), 132.0, 129.8, 123.6, 120.2 (d, J=2.9 Hz), 46.4 (d, J=5.0 Hz), 34.2 (d, J=14.3), 30.8 (d, J=16.6 Hz), 29.6 (d, J=8.9 Hz), 27.8 (d, J=11.6 Hz), 27.7 (d, J=7.6 Hz), 27.0. ³¹P{¹H} NMR (CDCl₃): δ −12.7.

### Synthesis of 4-(di-tert-butylphosphino)-N,N-dimethylaniline (L7)

The title compound was prepared in a manner similar to Guram et. al., only using 4-iodo-N,N-dimethylaniline instead of 4-bromo-N,N-dimethylaniline. This ligand is commercially available from Aldrich, however the spectroscopic properties have not been disclosed. ¹H NMR (CDCl₃): δ 7.54 (m, 2H), 6.68 (d, J=8.7 Hz, 2H), 2.98 (s, 6H), 1.20 (d, J=11.2 Hz, 18H). ¹³C{¹H} NMR (CDCl₃): 150.9, 129.3 (d, J=101.7 Hz), 122.0 (d, J=15.5 Hz), 111.4 (d, J=9.1 Hz), 40.3, 32.1 (d, J=19.3 Hz), 30.7 (d, J=14.2 Hz). ³¹P{¹} NMR (CDCl₃): δ 36.7.

Representative Procedure for the Coupling of Primary or Secondary Amines with Aryl Chlorides

In an inert atmosphere glovebox, [Pd(cinnamyl)Cl]₂ (0.67 mg, 0.0013 mmol, from a toluene stock solution) and L2 (2.2 mg, 0.0052 mmol) were mixed in a total of 2.000 mL toluene for 10 minutes. From this stock solution, 383 μL was added to a vial containing NaOtBu (135 mg, 1.4 mmol), followed by 600 μL of additional toluene. The vial was sealed with a cap containing a FIFE septum and removed from the glovebox. Chlorobenzene (103 μL, 1.0 mmol) and octylamine (200 μL, 1.2 mmol) were added by use of a microlitre syringe. The reaction mixture was heated at 110° C. and periodically monitored by use of MC or gas chromatography. Upon completion of the reaction, the product was purified by column chromatography on silica (20:1 Hex:EtOAc) and isolated as a colorless oil (0.203 g, 99% yield). Alternatively, samples of [Pd(cinnamyl)Cl]₂, ligand, and NaOtBu stored under N₂ could be weighed out on the benchtop into a vial. Following addition of chlorobenzene, octylamine and anhydrous toluene, the vial was sealed with a cap containing a PTFE septum, purged with N₂ and heated at 110° C., with results similar to those obtained from reactions setup in a glovebox (99% conversion on the basis of GC data at 0.1 mol % Pd).

Representative Procedure for the Coupling of Ammonia with Aryl Chlorides

In an inert atmosphere glovebox, [Pd(allyl)Cl]₂ (2.2 mg, 0.006 mmol) and L2 (10.1 mg, 0.024 mmol) were vigorously mixed in 4 mL of dioxane for 10 minutes. From this stock solution, 1.000 mL was added to a vial containing 20 mg NaOtBu. The vial was sealed with a cap containing a PTFE septum and removed from the glovebox. 2-Chloro-3-methylpyridine (16 μL, 0.15 mmol) was added by use of a microlitre syringe, followed by 3 mL of a 0.5 M solution of NH₃ in 1,4-dioxane. The reaction mixture was stirred at 110° C. and monitored by use of gas chromatography.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A compound of Formula I: 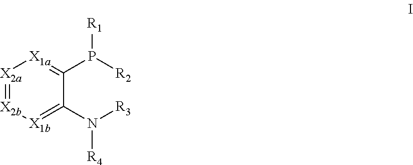
wherein
Each of R¹ and R² is independently selected from tert-butyl, cyclohexyl, 2-tolyl, or 1-adamantyl;
Each of R³ and R⁴ is independently selected from a C₁₋₅ alkyl, or
R³, R⁴, and the nitrogen atom to which they are attached form an optionally substituted 4-10 membered heterocyclic ring;
Each of X₁ₐ and X_{1b}, is independently selected from N or C—R⁵;
Each of X₂ₐ and X_{2b}, is independently selected from N or C—R⁶;
Each R⁵ is independently selected from —H, —CH₃, —OCH₃, halogen, or —CF₃;
Each R⁶ is independently selected from —H, —CH₃, —OCH₃, —N(CH₃)₂, halogen, or —CF₃; or
a vicinal R⁵ group and R⁶ group together with the carbon atoms to which they are attached form an optionally substituted 5-7 membered heterocyclic or carbocyclic ring; or
two R⁶ groups together with the carbon atoms to which they are attached form an optionally substituted 5-7 membered heterocyclic or carbocyclic ring; and
wherein no more than one of X₁ₐ, X_{1b}, X₂ₐ, or X_{2b} is N.

2. The compound of claim 1, wherein both of R¹ and R² are tert-butyl, cyclohexyl, 2-tolyl, or 1-adamantyl.

3. The compound of claim 2, wherein both of R¹ and R² are tert-butyl or 1-adamantyl.

4. (canceled)

5. (canceled)

6. The compound of claim 1, wherein R³, R⁴, and the nitrogen atom to which they are attached form an optionally substituted 4-10 membered heterocyclic ring.

7. The compound of claim 6, wherein R³, R⁴, and the nitrogen atom to which they are attached form 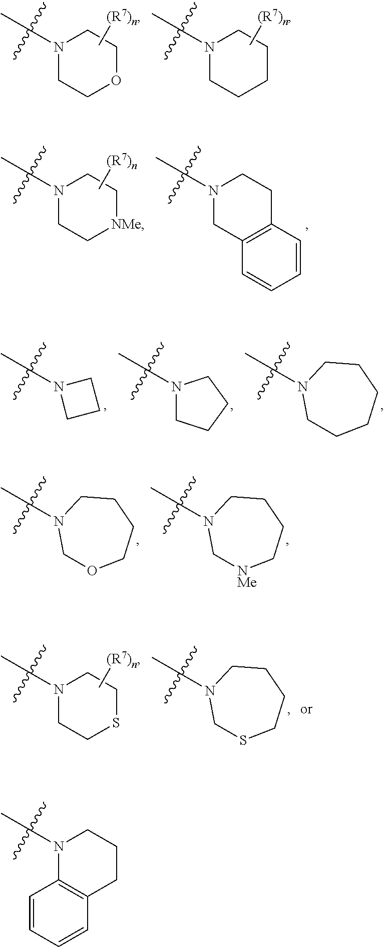
wherein n is 0-2, and R⁷ is —CH₃.

8. The compound of claim 7, wherein R³, R⁴, and the nitrogen atom to which they are attached form

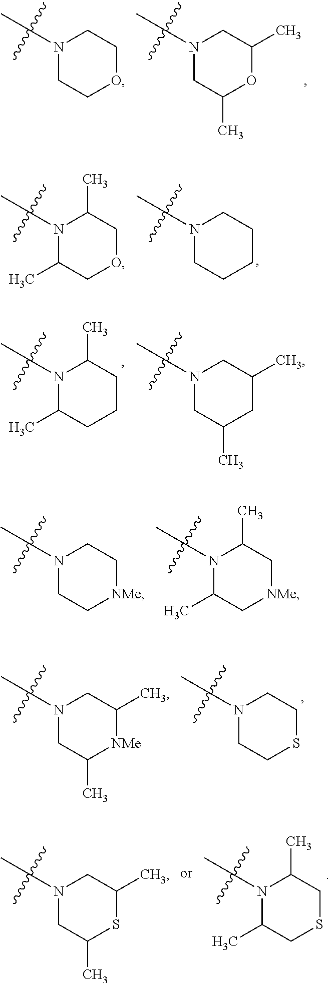

9. The compound of claim 1, wherein each of X₁ₐ and X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring.

10. The compound of claim 9, wherein each of X₁ₐ, X_{1b}, X₂ₐ, and X_{2b} is C—H.

11. A compound of Formula IA: 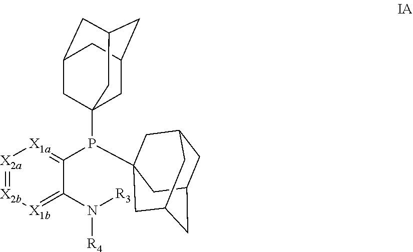
wherein
Each of R³ and R⁴ is independently selected from a C₁₋₅ alkyl, or
R³, R⁴, and the nitrogen atom to which they are attached form an optionally substituted 4-10 membered heterocyclic ring;
Each of X₁ₐ and X_{1b}, is independently selected from N or C—R⁵;
Each of X₂ₐ and X_{2b}, is independently selected from N or C—R⁶;
Each R⁵ is independently selected from —H, —CH₃, —OCH₃, halogen, or —CF₃;
Each R⁶ is independently selected from —H, —CH₃, —OCH₃, —N(CH₃)₂, halogen, or —CF₃; or
A vicinal R⁵ group and R⁶ group together with the carbon atoms to which they are attached form an optionally substituted 5-7 membered heterocyclic or carbocyclic ring; or
two R⁶ groups together with the carbon atoms to which they are attached form an optionally substituted 5-7 membered heterocyclic or carbocyclic ring; and wherein no more than one of X₁ₐ, X_{1b}, X₂ₐ, or X_{2b} is N.

12. (canceled)

13. The compound of claim 11, wherein R³, R⁴, and the nitrogen atom to which they are attached form an optionally substituted 4-10 membered heterocyclic ring.

14. The compound of claim 13, wherein R³, R⁴, and the nitrogen atom to which they are attached form 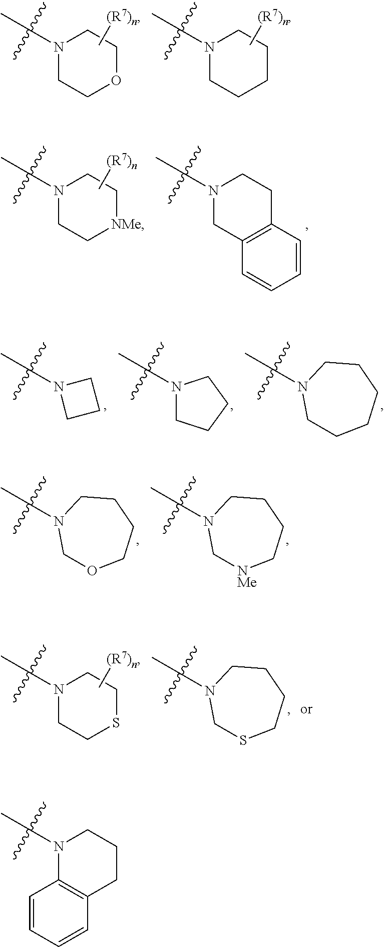
wherein n is 0-2, and R⁷ is —CH₃.

15. The compound of claim 14, wherein R³, R⁴, and the nitrogen atom to which they are attached form

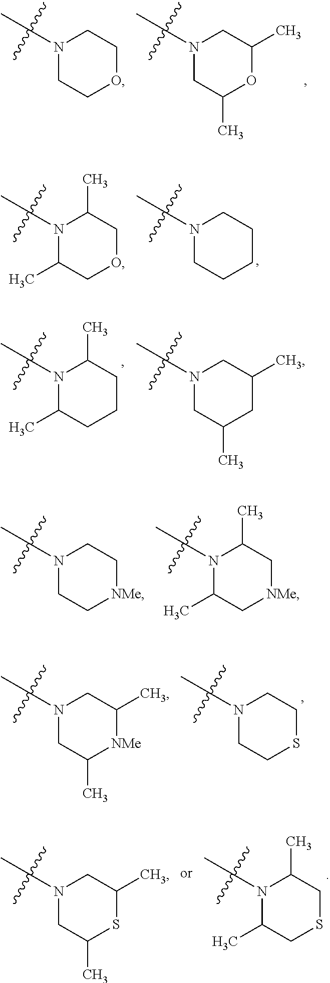

16. The compound of claim 11, wherein each of X₁ₐ and X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or cycloaliphatic ring; or two R⁶ groups together with the carbon atoms to which they are attached form an optionally substituted 5-7 membered heterocyclic or cycloaliphatic ring.

17. The compound of claim 16, wherein each of X₁ₐ and X_{1b} is C—H, and each of X₂ₐ and X_{2b} is C—R⁶, wherein the two R⁶ groups together with the carbon atoms to which they are attached form an optionally substituted 5-7 membered heterocyclic or carbocyclic ring.

18. (canceled)

19. The compound of claim 11, wherein X₁ₐ is N, X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring; or two R⁶ groups together with the carbon atoms to which they are attached form an optionally substituted 5-7 membered heterocyclic or cycloaliphatic ring.

20. The compound of claim 11, wherein X₂ₐ is N, X_{2b} is C—R⁶, and each of X₁ₐ and X_{1b} is C—R⁵, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃.

21. The compound of claim 11, wherein X_{2b} is N, X₂ₐ is C—R⁶, and each of X₁ₐ and X_{1b} is C—R⁵, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃.

22. The compound of claim 11, wherein X_{1b} is N, X₁ₐ is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring; or two R⁶ groups together with the carbon atoms to which they are attached form an optionally substituted 5-7 membered heterocyclic or carbocyclic ring.

23. A compound of Formula IB: 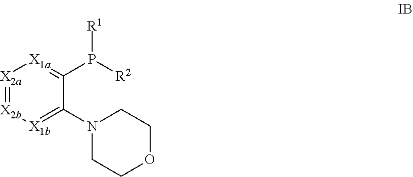
wherein
Each of R¹ and R² is independently selected from tert-butyl, cyclohexyl, 2-tolyl, or 1-adamantyl;
Each of X₁ₐ and X_{1b}, is independently selected from N or C—R⁵;
Each of X₂ₐ and X_{2b}, is independently selected from N or C—R⁶;
Each R⁵ is independently selected from —H, —CH₃, —OCH₃, halogen, or —CF₃;
Each R⁶ is independently selected from —H, —CH₃, —OCH₃, —N(CH₃)₂, halogen, or —CF₃; or
A vicinal R⁵ group and R⁶ group together with the carbon atoms to which they are attached form an optionally substituted 5-7 membered heterocyclic or carbocyclic ring; or
two R⁶ groups together with the carbon atoms to which they are attached form an optionally substituted 5-7 membered heterocyclic or carbocyclic ring; and
wherein no more than one of X₁ₐ, X_{1b}, X₂ₐ, or X_{2b} is N.

24. The compound of claim 23, wherein each of R¹ and R² is independently selected from tert-butyl, 2-tolyl, or 1-adamantyl.

25. The compound of claim 23, wherein R¹ and R² are both tert-butyl, cyclohexyl, 2-tolyl, or 1-adamantyl.

26. The compound of claim 25, wherein R¹ and R² are both 1-adamantyl.

27. The compound of claim 23, wherein each of X₁ₐ and X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring; or two R⁶ groups together with the carbon atoms to which they are attached form an optionally substituted 5-7 membered heterocyclic or carbocyclic ring.

28. The compound of claim 27, wherein each of X₁ₐ and X_{1b} is C—H, and each of X₂ₐ and X_{2b} is C—R⁶, wherein the two R⁶ groups together with the carbon atoms to which they are attached form an optionally substituted 5-7 membered heterocyclic or cycloaliphatic ring.

29. The compound of claim 27, wherein each of X₁ₐ, X_{1b}, X₂ₐ, and X_{2b} is C—H.

30. The compound of claim 23, wherein X₁ₐ is N, X_{1b} is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring; or two R⁶ groups together with the carbon atoms to which they are attached form an optionally substituted 5-7 membered heterocyclic or carbocyclic ring.

31. The compound of claim 23, wherein X₂ₐ is N, X_{2b} is C—R⁶, and each of X₁ₐ and X_{1b} is C—R⁵, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃.

32. The compound of claim 23, wherein X_{2b} is N, X₂ₐ is C—R⁶, and each of X₁ₐ and X_{1b} is C—R⁵, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃.

33. The compound of claim 23, wherein X_{1b} is N, X₁ₐ is C—R⁵, and each of X₂ₐ and X_{2b} is C—R⁶, wherein each R⁵ is independently selected from —H, —CH₃, —OCH₃, halogen, or —CF₃, and each R⁶ is independently selected from —H, —CH₃, —OCH₃, —N(CH₃)₂, halogen, or —CF₃; or a vicinal R⁵ group and R⁶ group together with the carbon atoms to which they are attached form an optionally substituted 5-7 membered heterocyclic or carbocyclic ring; or two R⁶ groups together with the carbon atoms to which they are attached form an optionally substituted 5-7 membered heterocyclic or carbocyclic ring.

34. A compound selected from

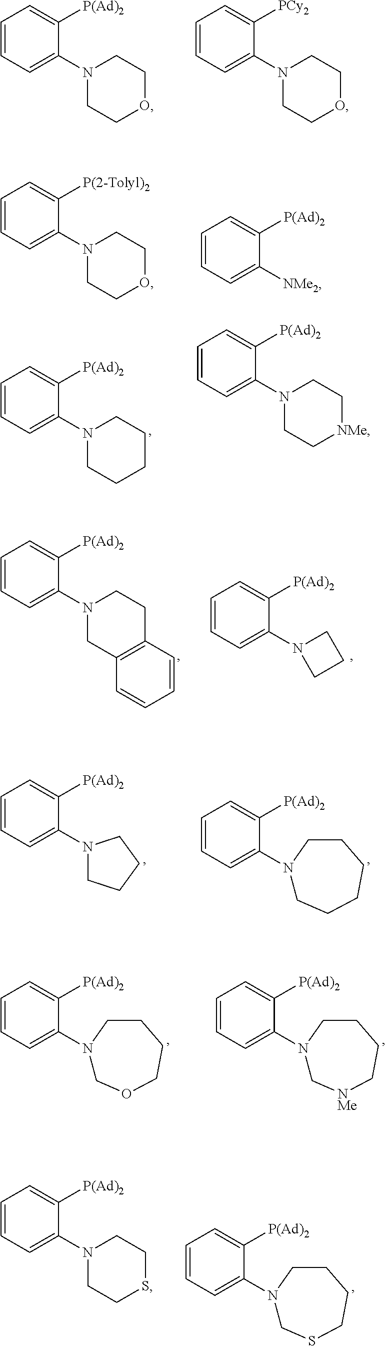

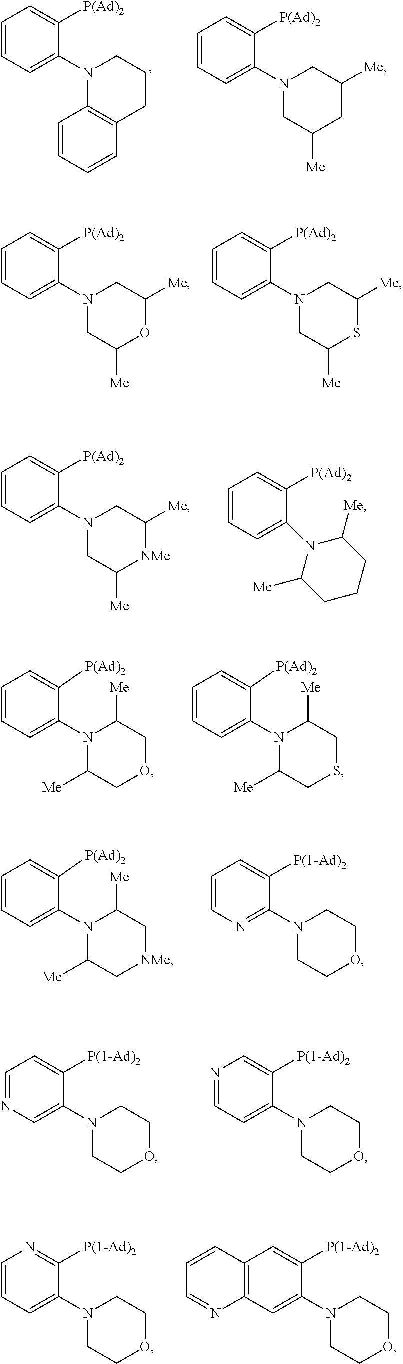

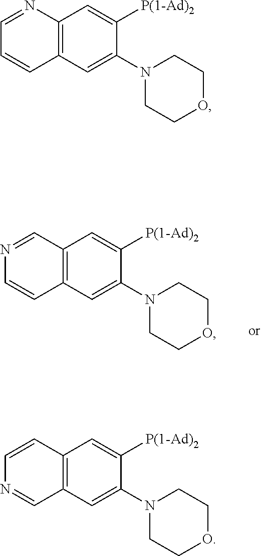

35-151. (canceled)
